(19) United States
(12) Patent Application Publication
(10) Pub. No.: US 2025/0375718 A1
(43) Pub. Date: Dec. 11, 2025

(54) DIFFERENTIAL SEPARATION PROCESS WITH CONTROLLED PARAMETERS RELEVANT TO SOLID AND LIQUID PHASE

(71) Applicant: Hsien-Chih Ma, Morris Plains, NJ (US)

(72) Inventor: Hsien-Chih Ma, Morris Plains, NJ (US)

(21) Appl. No.: 18/735,690

(22) Filed: Jun. 6, 2024

(51) Int. Cl. B01D 15/18; B01D 15/38; B01D 15/42

(52) U.S. Cl. CPC B01D 15/1807; B01D 15/1814; B01D 15/3847; B01D 15/422

(57) ABSTRACT

“Parametric Differential Moving Bed” named as PDMB, characterizes by obtaining target separation system's elution profile via optimized chromatography's separation parameters between selected solid sorbent and mobile phase; such generalized process employ an apparatus transforming such profile for mass production purpose, wherein disclosed apparatus bypassing imperfections observed in chromatography via new mass transfer equilibrium contact method, differential set-up between two phases, eliminating displacement zone via maintaining installed resin/adsorbent in semi-dry status thus enhancing maximum mass transfer efficiency. Through implementing aforesaid methods, disclosed apparatus further employs single stage recycle procedures to simulate moving beds operation in confined closed loop in differential protocols; which comprise multiple modules sequentially connected, yet each functions independently and simultaneously feeding feed solution, isolating at least one desired component, recycling mobile phase, concentrating multiple isolated components, regenerating adsorbent, washing and sanitizing; apparatus further integrate additional sequential unit operation installing other type solid phase material within.

### BACKGROUND OF THE INVENTION

### Prior Art

This application is an extension of U.S. Pat. No. 4,758,349 dated Jul. 19, 1988, U.S. Pat. No. 6,280,623 B1, Aug. 28, 2001, and U.S. Pat. No. 6,576,137 B1, dated Jun. 10, 2003 and application Ser. No. 18/243,560 filed on Sep. 7, 2023, titled as “Apparatus to modify Simulated Moving Bed for Continuous Separation of Glucose and Fructose” which is exemplified of present invention for industry scale binary sugar separation. To be more specific for large scale separation purpose, this invention is by creating an acceptable target separation system's elution profile via optimizing between same predetermined mobile phase parameter and resin/adsorbent packing material as feasible combination carried out in a typical chromatography separation, wherein such parameter can be selected mobile phase condition as homogeneous liquid solution in wide spectrum of variation in pH value, ionic strength, solubility, polarity in connection with selected resin/adsorbent as combination, wherein packing materials can be classified in various categories and/or commercially available material being used in chromatography like ion exchange, affinity, reverse phase, normal phase, and ligand exchange that can chemically and selectively interact with the dissolved components in mobile phase to promote successive separation. Hereinafter resin/adsorbent is generalized and named as solid phase. It broadly related to an apparatus and methods for purposes of mass production process to simultaneously isolate at least one desired component from a homogeneous liquid solution containing plurality of same mixture components. The apparatus is advanced by its unique construction to convey methods to overcome native engineering drawbacks observed and realized in typical chromatographic operation turned into irrelevant issues for purpose of scaling up from laboratory to production scale apparatus, issues like back mixing resulting diffusion, axial dispersion, and column end effects and so forth. Via applying differential set-up between solid and liquid phase, new mass transfer equilibrium contact method, and single stage operation protocols, this disclosed apparatus dramatically increases mass transfer equilibrium efficiency and effectively utilizes packing materials in comparison with typical chromatographic operations compared under same feeding capacity requirement. This generalized process further specifically controls system separation parameters obtained from particular elution cycle to avoid deterioration of separation efficiency due native engineering drawbacks of chromatographic process for purposes of constructing mass production apparatus. This comprehensive disclosure hereafter is named “Parametric Differential Moving Bed” abbreviated as “PDMB” to characterize such fundamental differences between other chromatography processes like Simulated Moving Bed, SMB, specifically designed for binary separation system in glucose and fructose purification.

### The Description of Prior Art

Nowadays there are many stationary solid phase and mobile phase combinations that can be employed when separating a mixture, there are several different types of laboratory analytical or pilot scale chromatography that are classified based on the physical states of those phases. Liquid-solid column chromatography, the most popular chromatography technique, features a liquid mobile phase that slowly filters down through the solid stationary phase, bringing the separated components with it. It relies on pump devices to pass a pressurized liquid containing component mixtures through a column filled with a solid adsorbent material. Each component in the sample interacts slightly differently with the adsorbent material, causing different transportation rates for the different components thus leading to the separation of the components as they flow out of the column. Commercial chromatography for mass production unit normally derives from similar combination from small scale column chromatography with chemically adsorption and de-adsorption interaction of mass transfer equilibrium phenomena between the solid and component mixtures in liquid phase. Packed or fixed bed batch type column is the dominant device being widely used for separation. Ever since 1967, the liquid chromatography was first emerged by Huber and Hulsman for faster and easier analytical speed over gas chromatography. Until nowadays that simulated moving bed process employing the embodiments as described in U.S. Pat. Nos. 3,761,533 and 3,201,491 become well known and adopted for such purposes. In those known processes, single chromatographic column is divided into several sections via distributors that allow fluid to freely flow into or out of each section. Those sections are interconnected in order and continuously circulating fluid stream flowing through all sections by circulating the effluent fluid from an outlet of the last section to an inlet of the first section. At a setting time intervals, all points of streams introducing inlet and withdrawing outlet are shifted simultaneously as same direction of fluid flow; this gives the packing materials a simulated flow in opposite direction of fluid flow. Alternatively, having multiple columns arranged to proceed continuous solids and liquids contacting device, as taught by the U.S. Pat. No. 4,522,726 and continuation-in-part of U.S. Pat. No. 4,522,726 which is U.S. Pat. No. 4,808,317. This device is described by its structure to provide fixed inlet and outlet nipples for continuous introducing and removing fluid streams. The inlet and outlet nipples are interconnected by plurality of rotating columns which are divided into three or four sections, similar to above mentioned simulated moving bed process. By the nature of ratable construction of its member and plural sections, a discrete fluid streams may simultaneously be treated.

All of aforementioned mass production processes comprise certain differences, yet they are all fallen into same category that stationary material packed within circular column and somewhat in modifying column configurations in order to enhance fluid distribution efficiency in order to increase productivity. Such modifications and improvement are purposely focus on solving common issues of fluid dynamics when design of production unit is concerned. Generally, separation is achieved through sequential stages of introducing predetermined amount of feed solution to promote adsorption of solute to consume small trace of packed adsorbent from top region of column as liquid flows through, then introducing another fluid to selectively elute impurities; following with introducing specific fluid to recover desired product, then followed with adsorbent regeneration and washing. At any given time, said sequential liquid introducing being proceeded limited to a narrow time interval in order to obtain satisfactory product recovery, so that, resulting packed adsorbent being inefficiently consumed mainly because the idle of most part of packing materials either waiting for being saturated with feed or contributing for elution of particular adsorbed component. Said imperfections are multifaceted coexisted and affecting one another, which are briefly illustrated as following:
a) Inefficient usage of resin/adsorbent, the mass transfer proceeded only at the very front of mass transfer zone, the solid phase before and after such zone are idle;
b) Due to existence of displacement zone in chromatography process causing excess dilution and to increase cycle time thus enhancing inefficient usage of adsorbent;
c) Engineering drawbacks of smearing component profile in column process; listed as following;
   1. Flow dynamics: axial dispersion and diffusion effects are important in affecting separation quality, include back mixing of column end effects.
   2. Column geometry: in and out, column end-effects includes dead volume required to provide extra fluid volume to fill liquid pipe line from liquid introducing point and exist point of column system.
   3. Loading limitation: to avoid peak broadening, overlapping, and tailing due flow-dynamics, so that this shall be compelled to create additional dilution of separated fractions due engineering drawbacks.
d) Require long cycle time to further weaken economic consumption of adsorbent and eluent, to intensify said engineering drawbacks; and

e) High-pressure drop and difficulty in maintenance.

Those combined fluid dynamic having great impacts on product purity and process efficiency. Thus, production rate needs to be compromised with purity and separation efficiency, and often requiring complicated protocols resulting in expensive support systems particularly in large scale industrial separation process. Furthermore, the scale up from laboratory result usually is linear procedures to pilot scale and then mass production unit through which involves all concerns of not only cost of construction but higher probability of failure.

It is readily understood that the breakthrough of efficient consumption of packing materials not only providing separation process to overcome those common engineering issues in order to markedly improves the efficiency of liquid column processes in aspects for low operation cost, low equipment investment, and flexible separation protocols.

### SUMMARY OF THE INVENTION

Principle object of this invention is to provide broadly generalized methods and a corresponding apparatus relevant to particular separation system for mass throughput in continuous separation via combining stages of simultaneous feeding, impurity stripping, adsorbent regeneration, and washing and or sanitation, subsequent decolorization stage might be required by separation system. It means through integration of all stages as a complete separation cycle via continuous execution of disclosed apparatus to simultaneously isolate at least one product stream and multi-impurities stripping, regeneration, washing. Each separated fraction derived from typical chromatographic elution profile is transformed to simultaneously recover within a specific zone and each zone is representing corresponding to one among aforementioned stages. Each zone contains one or more than one cell and each cell comprises a tall chamber installed with plurality of at least one column installed with stationary adsorbent acting like partially fluidized bed or mixed reactor. At least one cell disposed in specified zone representing a predetermined mass transfer equilibrium contact implemented from a particular elution profile of a target separation system.

In typical chromatographic operation, resident resin/adsorbent is stationary and is required to be well packed to maintain within flow pattern as plug flow in order to alleviate aforementioned fluid dynamic issues to avoid separated peak from being overlapping each other; such that resulting installed adsorbent being constantly maintained in contact with surrounding liquid as fluid being progressively pushed from one end to existing fluid out from another end. Typical chromatographic elution profile normally starts after at least one bed volume due limitation of column dead volume and adsorbent void volume, this is named as displacement zone. It is therefore understood that fundamental object of this invention is to initiate a new mass transfer equilibrium contact method to overcome abovementioned issues observed in chromatography process to eliminate said displacement zone and issues of high pressure drop operation, further utilize the void volume available for prompt mass transfer contact proceeding, and meanwhile creating a zero dead volume process. Such said new mass transfer equilibrium contact method composes at least one of following procedure.
1. Retain solid phase resin/adsorbent material in at least one of column, each of bundled columns having an inlet on one side and an outlet on another side with bottom meshed filter to contain said resin/adsorbent from being drained. Such bundled group of at least one column perform as partially fluidized bed as a whole unit is named as cell hereinafter,
2. intermittently and simultaneously deliver predetermined multiple amount of liquid solution in sequence through predetermined type of liquid dispenser into each of said cell amid predetermined first time period, to instantaneously promoting a homogenous mass transfer equilibrium contact either adsorption of dissolved components onto said material or elution of adsorbed components from said resin/adsorbent material;
3. intermittently and simultaneously supply broad range pressurized inert gas amid predetermined second time period to the group of cells on one side following each sequential delivery of liquid amount to force prompt draining of delivered liquid sipping through said resin/adsorbent material contained in each cell to complete expected mass transfer equilibrium contact between two phases;
4. simultaneously meanwhile amid spent time of step 3 providing vacuum environment on the other side of said group of cells to maintain said solid phase resin/adsorbent material in a semi-dry status, hereinafter defined as new mass transfer equilibrium contact status, meaning packed resin/adsorbent particles may have wet surface but with no liquid exists between adsorbent particles;
5. intermittently meanwhile amid spent time of step 3 collecting most of treated solution from the bundled outlet of said group of cells, repeating step 2 through step 5 until predetermined multiple amount of liquid solution in sequence is satisfied;
6. define total cumulated time spent for repeated step 2 through step 5 as minimal time interval, Δt.

Note that step 4 of general procedure may be omitted or using low vacuum environment due to organic mobile phase liquid may be used as part of eluent such as adding methanol or acetonitrile to reduce pure water polarity in reverse phase chromatography operation, so that, organic mobile phase liquid issues can be eliminated; using step 3 of pressurized inert gas for draining of delivered liquid.

Apparatus herein disclosed installed with typical adsorbent resin/adsorbent solid phase material being adopted in typical chromatography operation like ion exchange, affinity adsorbent, hydrophobic or hydrophilic resin, and dye ligand adsorbent; all of which are suitable to utilize and through selected combination between mobile and solid phase to carry out aforesaid new mass transfer equilibrium contact method. Disclosed apparatus comprises of plurality modules connected in sequence to meet specific production target; as procedures for conveying construction of apparatus among modules to satisfy production throughput requirement, operation smoothness, and maintenance flexibility as a whole device shall be illustrated further hereinafter.

As preferential set up to meet specific target separation system requirement, having a plurality of each holding tank assigned for receiving particular liquid, such group of holding tanks arranged in an organized array in selected pattern to dispose inside a heat media circulation insulated jacket having an inlet and outlet to maintain whole plurality of holding tanks in a selected temperature range. Water can be preferred heat media between 0 degree and 100-degree C. unless specified otherwise based on particular requirement of separation system. For temperatures range below 0 degree C., brine (water with salt) or water adding anti-freeze can be considered, and mineral oil or other synthetic heat carrier can be used for temperature range above 100-degree C. Each holding tank of whole plurality has an inlet extended outside upward of said jacket to receive liquid and has an outlet extended outside downward of said jacket to discharge stored liquid to the following rotary union multiple valves module. This is defined as upstream or downstream holding tanks module hereinafter.

Above mentioned rotary union multiple valves module having a circular rotational multiple valve body disposed inside a stationary sealed cover, such valve body is driven by a Servo-motor rotate intermittently stepped at a predetermined equal angle along circular path. Said stationary cover having top side multiple nipples, each nipple equipped with bottom liquid conduct inside stationary sealed cover paired with corresponding rotational valve body and having equal plurality of liquid inlet conduct of transit storage reservoir installed at predetermined location to simultaneously and intermittently receiving liquid transferred from particular holding tank of above said holding tanks module. This rotational valve body having an equal quantity of outlet conduct installed at corresponding location to precisely transmit said liquid to next following module. At any duration of time interval, all kinds of liquid stored in each said holding tanks module is delivered from particular tank and simultaneously transmitted via rotational multiple valve body to the next module. This is defined as upstream or downstream rotary union module hereinafter.

Having a plurality of said cells arranged in preferred pattern. As previously said each cell compromises at least one of column, each column has a top side opening means for liquid input and bottom screen filter means for retaining said resin/adsorbent from been drained. All cells arranged in a similar organized array of said holding tanks module as preferential set up for effortless organizing liquid flow from corresponding holding tank via said rotary union module. Such group of cells set inside heat media circulation insulated jacket having an inlet and an outlet to maintain whole plurality of cells in a selected temperature range as aforesaid selected heat media in upstream or downstream holding tanks module. Water can be preferred one for between 0 degree and 100-degree C. and brine (water with salt) or water adding anti-freeze can be used for temperature range below 0 degree C. Mineral oil or other synthetic heat carrier can be used for higher temperature range above 100-degree C. Each cell has a liquid inlet conduct extended outside upward of the insulated jacket to receive particular liquid delivered via upstream rotary union module from corresponding holding tank in upstream holding tanks module via predetermined type of liquid dispenser installed on top of plurality of columns. Each cell top has a pipe means for intermittently receiving supply of pressurized inert gas to force prompt draining of delivered liquid sipping through said resin/adsorbent contained in each cell to complete expected mass transfer between two phases during duration of time intervals of said new mass transfer equilibrium contact method. Each cell bottom meanwhile is exposed to vacuum to maintain said adsorbent in a semi-dry status and to affiliate liquid draining via liquid conduct into each underneath temporary liquid reservoir. Each bottom of cell has a liquid conduct extended outward insulated jacket means for simultaneous transferring particular liquid in each underneath cell temporary liquid reservoir via downstream rotary union module to each corresponding holding tank in said downstream holding tanks module to further carry out new mass transfer equilibrium contact method for separation of targeted solution mixture in following repeated manner.

Predetermined amount of all liquids, including feed solution and other particular solution related with targeted separation system, delivered from predetermined holding tank disposed in holding tanks module is intermittently and simultaneously delivered via upstream rotary union module via said selected type of liquid dispenser installed inside of respective cell to produce a wetted region of retained adsorbent. Such delivered liquid is instantaneously settled and drained by said pressurized inert gas applied from top of all cells and vacuum exerted simultaneously from bottom of all cells to maintain adsorbent at semi-dry status. Amid whole time duration, treated and drained liquid from respective cell is collected through each said temporary liquid reservoir located beneath each cell. The collected liquid flows via downstream rotary union and delivered into each corresponding holding tank in said holding tanks module. Amid same whole time duration, exiting mist enriched inert gas from bottom part of said apparatus is passing through an inert gas supply sub-module to condense the mobile phase liquid mist and such sub-module shall be illustrated later. Then, both upstream and downstream rotary union module advance further one predetermined rotation step via means of rotation and positioning together with seal mechanism before next dose of simultaneous liquid input. During steady stage operation, all cells in the apparatus perform repeatedly and simultaneously with liquid filling, liquid draining and collecting through all said modules connected in sequence means within every spent of said minimal time interval. This portion of apparatus is defined as separation module hereinafter.

Simultaneously exerting vacuum environment via a manifold conduct onto entire bottom portion of said separation module means for prompt liquid draining and meanwhile extracting mist enriched inert gas through a mist separation device to collect condensed mobile phase liquid for other usage and convert mist enriched inert gas to dry inert gas. Said dry inert gas exiting mist separator is combined with pressurized dry air and deployed through an inert gas generator to obtain fresh inert gas and to store in a steel tank vessel maintaining at multiple preferential pressure level ready for deploying back to separation module and said upstream and downstream holding tanks module. Providing an inline gas temperature adjuster to assure fresh dry inert gas is maintained at desired temperature level prior intermittently and simultaneously entering said separation module via a manifold conduct. Organize supplying broad range pressurized inert gas to incorporate with aforesaid modules is to affiliate liquid phase transmitting within disclosed apparatus. This portion of apparatus is defined as inert gas supply module and is sub-module integrated with said separation module.

It is an object of the invention to maximize the utilization efficiency of resin/adsorbent installed in each column grouped in a cell. Total amount of adsorbent material installed in each cell is equivalent to adsorbent of mass transfer zone (abbreviated as MTZ) in chromatography. Depending upon process design preference of combination between solid phase and mobile phase for particular separation system, such installed amount is further equally divided to predetermined adsorbent amount installed in each column to meet the scale up throughput requirement. It means resin/adsorbent amount installed in feed deployed zone is completely saturated with feed solution. In contrast with chromatography, this MTZ is the resin/adsorbent been saturated with feed solution in about 5 to 10% of beginning portion of resin/adsorbent bed and such MTZ is transported by sequential introducing various type of eluent liquid from one end to exit from the other end of column.

It is a further object of this invention to provide a differential set-up to convert both adsorbent and mobile phase for complete usage of adsorbent and thus obtaining the maximum mass transfer efficiency between two phases. The conventional chromatographic mass transfer path is parallel to the sequential input of mobile phase's flow direction and the solid phase is stationary. Inversely, this disclosure continuously and homogeneously exposes the solid phase simulated moving in horizontal direction to perpendicularly and simultaneously in contact with multiple kinds of mobile phase. The elution profile of a particular separation system is being organized along the apparatus in horizontal orientation to receive mobile phase transmitted in vertical direction to simultaneously achieve a complete separation cycle during duration of each spent of minimal time interval. Such ultimate object is achieved through swift mass transfer contact via implementation of said new mass transfer equilibrium contact method employed by differential set-up between two phases through which to attain dramatic reduction of resin/adsorbent inventory disposed in said apparatus.

It is a further object of this invention to define a new mobile phase input format to distinguish that from chromatography separation in term of general parameter such as pH value, polarity related with solubility, or ionic strength . . . and so forth, wherein input S-I format is defined as plurality of predetermined input volume amount of same mobile phase parametric condition is simultaneously and intermittently delivered in sequence within duration of said minimal time interval into each cell disposed in specific defined zone. Input I-I format is defined as plurality of predetermined volume amount of “discrete increments” of mobile phase parametric condition solution is simultaneously and intermittently sequential delivered into each cell located in same zone within duration of said minimal time interval. The differential increments of each mobile phase condition is predetermined between two designate levels that are grouped with each corresponding cell in such zone. The input volume amount of each discrete mobile phase parametric condition is further divided in predetermined equal portion and so is tied with designated cell in such zone as well.

It is further object of the invention to extend to other chemical unit operation constitutes resembling mass transfer phenomenon through combined application of differential set up, new mass transfer equilibrium contact method, operation protocols, and preferred apparatus. Such applications are like catalytic reaction in pack tower, activated carbon packed bed for decolorization or deodorization, and fluidized solid and liquid reaction.

It is fundamental for a particular separation system to obtain a characteristic elution profile investigated under the criterion of said new mass transfer equilibrium contact method, thus it is further object of the invention to provide single stage recycle protocol utilizing such elution profile arranged in endless format for simultaneous isolation and enhancing the concentration level of separated fractions for a target separation system to reduce consumption of mobile phase.

It is further object of the invention to provide a preferential operation protocol to carry out separation procedures with disclosed apparatus to implement via coordination of new mass transfer equilibrium contact method and differential set-up, wherein such preferential operation protocol including at least one protocol of start-up stage, steady state stage, and termination stage.

It is further object of the invention to provide single stage recycle protocol and said operation protocol employed by the disclosed apparatus to further illustrating multiple separation module operated simultaneously in parallel, exemplified in three of such modules as purpose for further breaking down massive feed solution throughput requirement.

### BRIEF DESCRIPTION OF THE DRAWINGS

The above and other objects, distinct features and advantageous of disclosure can be more readily illustrated from the following description, taken with drawings in which:

FIG. 1 is the schematic perspective view to illustrate fundamental difference between sequential stage operation in typical chromatography and schematic view of Parametric Differential Moving Bed, abbreviated as hereinafter PDMB, introduced via differential set-up between solid and mobile phase;

FIG. 2 is the perspective view of preferential apparatus for broad embodiment of separation system illustrated in aforementioned modules connected in series for closed loop of mobile phase transmitting route via as example of 24 cells in said separation module;

FIG. 3 is the perspective view of preferred inert gas supply module that is sub-module integrated with said separation module for mobile phase liquid streams transmitting mechanism, and that is briefly shown on left side of FIG. 2;

FIG. 4 is the cross-sectional perspective view of preferred apparatus emphasizing on upstream rotary union module that is the bridging module providing mobile phase flow from upstream holding tank module to top portion of said separation module via rotation positioning and seal mechanism related to FIG. 2 and FIG. 3;

FIG. 5 is the cross-sectional perspective view of preferred apparatus emphasizing on downstream rotary union module that is the bridging module providing mobile phase flow from bottom portion of separation module to downstream holding tank module via rotation positioning and seal mechanism related to FIG. 2 and FIG. 3;

FIG. 6 is the general perspective view for implementation of instantaneous mixing or stirring partial fluidized effect of preferred cell construction between resident packing material and upcoming fluid; particularly for single type resin/adsorbent disposed in a single column as cell itself;

FIG. 7 is the general perspective view for implementation of mixing or stirring partial fluidized effect of preferred cell construction for between resident packing material and upcoming fluid, wherein applies for single type of resin/adsorbent packed disposed in multiple layers or multiple kinds of resin/adsorbent disposed in multiple layers which aggregates several layers defined as zone to accommodate single type of resin/adsorbent and integrate multiple zones for multiple kind of resin/adsorbents disposed in a single column as cell itself;

FIG. 8 is the method to implement for continuous and simultaneous isolation of single product A and the two groups of impurities B1 and B2 in conjunction with a generalized scheme to carry out the differential set up illustrated in FIG. 1 onto Parametric Differential Moving Bed, PDMB;

FIG. 9 is the single stage recycle process to implement for continuous and simultaneous isolation of single product in conjunction with a generalized scheme illustrated in FIG. 8 to carry out said differential set up illustrated in FIG. 1 and employed by said apparatus;

FIG. 10 is the method to implement for continuous and simultaneous isolation of two products A1 and A2 and impurities groups of B1, B2, and B3 in conjunction with a generalized scheme to carry out the differential set up illustrated in FIG. 1 onto Parametric Differential Moving Bed, PDMB;

FIG. 11 is the single stage recycle process to implement for continuous and simultaneous isolation of at least one product in conjunction with a generalized scheme illustrated in FIG. 10 to carry out said differential set up illustrated in FIG. 1 and employed by said apparatus;

FIG. 12 shows the concentration profile from a single cell testing as an example of 24-zones protocols in which binary target system comprising glucose, fructose, and oligosaccharide, abbreviated as oligos, are plotted as D.S. % vs. elution time in terms of slow mass transfer mechanism to achieve a complete separation cycle during each spent of minimal time interval, Δt, and wherein the pure glucose and fructose stream are recovered from a feed stream comprising above mentioned components;

FIG. 13 is the schematic diagram for converting such characteristic elution profiles of FIG. 12 into a single-stage recycle protocol employed by disclosed apparatus for large scale purification through steady state operation;

FIG. 14 is perspective view of FIG. 13 of single stage employed by the disclosed apparatus emphasizing for single stage recycle process for sugar solution separation arranged in endless format and further illustrating multiple separation module simultaneously operated in parallel exemplified in three of such modules;

FIG. 15 is purposely to demonstrate fundamental difference in view of fluid dynamic via an ion-exchange column for a single component being adsorbed and then eluted three pH cyclic waves between chromatography operation such as well adopted Simultaneous Moving Bed (SMB) process and this Parametric Differential Mobile Bed (PDMB); and

FIG. 16 is the schematic flow diagram for demonstrating isolation of single component from mixtures of components via fast and instant adsorption and desorption of mass transfer mechanism to achieve complete separation cycle during each spent of minimal time interval, Δt;

FIG. 17 is the schematic diagram for demonstrating of cell as column itself for isolation of single component from mixtures of components via fast and instant adsorption and desorption of mass transfer mechanism to achieve complete separation through exemplified as batch mode omitting upstream rotary union module B and downstream rotary union module D;

FIG. 18 is the perspective view of FIG. 13 in single stage recycle protocol employed by the disclosed apparatus emphasizing for mass production throughput requirement to break down upstream rotary union module B and downstream rotary union module D into a plurality of sub-module and integration of all sub-module functions as one module through exemplified sugar solution separation arranged in endless of single separation module C;

FIG. 19 is the schematic diagram for demonstrating slow adsorption and desorption of mass transfer mechanism via multiple cells disposed in disclosed apparatus operated in batch mode for separation binary system using glucose and fructose sugar mixtures that sugar components dissolved in eluent solution as an example to achieve a complete separation cycle through said apparatus amid every spent of said minimal time interval; wherein such batch operation omit upstream holding tanks module A and upstream rotary union module B and downstream rotary union module D.

### DETAILED DESCRIPTION OF THE INVENTION

This invention includes a preferred apparatus and such apparatus implemented new mass transfer equilibrium contact method to integrate with differential set up between mobile and solid phase and an operation protocol to employ predetermined separation system's parameters derived from elution profile onto said apparatus. Both the apparatus and aforesaid methods are interrelated as hybrid embodiments and illustrated in five descriptive embodiments with aforementioned drawings.

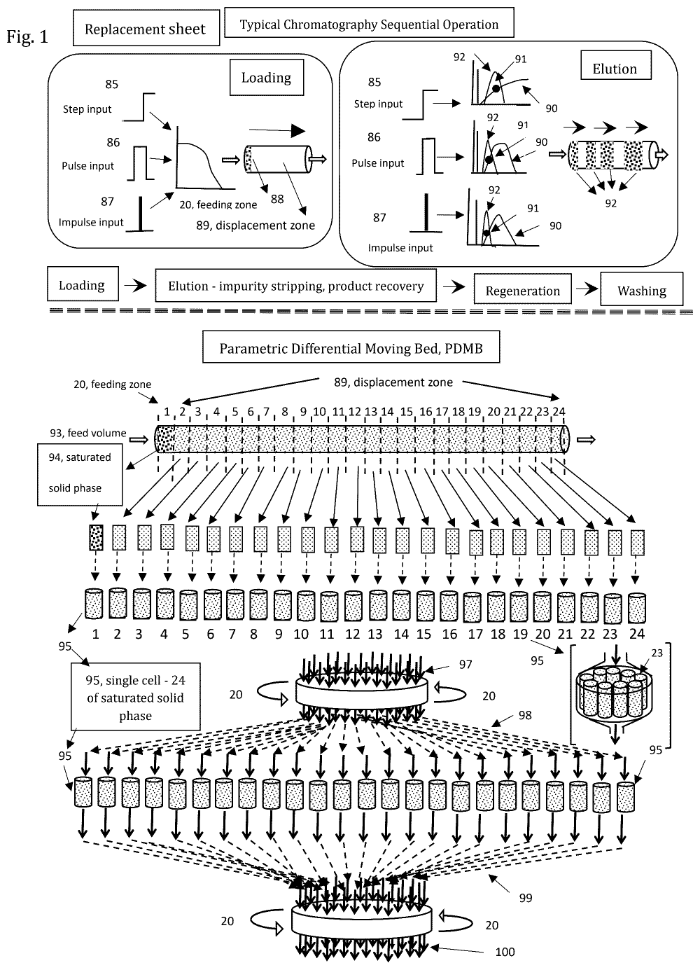

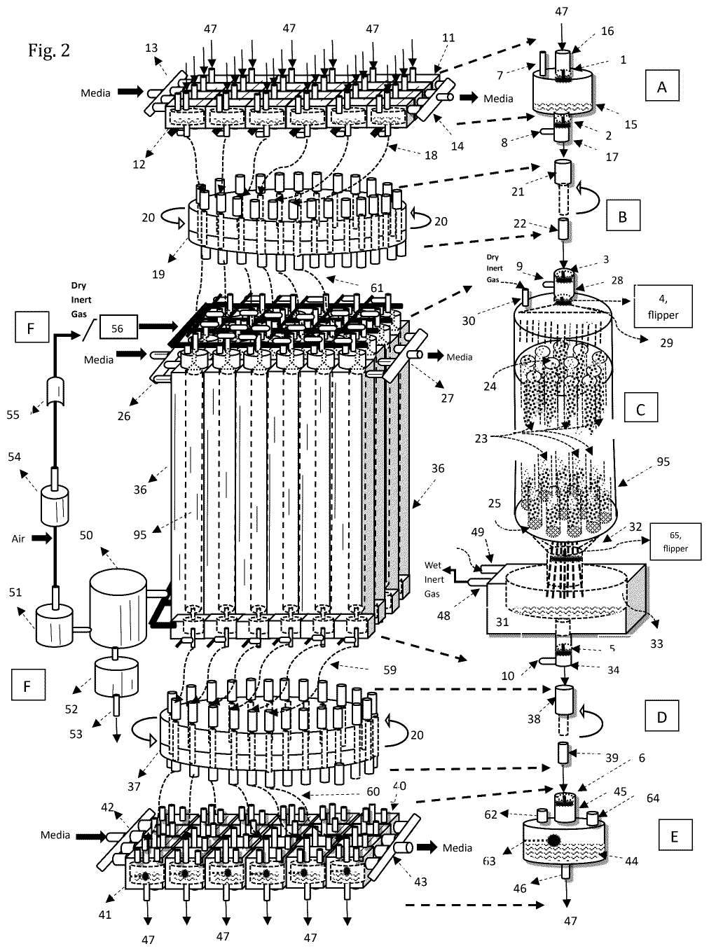

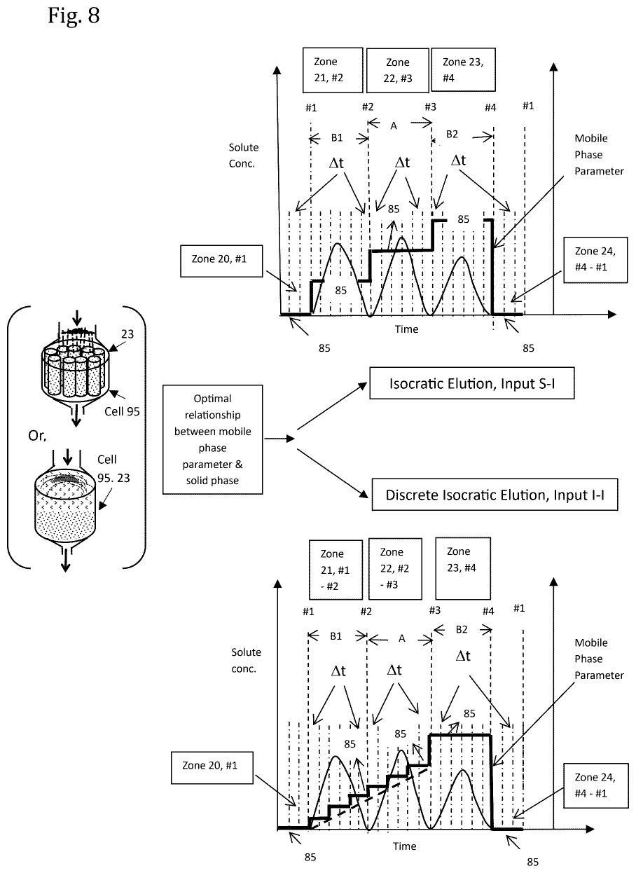

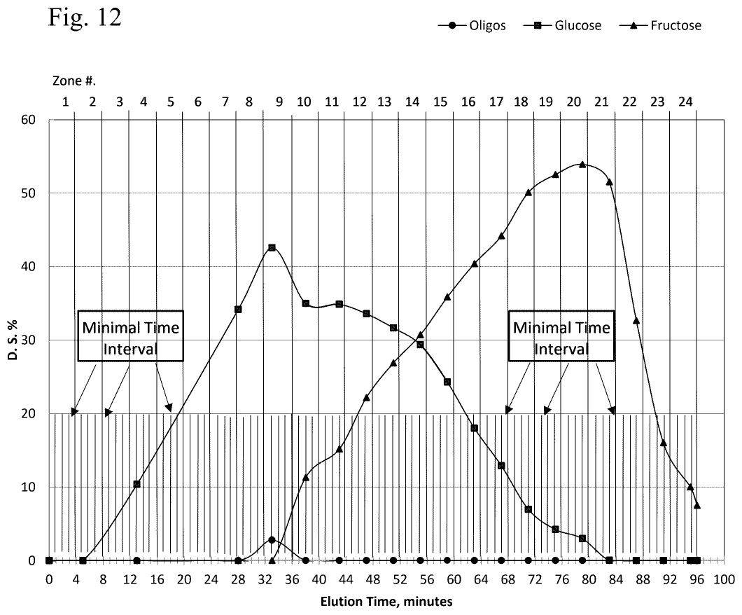

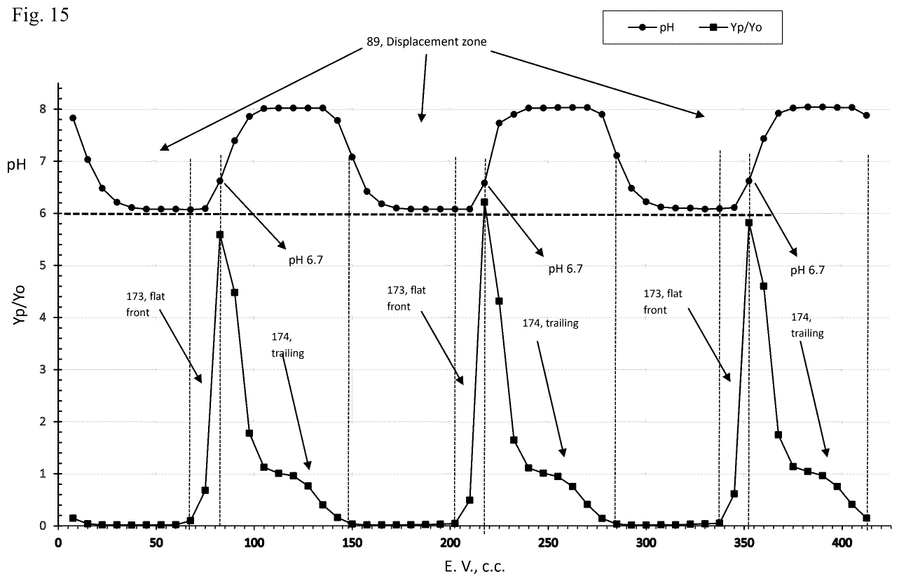

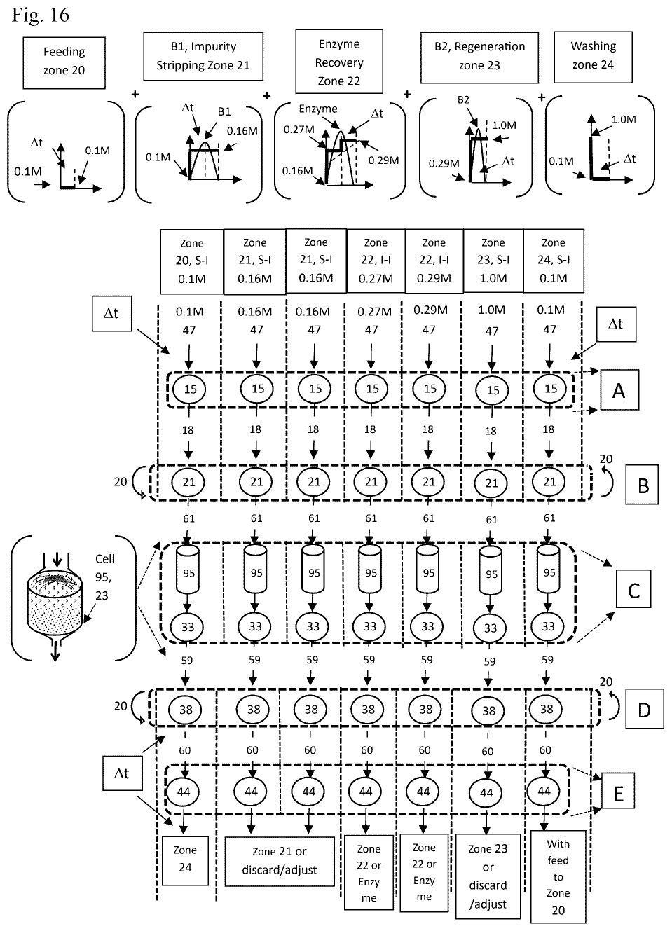

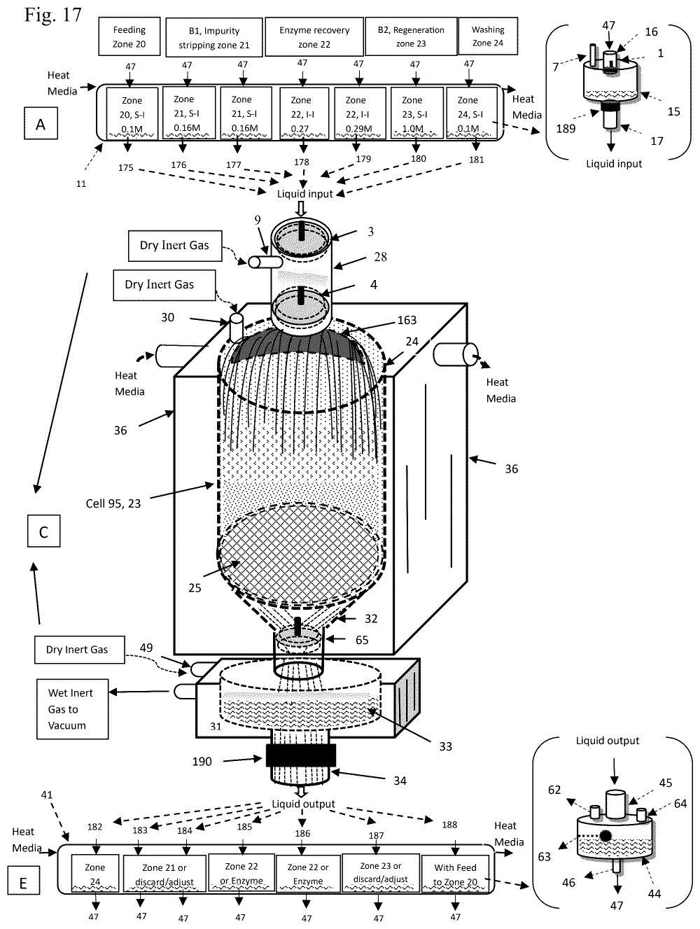

The first constituent starts from FIG. 1 is to illustrate fundamental difference between column processes and named Parametric Differential Moving Bed abbreviated as PDMB. The second constituent is for preferred apparatus comprises modules thoroughly illustrated in FIGS. 2, 3, 4, 5, 6 and 7 in conjunction with lower portion of FIG. 1 briefly illustrated for above defined Parametric Differential Moving Bed abbreviated as PDMB. The third constituent involves the various mass transfer novelties and methods covered from FIG. 8 to FIG. 11 to explicate this broad and generalized said PDMB for single stage recycle method via new mass transfer equilibrium contact method and employed by disclosed apparatus. Moreover, FIG. 12 through FIG. 14 illustrate single stage recycle protocol for binary system of glucose and fructose to obtain ultimate separation and enrichment with multiple parallel operation of said separation module. Selected experimental data of enzyme isolation are demonstrated via FIG. 15 through FIG. 16 for numerous advantageous of this disclosure over current column process and to signify this disclosure can be very feasible process design for scaling up mass production alternative based on enhancing efficiency of mass transfer mechanism. It is clear that all drawings and examples are mainly for illustration and possible extent of alternation or configurations of mechanical structures onto preferred apparatus may be explored. Yet, fundamental concept of this disclosure should set above such possible modification and be governed within the scope of this invention, mainly because this invention is the hybrid embodiments of an apparatus in connection with broad and generalized procedures of new mass transfer equilibrium contact method between solid and mobile phase and employed by said apparatus via differential set up and single stage recycle operation protocol. Thus lastly, FIG. 17 through FIG. 19 illustrated such extend of alternation related with mass production process design can be logically derived, yet new mass transfer equilibrium contact method is the fundamental to base upon.

FIG. 1 shows significant difference between chromatography and Parametric Differential Moving Bed, abbreviated as PDMB. Fundamental set for typical chromatography is sequential input of multiple mobile phases, through which beginning with loading, subsequently followed with sequential elution including impurity striping, product recovery, regeneration, and lastly is adsorbent washing, cleaning, or sanitation step. As indicated “Loading” in sequential operation in upper left portion of FIG. 1, the shaded region 88 is so called mass transfer zone, abbreviated as MTZ, represents disposed resin/adsorbent in chromatography column been saturated and progressively increases along flow direction of mobile phase amid introduced feed solution which comprises solute components been homogeneously dissolved in predetermined separation system's parameter to promote adsorption of such solute components onto resin/adsorbent and simultaneously push out the existing mobile phase out the other end of column. The unshaded area 89 is so called “displacement zone” represents the fresh adsorbent has not been saturated with feed solution. As indicated during loading stage, depending on input feed solution volume amount been introduced in time domain and options of three input modes, each named as step input 85, pulse-input 86, and impose input 87 generate same result due to target separation's parameter being adjusted to promote dissolved solute components been adsorbed. The feeding zone 20 in typical chromatography sequential operation occupies 5-15% of total column volume and unused remaining resin/adsorbent in displacement zone 89, both zones are being constantly soaked in contact with mobile phase.

Soon after feed solution input being completed, subsequently followed with inputting each elution liquid having particular mobile phase parameter condition, wherein each parameter can be variant in pH value, ionic strength, polarity related with solute solubility and other characteristic parameter in combination with selected resin/adsorbent solid phase for a target separation system. As shown in upper right portion of FIG. 1, having three options of incoming mobile phase input mode, each sequential eluent liquid pushes the existing fluid out of other side of column along with each desorbed component in sequence to generate so called characteristic elution profile representing a complete separation cycle. The conjunction region between two back-to-back fluids as indicated is the particular target system's parameter profile 90 that represents predetermined parameter of mobile phase is progressively changing from that of feed solution toward particular elution liquid's parameter. Note that this parameter characteristic profile 90 starts from said MTZ which is the very beginning portion of column in which all of adsorbed solute components original in feed solution. Along with prevailing time domain, all adsorbed components can be selectively eluted from resin/adsorbent solid phase thus to flow with such mobile phase is governed by each said particular profile 90. The highest peak of eluted component profile 92, shown as a single profile for illustration, is pointed to its specific corresponding mobile phase parameter condition hereinafter being named as iso-point 91, at which particular adsorbed solute starts to elute from solid phase and returning to flow with mobile phase. In reality, it asserts an equilibrium contact status between solid and mobile phase with only particular parameter condition that each adsorbed solute component will not depart from its bounded site unless its surrounding mobile phase is favorable for such elution phenomena to occur. It means each parameter characteristic profile 90 with particular iso-point, and elution profile 92 are concurrence representing every adsorbed solute component has its own unique equilibrium contact status that only allow such solute component to be eluted from bonded status back to flow with such mobile phase. It means a neutral equilibrium point has to be triggered for each component prior to its elution. This fact relates to all adsorbed components that each adsorbed component may depart from resin/adsorbent only if the surrounding mobile phase condition exceeds its neutral point, iso-point 91, despite of fluid dynamics nearby. As further shown on upper very right portion of this FIG. 1, eluted components 92 flowing through said displacement zone 89 can be dispersed and widened caused by column end affect, axial dispersion, and diffusion along with mobile phase flow direction, such combined fluid dynamic effects resulting widening region as profile 92 approaching other end of the column. As aforementioned issues observed in typical chromatographic operation, fluid dynamic causing excess eluted peak dilution and thus increase cycle time and enhancing inefficient usage of resin/adsorbent solid phase. Thus, eliminating said displacement zone 89 is one of objects of this disclosure,

Second portion of FIG. 1 is schematic drawing for said Parametric Differential Moving Bed abbreviated as PDMB via exemplified twenty-four units of cells 95 utilizes identical mobile and solid phase combination in chromatography, yet, employed with new mass transfer equilibrium contact method to organize differential set-up as following procedures:
1. As described in new mass transfer equilibrium contact method via gradually adding and mixing resin/adsorbent solid phase in semi-dry status into predetermined volume amount of feed solution 93 comprising solute components to obtain optimal solid phase amount 94 required to promote at least one or all solute components been adsorbed onto added resin/adsorbent amount;
2. Disposing such amount of solid phase resin/adsorbent maintaining in semi-dry status into a single cell 95 and such amount is equivalent to formerly defined mass transfer zone 88, MTZ, and is the saturated resin/adsorbent amount in feeding zone 20 and is also equivalent to predetermined feed solution volume throughput in chromatography operation to saturated with like 5-15% of adsorbent;
3. Further differentiate such solid phase amount with a predetermined number in equally divided amount into each of bundled columns 23 contained in each said cell 95, in which each column 23 having an inlet on one side to receive liquid transmitted from above and an outlet on another side with bottom meshed filter to contain said solid phase from being drained;
4. Disposing each cell, exemplified as twenty-four cells 95, arranged in a particular pattern representing a combined zones of said feeding zone 20 and displacement zone 89 into disclosed apparatus, so that such plural cells arrangement as indicated is corresponding to typical chromatography sequential operation that covers loading and sequential elution steps as indicated in upper portion of FIG. 1;
5. Bottom portion of FIG. 1 is the simplified apparatus schematic drawing; detail of disclosed apparatus will further be illustrated in FIG. 2 through FIG. 5. This simplified drawing is to emphasize mobile phase being simultaneously transmitted in vertical direction interacting with stationary bundled of cells 95 arranged in endless loop and disposed in particular pattern, wherein;

Said upstream rotary union module when stops to receive all kind of liquids simultaneously transmitted from said upstream holding tank module, not shown to simplify drawing, via plurality of transit liquid conduct 97 and advance one step in rotation direction 20 then intermittently stopped to simultaneously transmit via multiple liquid pipe 98 such multiple liquids into top portion of each stationary plurality cells 95, exemplified as twenty-four cells 95, to proceed expected mass transfer equilibrium contact between mobile and solid phase in aforementioned separation module. As said bottom portion of the separation module exposed to vacuum environment and top portion being delivered with pressurized inert gas, treated and drained liquid collected from the separation module is simultaneously transmitted via multiple liquid pipes 99 via when said downstream rotary union module stopped to receive multiple kind of treated liquids and advance one step in rotation direction 20 then intermittently stopped to simultaneously via multiple liquid pipe 100 to discharge multiple kind of liquids into said downstream multiple holding tanks, not shown to simplify drawing.

So that, this PDMB continuously exposes the solid phase disposed in each cell 95 contained in said separation module that is simulated moving in horizontal direction to perpendicularly and simultaneously in contact with multiple kinds of mobile phase. The elution profile of a particular separation system derived from typical chromatography sequential operation is being arranged along the apparatus in horizontal direction to receive mobile phase transmitted in vertical direction to simultaneously achieve a complete separation cycle during duration of each said minimal time interval, Δt, being spent. Such Parametric Differential Moving Bed being designed through swift mass-transfer contact by the implementation of said new mass transfer equilibrium contact method and by above illustrated differential set-up between two phases employed onto disclosed apparatus. Through all of which, PDMB has demonstrated to achieve following:
1. Eliminate entire displacement zone 89 in chromatography process causing aforesaid excess dilution and to increase cycle time thus enhancing inefficient usage of resin/adsorbent;
2. Aforementioned engineering drawbacks of smearing component profile in column process such as axial dispersion along with diffusion effects are irrelevant with separation quality, include back mixing of column end effects;
3. Mobile phase in and out of column process like end-effects includes dead volume required to provide extra fluid volume amount to fill liquid pipe line from liquid introducing point and exist point of column system is avoided;
4. Feeding zone 20 is extended and equivalent to said MTZ 89, so that, retained resin/adsorbent in chromatography operation been maximized for each cell 95; mass transfer efficiency is also maximized via differential set-up to avoid peak broadening and overlapping; furthermore, as illustrated that elution profile of typical sequential chromatography is converted to horizontal direction to minimize cycle time during each spent of minimal time interval, Δt;
5. And lastly, solid phase disposed in apparatus being maintained in new mass transfer condition in said semi-dry status, though which high pressure operation is avoided.

In general, the scale up process design from bench top scale to production scale is to proportionally quantify the increment of capacity requirements via simply magnify with size increments to a larger process size. This differential set up has conceptualized and evidently changed that rule by increasing the number of bench-top scale to meet such capacity requirements. As all cells in said apparatus representing as one small scale that are independent from each other and simultaneously, perform one task at any instance such that integration and coordination of all cells represent a complete separation cycle. The traditional scale-up strategy focuses mainly on size increment and often ignores the coordination that part of stages may be idled during the preceding of entire operation. Particularly in column operation been long recognized for inefficient usage of packing materials, this invention has clearly ratified the strategy of scale up by implementation of differential method between two phases and new mass transfer equilibrium contact method. The preferred apparatus has demonstrated the mechanical capability to implement and transform the path of the mass transfer from sequentially vertical direction to simultaneously horizontal direction. Both methods and means to implement such methods are tied together as hybrid embodiments. These hybrid embodiments can be extended to other chemical operation such as catalytic reaction would inherently involve the use of a catalyst disposed in a packed bed and ordinary fluidized first order chemical reaction in connection between solid and liquid phases. Particularly, unit chemical operation composes of sequential stages that are linked together to carry out such sequential operations. Furthermore, adding packed bed like activated carbon for decolorization and/or deodorization, or isomerization catalytic enzyme imbed fluidized bed can be orderly disposed within disclosed apparatus with at least one cell 95 as zone to perform specific task to consolidate as unit operation in sequence after purification is completed. So that, the capabilities of cycle time reduction via differential method and preferred apparatus can benefit reduction of process size proportionally and ends up with production cost reduction.

FIG. 2 is preferred apparatus constructed for broad illustration of particular separation system comprising selected combination between solid phase and mobile phase derived from typical chromatographic operation for large scale production apparatus. The detailed and generalized illustration of apparatus itself is an improved version compared with above-cited patents. The preferred apparatus comprises at least one of modules marked as A, B, C, D, E, and F; each functions independently and yet coordinated in sequence to achieve continuous isolation of at least one component as product from mixture of components dissolved in particular homogeneous feed solution. To simplify illustration for said apparatus, an example of twenty-four zones schematic drawing represents said modules shown on left side of drawing, whereas right side exploded drawing representing each single unit disposed in respective module for flow of mobile liquid phase transmitting in a closed loop among modules connected in sequence.

### 1. Upstream Holding Tanks Module A:

Having same holding tanks in size for simplicity of drawing or different in size of twenty-four holding tanks as Upstream Holding tanks Module 12, all tanks arranged in an organized array in a selected pattern as preferred set up and denoted as A on right side of the drawing. Each holding tank means for receiving predetermined volume amount of liquid solution through line 47 via preferred volumetric pump, not shown for drawing simplicity, or not limited via other means of transporting particular liquid from assigned tank in the downstream holding tanks module. Said each of plurality of holding tanks means for intermediate storing of particular liquid solution; and means for simultaneous transporting entire volume amount of such liquid into assigned destination of following module. Such plurality of holding tanks set inside selected heat media circulation insulated jacket 11. Water can be preferred heat media between 0 degree and 100-degree C. unless specified otherwise based on requirement of particular separation system. For temperature range below 0 degree C., brine (water with salt) or water adding anti-freeze can be used, whereas mineral oil or other synthetic heat carrier can be used for temperature range above 100-degree C. Such jacket 11 comprising a heat media inlet via a manifold 13 and heat media outlet via another manifold 14 to maintain whole plurality of holding tanks in a selected temperature range. Such selected twenty-four holding tanks is to follow same in FIG. 1 as an exemplified illustration. Each said holding tank representing by a single holding tank 15 of whole plurality has an inlet conduct 16 to receive liquid. Said conduct 16 is extended out of said jacket 11 and is installed with selected check valve named as flipper 1 inside at bottom of said conduct 16. Low range pressure dry inert gas enters via pipe 7 that is extended out of said jacket 11 and shown next to said conduct 16. Each tank has an outlet 17 extended downward of said jacket 11 to discharge whole of stored liquid. There has a selected check valve named as flipper 2 installed at top of conduct 17 and there has pipe 8 means for entering medium range pressure dry inert gas. Both conduct 17 and pipe 8 are extended outside of said jacket 11. For simplicity of drawing, only six of front tanks shows by a curve dot line 18 for liquid distribution to the following rotary union multiple valves module B.

### 2. Upstream Rotary Union Module B:

This preferred upstream multiple valves module, denoted as B, having a rotational circular multiple valve body 19 driven by a Servo-motor, not shown for drawing simplicity, rotate intermittently stopped and stepped forward at a predetermined equal angle in a selected clockwise or counter clockwise 20 direction. When valve body 19 stopped means for predetermined volume amount of all particular liquids are promptly and simultaneously transferred. Said multiple valve body 19 having a plurality of top side liquid transit storage reservoirs 21 installed at predetermined location to simultaneously receiving said predetermined volume amount of liquid transferred from particular holding tank of above said upstream holding tanks module A. Said rotational valve body 19 having an equal quantity of outlet conduct 22 equipped with preferred top side pressure activated spring valve body, not shown for drawing simplicity, means for holding liquid and installed bottom side at corresponding location to precisely transmit said predetermined volume amount of liquid to next following module as shown on right side exploded diagram. Soon received all kind of liquid in each said reservoirs 21 is satisfied, valve body 19 steps forward one rotation angle step, then to transmit stored liquid to following module and waiting for another round of liquid throughput. During duration of time interval between stopped and rotation step forward of said valve body 19, all kinds of liquid stored in each said holding tanks module A is simultaneously delivered from particular holding tank via upstream rotary module B to assigned cell 95 disposed in following separation module. It is contrast different from liquid handling observed in chromatographic process including nowadays well adopted simulate moving bed (SMB) process.

### 3. Separation Module C:

Having a plurality of said cells 95 arranged in preferred pattern wherein is denoted as C. As aforesaid each cell 95 comprising a plurality of columns 23, each column has a top side opening 24 means for liquid input and bottom screen filter 25 means for retaining equal amount of said resin/adsorbent from been drained. All cells 95 disposed in an approximate organized array of said holding tanks module as preferential set up for easier organizing liquid flow from corresponding holding tank in said holding tanks module A via said rotary union module B. Such group of cells 95 set inside an insulated selected heat media circulation jacket 36. Water can be preferred heat media between 0 degree and 100-degree C. unless specified otherwise based on requirement of particular separation system. For temperature range below 0 degree C., brine (water with salt) or water adding anti-freeze can be used, whereas mineral oil or other synthetic heat carrier can be used for temperature range above 100-degree C. Such circulation jacket 36 comprising a heat media inlet via a manifold 26 and heat media outlet via another manifold 27 to maintain whole plurality of cells 95 in a selected temperature range. Such bundled twenty-four cells 95 is to follow above discussed FIG. 1 for exemplified illustration. As shown on right side exploded diagram, each cell 95 has a liquid inlet conduct as temporary transit reservoir 28 extended out of the jacket 36 to receive particular liquid delivered; through selected check valve named as flipper 3 located at reservoir 28 top, via said upstream rotary union module B from corresponding holding tank and via down below of selected type of liquid dispenser depending on type of cell construction like exemplified showerhead 29 that has as particular for multiple columns disposed in single cell 95. Such exemplified showerhead 29 is comprising of a top side selected check valve named as flipper 4 installed inside between bottom side of reservoir 28 and top side of showerhead 29 via controlling on and or off of entering pressurized inert gas to intermittently drop in parts of delivered liquid out of reservoir 28 or stop transmitting such stored liquid as aforementioned format selected in between input S-I and input I-I. There has a pipe 9 located between said flipper 3 and flipper 4 as shown means for entering high range pressurized dry inert gas into said reservoir 28. Each cell 95 top has a pipe 30 means for simultaneously and intermittently receiving supply of high range of pressurized dry inert gas.

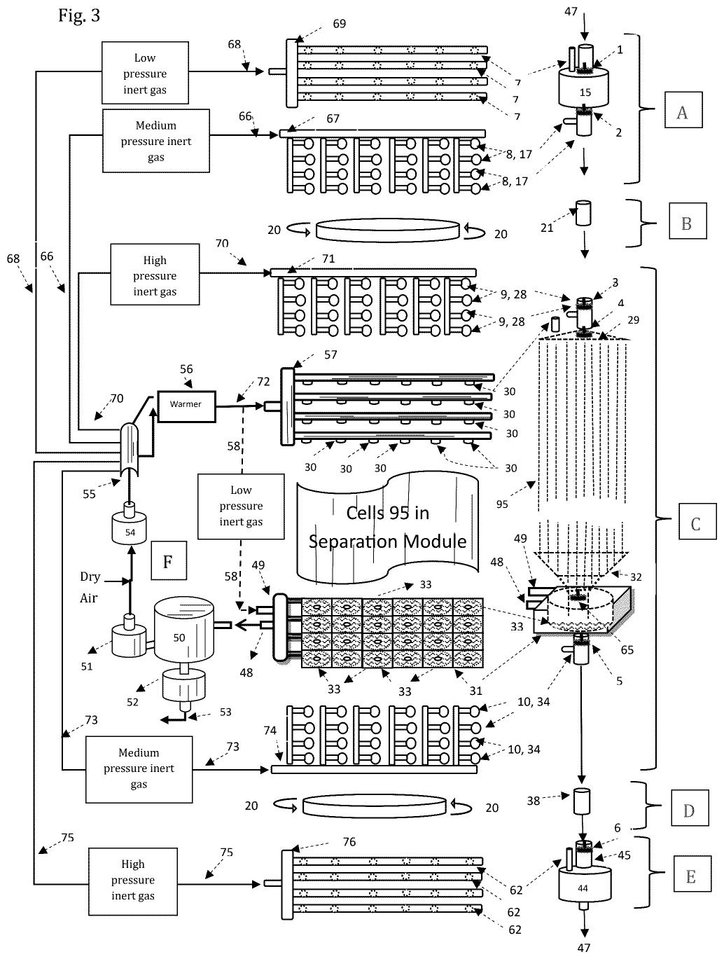

Each cell 95 bottom is exposed to vacuum environment 31; such vacuum exerted via inert gas supply module will be further illustrated in FIG. 3, having an exit for mobile phase mist enriched inert gas via conduct 48 to maintain said resin/adsorbent in new mass transfer condition in a semi-dry status, and to affiliate liquid draining via funneled shape liquid conduct 32 into each underneath temporary liquid reservoir 33 means for treated liquids from various zones redistributed for further applications. There has manifold 49 means for supplying low range pressurized inert gas when vacuum 31 is shut off. Said liquid conduct 32 installed inside with a selected check valve named as flipper 65. Each bottom of liquid reservoir 33 has a liquid conduct 34 and its bottom inside installed a selected check valve named as flipper 5 wherein has a pipe 10 connected to conduct 34 located below flipper 5; both pipe 10 and conduct 34 are extended outward said insulated jacket 36. Arrange to transfer various liquid stored in respective liquid reservoir 33 into following modules will be illustrated further in following FIG. 3.

### 4. Downstream Rotary Union Module D:

This preferred downstream multiple valves module, denoted as D, having a rotational circular multiple valve body 37 driven by a Servo-motor, not shown for drawing simplicity; rotate in same direction with said upstream rotary union module 19, stepping forward at same predetermined equal angle in a selected clockwise or counter clockwise 20 direction. Said multiple valve body 37 having a plurality of top side liquid transit storage reservoirs 38 installed at predetermined location to receive said treated all kind of liquids transferred via each liquid conduct 34 of above aforesaid separation module C. When valve body 37 stopped means all kind of liquids collected in each cell bottom reservoirs 33 are simultaneously delivered and stored in said reservoir 38. This rotational valve body having an equal quantity of outlets conduct 39 equipped with preferred top side pressure activated spring valve body, not shown for drawing simplicity, means for holding liquid and installed at corresponding location to precisely transmit particular liquid to each assigned holding tank disposed in following downstream holding tanks module. Soon all kind of liquids available in said reservoir 38 simultaneously transmitted via conduct 39 are completed, valve body 37 stepped another predetermined rotation step to repeat aforesaid operation; in event of steady state operation wherein valve body advance one rotation step means disclosed apparatus achieve one complete separation cycle during each spent of minimal time interval, Δt.

### 5. Downstream Holding Tanks Module E:

Having same holding tanks in same size for simplicity of drawing or different in size of twenty-four holding tanks 40, denoted as E. Each holding tank is assigned for receiving particular liquid via each conduct 39 from above mentioned downstream rotary union module D; arranged in an organized array in a selected pattern as preferred set up. Such group of holding tanks set inside an insulated selected heat media circulation jacket 41. Water can be preferred heat media between 0 degree and 100-degree C. unless specified otherwise based on requirement of particular separation system. For temperature range below 0 degree C., brine (water with salt) or water adding anti-freeze can be used, whereas mineral oil or other synthetic heat carrier can be used for temperature range above 100-degree C. Such circulation jacket 41 comprising a heat media inlet via a manifold 42 and heat media outlet via another manifold 43 to maintain whole plurality of holding tanks in a selected temperature range. Such selected twenty-four holding tanks is to follow same discussed FIG. 1 as an exemplified illustration. Each holding tank representing by a single holding tank 44 of whole plurality has an liquid conduct 45 wherein installed top with selected check valve named as flipper 6; such liquid conduct 45 extended upward of said jacket 41 means for freely receiving particular liquid via opened flipper 6 and has a liquid conduct 46 extended downward of said jacket 41 means for discharging stored liquid via line 47. Depending on requirement of target separation system after each holding tank been assigned for receiving particular liquid solution, means for discharging components of particular solution as at least one isolated product via line 47 into respective assigned storage tank; means for discharging components in particular solution as by product via another line 47 into respective assigned storage tank; and means for transmitting in part of available solute stored in respective holding tank 44 via 47 in predetermined volume amount recycling back via each volumetric pump or other means for liquid transmitting, not shown for drawing simplicity, into each assigned holding tank in aforesaid upstream holding tanks module A. There has a pipe 62 installed next to conduct 45 means for supplying high range pressurized inert gas. There has a preferred liquid level sensor 63 installed inside each holding tank 44 to maintain predetermined liquid level of stored liquid within, means such level sensor 63 is to control delivering sufficient volume of particular solution via liquid conduct 64 to monitor predetermined liquid level setting in respective holding tank 44. For simplicity of drawing, only six of front tanks shows by a line 47 for particular liquid distribution to respective assigned holding tank of said upstream holding tanks module A; except to aforementioned by product storage tank and to at least one isolated product storage tank.

Note that “selected check valve name as flipper” is an option of pneumatic check valve that is related with supplying broad range of pressurized inert gas; again, depending on target system requirement like throughput capacity, hygiene operation environment and so on; options can be electric controlled solenoid valve, hydraulic check valve, pressure activated spring check valve or other selections due to design preference. Thus, it is clear that all drawings and examples are mainly for illustration and possible extent of alternation or configurations of mechanical device onto preferred apparatus may be explored. Yet, fundamental concept of this disclosure should set above such possible modification and be governed within the scope of this invention is a hybrid of methods, “Parametric Simulated Moving Bed”, PSMB that is fundamentally differentiated with chromatographic operations.

### 6. Inert Gas Supply Module F Illustrated in FIG. 3 and Denoted as F:

Focusing on routing for supplying broad range pressurized inert gas to incorporate with said module A, B, C, D and module E to affiliate transmitting multiple liquid solution within disclosed apparatus and maintaining disposed resin/adsorbent in semi-dry status; thus to coordinate with each module being thoroughly illustrated in FIG. 2 and impending FIG. 3 hereinafter. Inert gas supply module disposed in this disclosed apparatus comprises three generalized portions and classified as closed vacuum environment loop, upstream broad range inert gas supplying loop, and downstream broad range inert gas supplying loop.

1. Closed Vacuum Environment Loop, as Aforementioned in FIG. 2 Each Cell 95 Bottom portion of separation module C being exposed to said vacuum environment 31; again such closed loop is shown on mid part of this FIG. 3 comprising manifold conduct 48, mist separator 50, central vacuum pump 51, means for simultaneously prompt liquid draining into each said plurality of temporary liquid reservoirs 33 and meanwhile extracting mobile phase liquid enriched mist inert gas to maintaining said resin/adsorbent in new mass transfer condition in a semi-dry status to meet criterion of new mass transfer equilibrium contact method; means to create a heterogeneous contact as liquid promptly sipping through stationary resin/adsorbent particles; and means for converting mobile phase liquid enriched inert gas to dry inert gas. The whole time, mist enriched inert gas exited said manifold 48 first passing through mist separator 50 to remove mobile phase liquid moisture/vapor, prefer using cold water condenser to condense mobile phase liquid moisture/vapor or passing through other means to recover water soluble mobile phase liquid to store collected liquid in reservoir 52 via liquid conduct 53 to recycle such mobile phase liquid. Such dry inert gas exiting mist separator 50 is combined with pressurized dry air and deployed through an inert gas generator 54 to obtain fresh dry inert gas and to store in a steel tank vessel 55 maintaining at preferred broad range of pressure level inert gas ready for deploying back to following modules;

2. Upstream broad range inert gas supplying loop means for upstream holding tanks module A and cell 95 top portion in said separation module C, wherein via line 66 out of said tank vessel 55 supplying medium range pressurized inert gas through manifold 67 for upstream holding tanks A to simultaneously deploys via respective pipe 8, whereas low pressure inert gas via pipe 7 is shut off; so that flipper 1 is opened to allow predetermined liquid volume amount transferred from assigned tank in said downstream holding tanks module E via particular volumetric pump or other means for liquid transmitting, freely passing through via line 47 whereas flipper 2 is pushed upward to block liquid from flowing downward to temporarily store delivered liquid into each holding tank 15 in said upstream holding tanks module A.

As above mentioned operation is concluded, medium pressure inert gas via pipe 8 is promptly shut off; meanwhile simultaneously out of tank vessel 55 via line 68 to supply low range pressurized inert gas through manifold 69 via each pipe 7, together yet separately via line 70 to supply high range pressurized inert gas through manifold 71 via each pipe 9; such operation resulting to close both flipper 1 and flipper 3 and to open flipper 2 for freely liquid throughput via liquid conduct 17 from holding tank 15 into respective transit reservoir 21 in upstream rotary union module B; said rotary valve body shown as upstream rotary union module B promptly advance one rotation step.

Soon said upstream rotary union valve body is stopped, low pressure inert gas via pipe 7 and high pressure inert gas via pipe 9 are both promptly shut off; meanwhile simultaneously out of tank vessel 55 via line 66 to resume supplying medium range pressurized inert gas through manifold 67 via each pipe 8 together yet separately to supply high range pressurized inert gas via line 72 through manifold 57 via each pipe 30 to supply of high pressurized inert gas, so that such operation resulting to simultaneously close said flipper 2 and flipper 4, resulting simultaneously to transmit entire liquid stored in respective transit reservoir 21 of valve body via opened flipper 3 into respective reservoir 28 located at top portion of said separation module C.

Soon aforesaid operation is completed, high pressure inert gas via pipe 9 is promptly turned on in a predetermined short time duration to close flipper 3; whereas inert gas via pipe 30 is meantime shut off, resulting liquid stored inside reservoir 28 to promptly pass freely through flipper 4 to drop in parts of stored liquid during said very short time period to wet top portion of installed solid resin/adsorbent. Then, immediately soon high-pressure inert gas supply via pipe 30 is turned on and whereas via pipe 9 is meanwhile shut off, such operation means for pushing back flipper 4 to stop liquid from dropping; means for pushing liquid through said resin/adsorbent contained in each cell to complete expected aforesaid mass transfer equilibrium contact between two phases. Alternatively repeating operation between on and or off supplying inert gas between pipe 9 and pipe 30 with dividing stored liquid in reservoir 28 in predetermined liquid doses means to proceed differential set up between solid and liquid phase which is governed under current disclosure.

3. Downstream broad range inert gas supplying loop means for all cells 95 bottom portion in said separation module C and downstream holding tanks module E, wherein as aforementioned, bottom portion of separation C is exposed to vacuum environment 31 containing entire bottom part of separation module in order to continuously and simultaneously drain dropped doses of liquid solution from respective cell 95 top to store in respective transit liquid reservoir 33, wherein such reservoir having widely opened top. Meanwhile, medium range pressurized inert gas out of said tank vessel 55 through line 73 via manifold 74 via each pipe 10 is simultaneously turned on, such operation means for supplying medium pressure range inert gas when vacuum 31 is exerted to push upward said flipper 5 to hold treated and drained liquid stored in respective holding tank 33.

Promptly after liquid draining is completed, whereas vacuum 31 and said medium range pressurized inert gas via each pipe 10 are both shut off; both low range pressurized inert gas supplied via manifold 49 and high range pressurized inert gas supplied via pipe 62 are promptly turned on, so that both flipper 65 inside funneled conduct 32 and flipper 6 inside liquid conduct 45 are both closed, meanwhile flipper 5 in conduct 34 is opened to allow entire stored liquid in respective reservoir 33 simultaneously freely transferring into each underneath liquid transit storage reservoirs 38 in said downstream rotatory union module D; said valve body 37 in downstream rotary union module advance one rotation step and promptly after multiple valve body is stopped, medium pressure range inert gas resume supplying via pipe 10 and high range pressurized inert gas supplied via pipe 62 is turned off, such operation resulting to close flipper 5 to push stored liquid in each reservoir 38 freely via liquid conduct 45 through opened flipper 6 into each assigned holding tank in said downstream holding tanks module E.

As aforesaid illustration, this inert gas supply module F is sub-module integrated with the separation module C to incorporate with other modules as disclosed apparatus shown in FIG. 2. During duration of each spent time interval in steady state operation, all kind of liquid solutions simultaneously distributed entire available liquid solution from respective holding tank 15 in upstream holding tanks module A through each transit reservoir 21 in upstream rotary union module B, and simultaneously intermittently disposed into respective cell 95 body in separation module C to carry out mass transfer equilibrium contact; treated and collected liquid in each transit reservoir 33 transferred via each transit reservoir 38 in downstream rotary union module D into each assigned holding tank in downstream holding tanks module E, through downstream holding tanks module E, recycling back to upstream holding tanks module A in a close loop to carry out in a form of said new mass transfer equilibrium contact to continuously achieve separation of particular target separation mixture in a repeated manner. Such organized liquid transferring operation is carried out via controlling broad range of pressurized inert gas incorporated with aforesaid modules for this ultimate objective separation for mass production of target separation system.

Prior supplying high range pressurized inert gas through line 72 via manifold 57 via each pipe 30 entering said separation module C, there has a preferred inline gas temperature adjuster 56 installed to assure fresh dry inert gas, depending on target system requirement, maintained in desired temperature level slightly above all kind of liquid solutions temperature range means to prevent microbiological growth or reducing liquid viscosity and in some case maintaining at preferred temperature range to reduce dissolved components sensitive to variation of operation temperature preventing from being deteriorated. Maintaining said upstream holding tanks module A, downstream holding tanks module E, and separation module C within predetermined temperature range means are for same requirement of target separation system.

Preferred broad range pressure level set for inert gas is set in between 40 to 90 psi within pressurized inert gas supply module, wherein preferred low range pressurized inert gas is set in between 40 to 55 psi means for providing enough pressure for quickly pushing liquid into next following upstream rotary union module and or downstream rotary union module, wherein preferred medium range is set in between 55 to 70 psi means for providing enough force onto mechanical flipper to holding the entire transmitted liquid weight, wherein preferred high range pressurized inert gas is set in between 70 and 90 psi means for providing enough force onto mechanical flipper to support the entire transmitted liquid weight and providing enough pressure to push dropped liquid quickly sipping through respective column disposed in each cell, and or pushing entire liquid promptly into assigned holding tank in downstream holding tank module. Preferred inert gas used for this disclosed apparatus is nitrogen, carbon dioxide, argon or mixtures of gas in portions to reduce oxygen oxidation with resin/adsorbent from hindering long term separation efficiency. For some separation system, components to be isolated are not sensitive to air oxygen, pressurized air is preferred. Preferred vacuum level is between 15 in-Hg to 27 in-Hg. Such inert gas close loop circulation module F integrated with separation module C means for affiliating prompt liquid draining; means for preventing possible microbiological growth; means for as carrier to affiliate removing mobile phase liquid enriched moisture/vapor as elevated concentration level of various liquid stream been transmitted within apparatus. For binary separation system amid proceeding of glucose and fructose separation; means for reducing eluent water consumption of condensed water; and ultimately reducing power consumption as well in this disclosed apparatus.

For purpose of large-scale process design and construction for a target feed throughput in order to obtain at least one component purification from mixture of same; expansion of particular module in size and/or operating of multiple modules in parallel are deemed as part of disclosed apparatus in total; and that is understandable as subset of an expandable disclosed apparatus. Furthermore, such addition of increasing quantity of same module or module connected in sequence as plurality of sequential modules operated in parallel is also governed under this disclosed apparatus. That said, these modules simultaneously operated in parallel will be readily exemplified in following FIG. 12 through FIG. 14 for binary glucose and fructose separation, whereas other modules as single component to match with predetermined liquid volume throughputs. For example, said separation module C can expand to modules operated in parallel for alternate resin/adsorbent regeneration of particular module without shutting down whole apparatus. Holding tanks module, A or D, can be increased in size and distribute liquid solution via upstream rotary module B to separation module C operated in parallel and distribute back to holding tank module E via downstream rotary module D. Urgent situation like in event of mechanical failure in particular module, the part of apparatus can be shut down for maintenance without harming other part of apparatus operation. This flexible set up as a whole apparatus among each independently operated modules provide flexibility in throughput requirement, operation smoothness, and reducing down time required for maintenance.

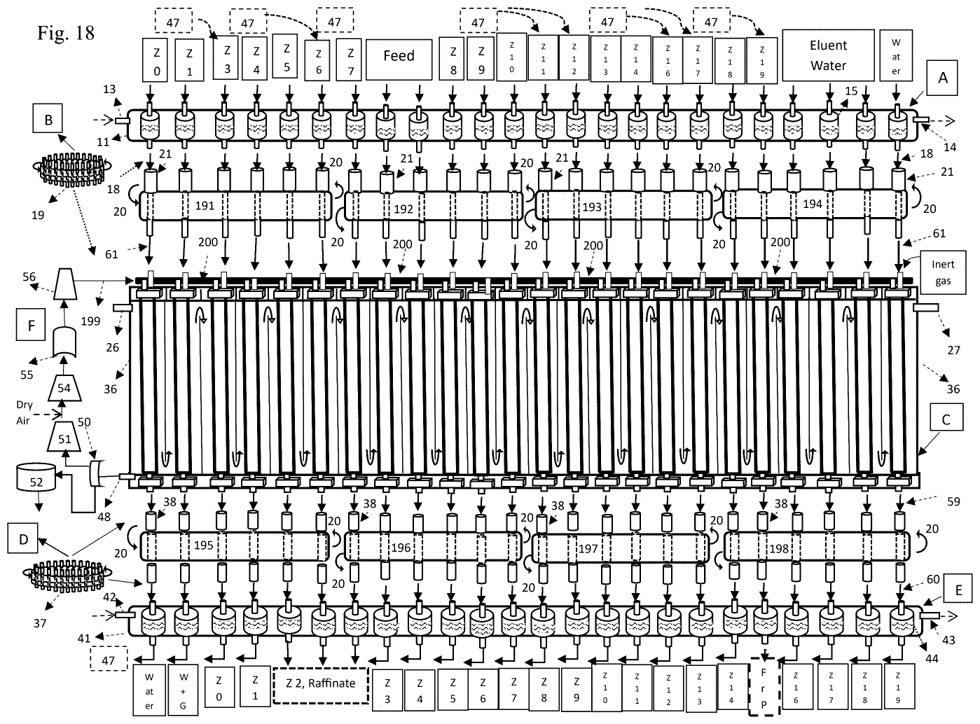

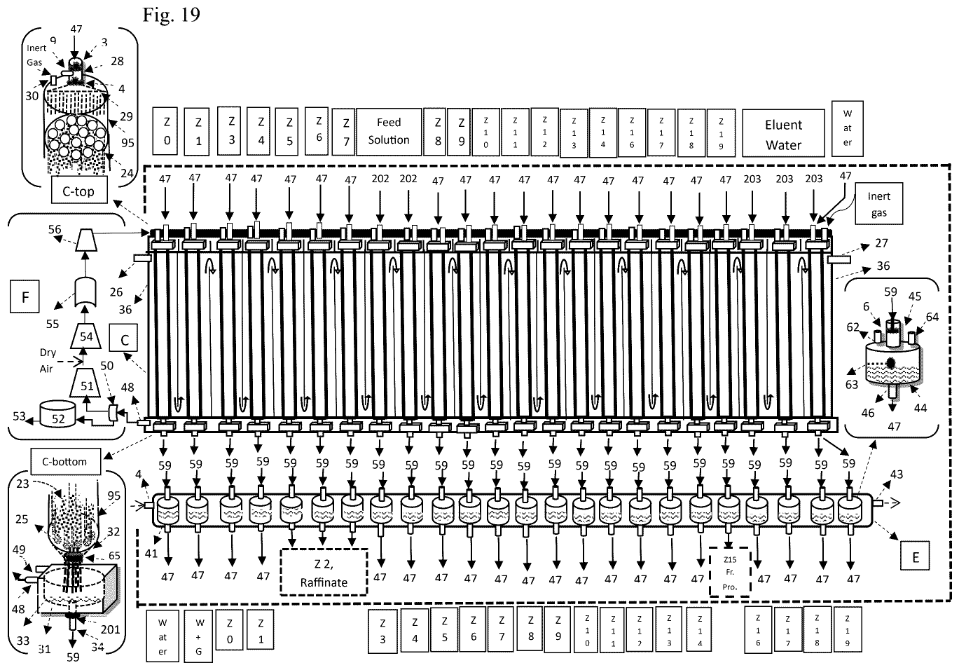

Other alternative process design may consider massive operation capacity like 300 gallons/minute feed throughput, to break down or divide upstream rotary union module B and downstream rotary union module D into equal parts to elevate weight load in parts as whole upon single rotary union module, example such as disposing six of transit reservoirs in ¼ of total twenty-four count disposed in sub-rotary module and integration four of such sub-module functions as one module containing twenty-four of transit reservoirs. In addition, some process development already been thoroughly evaluated and obtained satisfactory separation through means of proved characteristic profile result. Amid pilot apparatus and/or production process design may omit some modules like upstream holding tanks module A to directly introducing various liquid, including recycled liquid, feed solution, and other eluent mobile phase liquid into upstream rotary union and then transmitted into assigned cell top of respective cell disposed in separation module C to proceed differential set up for mass transfer equilibrium contact between selected mobile and solid phase. There have other configurations to further omit both upstream rotary union module B and downstream rotary module D disposed in this apparatus for a satisfactory process design. Again, this shall be deemed and be governed under this disclosure. Anyhow, for sake of argument, impending FIG. 17, FIG. 18 and FIG. 19 shall exemplify to elucidate such possible modification or alteration of components disposed in the disclosed apparatus purposely to fit for mass throughput process design is again governed under this disclosure; again, it is purely relied upon particular separation system evaluation.

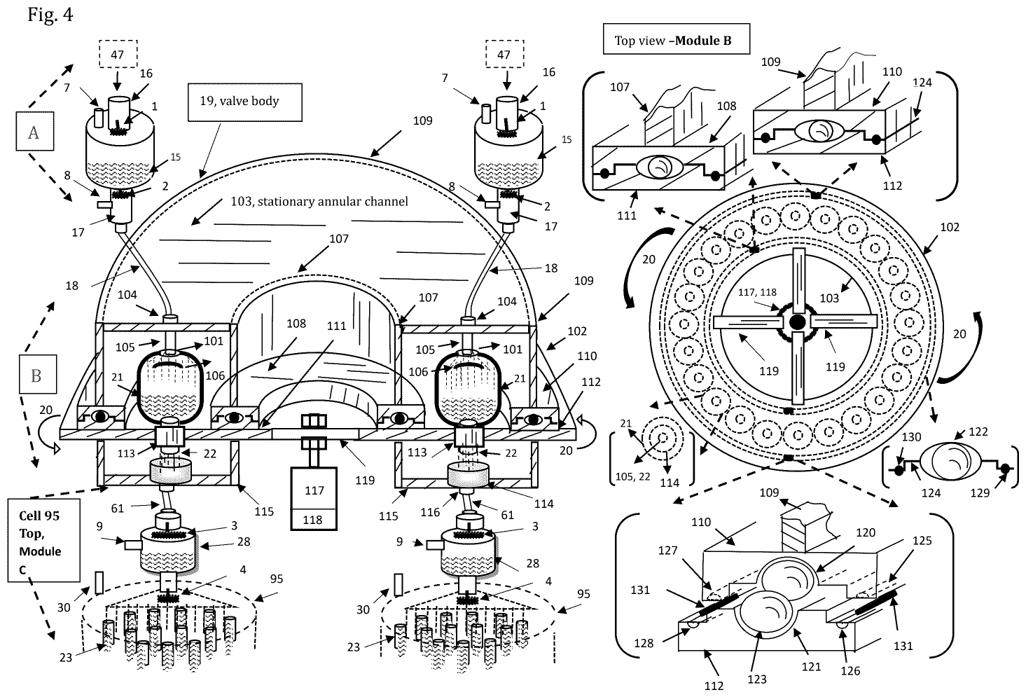

In FIG. 4, left portion is the cross-sectional perspective view of preferred apparatus emphasizing on upstream rotary union module B comprising said valve body 19 as the bridging module providing various kind of liquids transmitted from respective holding tank 15 in said upstream holding tanks module A into top portion of said separation module C via rotation and seal mechanism shown on right portion of this FIG. 4. Briefly reiterate illustrated in FIG. 2 and FIG. 3, only two of multiple holding tanks 15 are shown on top of FIG. 4 left portion for holding predetermined volume amount of particular liquid among all kind of liquids simultaneously delivered from respective holding tank 44 in downstream holding tank module E (not shown) via respective line 47 as indicated via liquid conduct 16, extended upward of said heat media circulation insulated jacket 11 (not shown), via opened flipper 1 and closed flipper 2 into each holding tank 15; wherein broad range of pressurized inert gas being supplied via gas pipe 7 and gas pipe 8 to alternatively control opening and closing of said flipper 1 and flipper 2. Amid flipper 2 being opened, stored liquid in respective holding tank 15 being pushed via its liquid conduct 17, extended downward of said heat media circulation insulated jacket 11 (not shown), via respective pipe 18 into said upstream rotary union module B as bridging module.

Such upstream rotary union module B contains a plurality of said transit reservoir 21 shaped like jar with top opening 101 and said bottom liquid conduct 22 equipped with said preferred pressure activated spring valve body 113 disposed near top vicinity of the conduct 22; only two reservoir 21 are shown in connection as matching pair with above two holding tank 15 for illustration and are corresponding to exemplified twenty-four reservoirs 21 shown on right portion of this figure. Such reservoir 21 mounted equally in one or multiple layers; exemplified as one layer for drawing simplicity, along the predetermined equal angles of multiple angle lines and circumference in each predetermined bored hole location of a horizontal circular plate 102 with extended downward said liquid conduct 22. The whole group of evenly spaced reservoir 21 is disposed inside an endless flattop reversed “U” shape stationary annular channel 103 to cover plurality of components including reservoirs 21. On outer top surface of stationary annular channel 103 installed a plurality of nipple 104 paired corresponding in between said pipe 18 and each reservoir 21 and each nipple has an extended downward liquid conduct 105 disposed inside of said channel 103 in vicinity above inlet opening 101 of reservoir 21 to precisely discharge liquid transmitted via said liquid pipe 18 from said corresponding holding tank 15, splashing over a less than 180 degree baffle 106 disposed underneath conduct 105 inside of reservoir 21, like an umbrella shape smoothly sliding down along inner wall into said reservoir 21. Said annual channel 103 has been secured and supported with curved inner and outer rim mounted vertically on top surface of concentric paired railings and installed along the central axis of horizontal plate 102. The inner rim 107 is secured on inner-top railing 108 and outer rim 109 is secured on outer-top railing 110. A matching inner-bottom railing 111 and matching outer-bottom railing 112, both railing 111 and railing 112 have flat bottom smooth surface to be tightly fastened with top-surface of said plate 102.

As aforesaid, soon received all kind of liquid in each said reservoirs 21 is satisfied from liquid originally held in above holding tank 15 via respective line 18. Valve body 19 steps forward one rotation angle step, then supply via said broad range pressurized inert gas illustrated in FIG. 3 to simultaneously to close said flipper 2 and flipper 4 and open said flipper 3 via said medium range pressurized inert gas through same pipe 18 pushing entire liquid stored in respective transit reservoir 21 via pressure activated opened valve body 113 through liquid conduct 22 into underneath stationary wide open top funnel 114 as transit vehicle evenly disposed at corresponding location with said liquid conduct 105 to precisely handle all kind of liquid transferred in between, wherein funnel 114 disposed at bottom floor of U shaped annular stationary compartment 115 securely supported via other means so that has small gap between bottom surface of horizontal plate 102 and compartment 115, so that, plate can freely rotate along its rotation path as instructed and to maintain minimal leak of pressurized inert gas. Transmitted liquid further pass through nipple 116 disposed outside of such stationary compartment 115 connecting with said liquid conduct 61 illustrated in FIG. 2 into respective reservoir 28 located at top portion of said separation module C that each cell 95 comprising plurality of bundled column 23 to carry out expected mass transfer equilibrium contact between mobile and solid phase and said bridging upstream rotary union module B waiting for another round of liquid throughput.

As aforesaid, rotational circular multiple valve body 19 employed as part of upstream rotary union module B for bridging to transmit various kind of liquids; such valve body 19 comprise a rotation and positioning together with sealing mechanism with preferred center mount servo-motor 117 and may equip with a speed reducer usually gearbox or motor brake 118 if needed for maneuvering heavy load rotation depending on apparatus design preference. Such servo-motor 117 rotates said plate 102 disposed with plurality of equally mounted reservoir 21 via stretch bars 119 in predetermined clockwise or otherwise in counter-clockwise stepwise direction 20. The direction of rotation and the range of one rotation step are preset and remain unchanged for one reservoir at a time or more than one as a group. Initially, the motor 117 receives the signal from the controller to energize and rotate said plate 102 forward. The plate 102 continuously rotates forward until rotation step is satisfied in order to de-energize the motor and concurrently initiate the motor brake 118 to halt the rotation of plate 102. It shall be understood that there is no limitation of other alternatives of motion control systems can be utilized for such rotation and positioning purpose, such as actuator in options of energy source like hydraulic actuator or pneumatic actuator, or light sensor system using light sensor to signal central mount motor to move forward and stop at predetermined rotational angle.

Right portion of this FIG. 4 further illustrates preferred rotation and seal mechanisms via an exploded profile of exemplified twenty-four top view of reservoir 21 and railing system. A blown up top view of a single reservoir 21 indicating said liquid conduct 105 as liquid top entry into reservoir 21 and liquid conduct 22 as bottom liquid outlet into beneath funnel 114 being lined up vertically means for repeated simultaneous transmitting of all kind of liquids being out from respective holding tank of said module A via bridging module B amid plate 102 is in immobile status into top portion of said separation module C. Briefly repeating via a blown up view of inner rim 107 being secured on inner-top railing 108 and outer rim 109 being secured on outer-top railing 110 and paired with matching inner-bottom railing 111 and matching outer-bottom railing 112, both paired railing systems are tightly fastened with top-surface of horizontal plate 102 disposed with exemplified twenty-four of equally mounted reservoirs 21 contained inside of stationary annular channel 103 to rotate intermittently along its circular path driven by center mount servo-motor 117 and brake 118 via stretch bars 119. For paired railing systems of 108 with 111, and 110 with 112 are resemble in structure, just the pair of 110 and 112 being illustrated via exploded view in lower portion for rotation and seal mechanism. As shown, railing 110 has a center down-face half-oval shaped groove 120 to match the center up-face half-oval shaped groove 121 on railing 112. Combined of groove 120 and 121 generates a concentric oval-shaped tunnel 122 as demonstrated by railing pair of 110 and 112. Circular balls 123 with its diameter slightly larger than vertically height of 122 are laid within such that a gap 124 is formed for free mobilization of said plate 102 driven via said servo-motor 117. There have half-circular grooves 125, 126, 127, 128 being shaped as concentric circular tunnel 129 and 130 to accommodate circular shape O-ring type seal 131 with its diameter just big enough to seal said gap 124. It is clear that the configuration of railings, steel balls, and predetermined quantity of O-ring seals furnish a sufficient frictionless rotation and positioning together with seal mechanism for said plate 102, providing minimal gas leakage for said stationary annular channel 103 to maintain mid-range pressurized inert gas to transmit all kind of liquid within said bridging module and prevent micro-organism growing within.

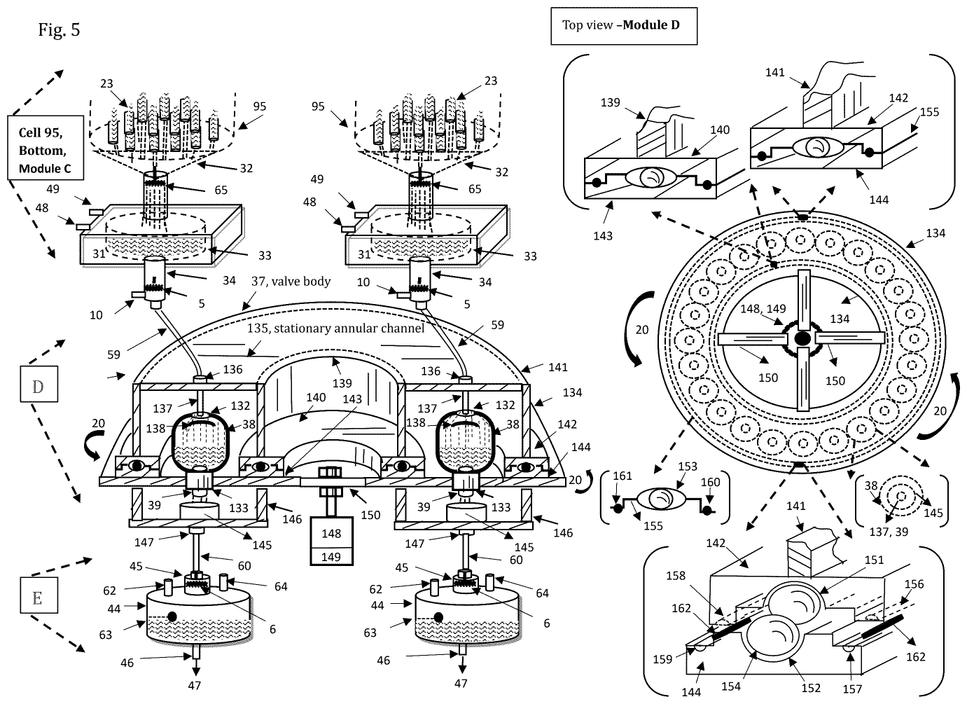

In FIG. 5, left portion is the cross-sectional perspective view of preferred apparatus emphasizing, via each paired of two out of exemplified twenty-four components, through downstream rotary union module D comprising said valve body 37 as the bridging module providing various kind of liquids transmitted from bottom portion of separation module C into respective holding tank of downstream holding tank module E together with rotation positioning and seal mechanism shown on right portion of this FIG. 5. Briefly reiterate illustrated in FIG. 2 and FIG. 3, only two of cell 95 bottom portion are shown as comprising plurality of said column 23 exposed to vacuum environment 31. Such vacuum exerted via inert gas supply module F having an exit for mobile phase liquid enriched inert gas via conduct 48 to maintain said resin/adsorbent in new mass transfer condition in a semi-dry status, and to affiliate liquid draining via funneled shape liquid conduct 32 through opened flipper 65 amid closed of flipper 5 via supplying of medium range pressurized inert gas via each pipe 10 into each underneath temporary liquid reservoir 33. Soon treated and treated and drained liquid being completed, such entire collected liquid then been pushed to transmit via means of supplying said low range of pressurized inert gas through manifold 49 to close said flipper 65 via liquid conduct 34 through opened flipper 5, amid stop supplying of medium range pressurized inert gas via said pipe 10, through said liquid pipe 59 into respective top side liquid transit storage reservoirs 38 of valve body 37 into said downstream rotary union module D as bridge module.

Such downstream rotary union module D contains a plurality of said transit reservoir 38 shaped like jar with top opening 132 and said bottom liquid conduct 39 equipped with said preferred pressure activated spring valve body 133 disposed near top vicinity of the conduct 39; only two reservoir 38 are shown in connection as matching pair with above temporary liquid reservoir 33 for illustration and are corresponding to exemplified twenty-four reservoirs 38 shown on right portion of this figure. Such reservoir 38 mounted equally in one or multiple layers; exemplified as one layer for drawing simplicity, along predetermined equal angles of multiple angle lines and circumference in each predetermined bored holes location of a horizontal circular plate 134 with extended downward said liquid conduct 39. The whole group of evenly spaced reservoir 38 is disposed inside an endless flattop reversed “U” shape stationary annular channel 135 to cover plurality of components including said reservoirs 38. On outer top surface of stationary annular channel 135 installed a plurality of nipple 136 paired corresponding in between said pipe 59 and each reservoir 38 and each nipple has an extended downward liquid conduct 137 disposed inside of said channel 135 in vicinity above inlet opening 132 of reservoir 38 to precisely discharge liquid transmitted via said liquid pipe 59 from said corresponding temporary liquid reservoir 33; splashing over a less than 180 degree baffle 138 disposed underneath conduct 137 inside of reservoir 38, like an umbrella shape smoothly sliding down along inner wall into said reservoir 38. Said annual channel 135 has been secured and supported with curved inner and outer rim mounted vertically on top surface of concentric paired railings and installed along the central axis of horizontal plate 134. The inner rim 139 is secured on inner-top railing 140 and outer rim 141 is secured on outer-top railing 142. A matching inner-bottom railing 143 and matching outer-bottom railing 144, both railing 143 and railing 144 have flat bottom smooth surface to be tightly fastened with top-surface of plate 134.

As aforesaid, soon all kind of liquids originally held in temporary liquid reservoir 33 transmitted via respective line 59 into each said reservoirs 38 is satisfied. Said valve body 37 steps forward one rotation angle step, then supply via said medium range pressurized inert gas via gas pipe 10 illustrated in FIG. 3 to close said flipper 5 through same pipe 59 to push transmitting entire liquid stored in respective transit reservoir 38 via pressure activated opened valve body 133 into underneath stationary wide open top funnel 145 as transit vehicle evenly disposed at corresponding location disposed at bottom floor of stationary compartment 146 that has small gap between bottom surface of said plate 134 and compartment 146, so that, plate can freely rotate along its rotation path as instructed. Further via said medium range pressurized inert gas to push transmitting entire liquid through nipple 147 disposed outside of such stationary compartment 146 connecting with said liquid conduct 60 illustrated in FIG. 2 via said liquid conduct 45 through opened flipped 6 into respective holding tank 44 disposed in said downstream holding tank module E; and meanwhile said bridging downstream rotary union module D waiting for another round of liquid throughput.

Depending on design preference of target separation system, all kind of liquids stored in each holding tank 44 representing whole plurality of liquid solution including feed solution initially being entered from top portion of said separation module C, via said new mass transfer equilibrium contact method alternatively exerting high range pressurized inert gas between pipe 9 and pipe 30 illustrated in FIG. 3 and such delivered mobile phase been draining through solid phase resin/adsorbent to carry out expected mass transfer phenomena to exit from bottom portion of the separation module C via said vacuum environment 31, resulting to isolate at least one product and other multiple liquid streams. Delivering all kind of liquids in each holding tank 44 via electrically operated volumetric pump or other means for liquid transmitting (not shown) through bottom conduct 46 extended downward said heat media circulation jacket 41 (not shown) via line 47 means for discharging stored liquid as at least one isolated product into respective assigned storage tank; means for discharging components in particular solution as by product via another line 47 into respective assigned storage tank; and means for transmitting in part of available solute stored in respective holding tank 44 via each 47 in predetermined volume amount recycling back into each assigned holding tank in aforesaid upstream holding tanks module A; and means for discard stored liquid or other usage. There has a pipe 62 installed next to conduct 45 means for supplying high range pressurized inert gas illustrated in FIG. 3. There has a preferred liquid level sensor 63 installed inside each holding tank 44 to monitor predetermined liquid level of stored liquid within, means such level sensor 63 is to control delivering sufficient volume of particular solution via liquid conduct 64 to maintaining a predetermined liquid level setting in respective holding tank 44.

As aforesaid, rotational circular multiple valve body 37 employed as part of downstream rotary union module D for bridging to transmitting various kind of liquids; such valve body 37 comprise a rotation and positioning together with sealing mechanism with preferred center mount servo-motor 148 and may equip with a speed reducer usually gearbox or motor brake 149 if needed for maneuvering heavy load rotation depending on apparatus design preference. Such servo-motor 148 rotates said plate 134 disposed with plurality of equally mounted reservoir 38 via stretch bars 150 in predetermined clockwise or otherwise in counter-clockwise stepwise direction 20. The direction of rotation and the range of one rotation step are preset and remain unchanged for one reservoir at a time or more than one as a group. Initially, the motor 148 receives the signal from the controller to energize and rotate said plate 134 forward. The plate 134 continuously rotates forward until rotation step is satisfied in order to de-energize the motor and concurrently initiate the motor brake 149 to halt the rotation of said plate 134. It shall be understood that there is no limitation of other alternatives of motion control systems such as actuator or light sensor can be utilized for such rotation and positioning purpose.

Right portion of this FIG. 5 further illustrates preferred rotation and seal mechanisms via an exploded profile of exemplified twenty-four top view of reservoir 38 and railing system. A blown up top view of a single reservoir 38 indicating said liquid conduct 137 as liquid top entry into reservoir 38 and liquid conduct 39 as bottom liquid outlet into beneath funnel 145 being lined up vertically means for repeated simultaneous transmitting of all kind of liquids being out from respective temporary liquid reservoir 33 via bridging module D amid horizontal plate 134 is in immobile status into respective holding tank in said downstream holding tank module D. Briefly repeating via a blown up view of inner rim 139 being secured on inner-top railing 140 and outer rim 141 being secured on outer-top railing 142 and paired with matching inner-bottom railing 143 and matching outer-bottom railing 144, both paired railing systems are tightly fastened with top-surface of said plate 134 disposed with exemplified twenty-four of equally mounted reservoirs 38 contained inside of stationary annular channel 135 to rotate intermittently along its circular path driven by center mount servo-motor 148 and brake 149 via stretch bars 150. For paired railing systems of 140 with 143, and 142 with 144 are resemble in structure, just the pair of 142 and 144 being illustrated via exploded view in lower portion for rotation and seal mechanism. As shown, railing 142 has a center down-face half-oval shaped groove 151 to match the center up-face half-oval shaped groove 152 on railing 144. Combined of groove 151 and 152 generates a concentric oval-shaped tunnel 153 as demonstrated by railing pair of 142 and 144. Circular balls 154 with its diameter slightly larger than vertically height of 153 are laid within such that a gap 155 is formed for free mobilization of said plate 134 driven via said servo-motor 148. There have half-circular grooves 156, 157, 158, 159 being shaped as concentric circular tunnel 160 and 161 to accommodate O-ring type seal 162 with its diameter just big enough to seal said gap 155. It is clear that the configuration of railings, steel balls, and O-ring seals furnish a sufficient frictionless rotation and positioning together with seal mechanism for said plate 134, providing minimal gas leakage for said stationary annular channel 135 to maintain mid-range pressurized inert gas to transmit all kind of liquid within said bridging module and prevent micro-organism growing within.

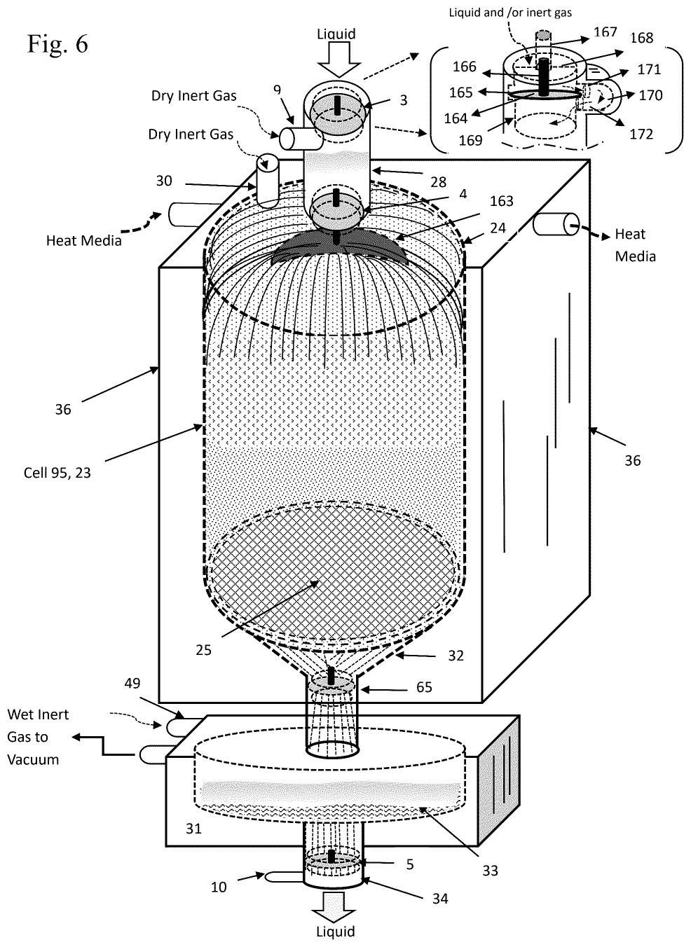

Depending on target separation requirement related with particular combination of selected mobile and solid phase, preferred construction of cell shown in FIG. 6 is the perspective view for single type of resin/adsorbent disposed in a single column 23 as cell 95 itself and is some other cell construction to carry out said new mass transfer equilibrium contact method via generating an instantaneous mixing along with partial fluidized effect between resident packing material and upcoming fluid thus to distinguish this disclosure from typical ion exchange or affinity chromatography that can swiftly interact with the dissolved components in mobile phase to promote instant adsorption and/or elution. Disclosed apparatus comprising said multiple modules A, B, C, D, E, and F remain unchanged as said cells 95 comprising bundled group of at least one column illustrated in FIG. 2 through FIG. 5; except mechanical alteration of liquid distribution entering top portion of said separation module C. Such said new mass transfer equilibrium contact method in general is modified and composed of at least one of following procedure.
1. Retain solid phase resin/adsorbent material in a cell having an inlet on one side and an outlet on another side with bottom meshed filter to contain said resin/adsorbent from being drained and plurality of cells disposed orderly in said separation module C;
2. Intermittently and simultaneously deliver predetermined multiple amount of particular liquid solution via predetermined type of liquid dispenser into each of said cell amid predetermined first time period, to instantaneously mixing or stirring as partially fluidized bed, to promoting a homogenous mass transfer equilibrium contact either adsorption of dissolved components onto said resin/adsorbent material or elution of adsorbed components from said material;
3. Intermittently and simultaneously supply broad range pressurized inert gas amid predetermined second time period to the group of cells on the one side following each sequential delivery of a liquid to promptly settling stirred resin/adsorbent particles to force prompt draining of delivered liquid sipping through said solid phase material contained in each cell to swiftly conclude expected mass transfer equilibrium contact between two phases;
4. Simultaneously meanwhile amid spent time of step 3 providing vacuum environment on the other side of said group of cells to maintain said solid phase resin/adsorbent material in a semi-dry status, hereinafter defined as new mass transfer equilibrium contact status, meaning packed resin/adsorbent particles may have wet surface but with no liquid exists between adsorbent particles;
5. Intermittently meanwhile amid spent time of step 3 collecting most of treated solution from the outlet of said group of cells, repeating step 2 through step 5 until predetermined multiple amount of liquid solution in sequence is satisfied;
6. Define total cumulated time spent for repeated step 2 through step 5 as minimal time interval, Δt.

Note that step 4 of general procedure may be omitted or using low vacuum environment due to organic mobile phase liquid may be used as part of eluent such as adding methanol or acetonitrile to reduce pure water polarity in reverse phase chromatography operation, so that, organic mobile phase liquid issues can be eliminated; using step 3 of pressurized inert gas for draining of delivered liquid.

As shown by exploded view located on upper right portion of this figure, a typical selected check valve named as flipper is shown and comprising a circular rigid material 164 set in and around with rigid seal gasket 165 means for top and bottom sealing purpose depending upon either upward or downward movement of such flipper. Said flipper having a circular rigid centered stick 166 pierce through a big enough sealed top centered circular channel 167 supported by rigid wire 168 means for holding such flipper in upright position set inside of said circular channel 167 and confined within a shaped circular compartment 169 aligned with internal wall of a liquid conduct; such compartment 169 comprising side conduct 170 having a circular opening 171 and another circular opening 172 means for providing such wide opening space 169 trapping within such flipper freely moving upward to block or hold liquid from passing through amid exerted pressurized inert gas from bottom, or, switched in downward position to allow fluid swiftly passing through said opening 170 then opening 171 soon exerted pressurized inert gas supplied from bottom being turning off and meanwhile exerted pressurized inert gas supplied from top being turning on. Such preferred mobile phase liquid transmitting mechanism in cooperating with broad range of pressurized inert gas has been thoroughly illustrated in FIG. 2 through FIG. 5.

Single column 23 as cell 95 itself is a tall cylindrical container retaining a predetermined quantity of resin/adsorbent disposed over said porous filter 25 having porous mesh small enough to prevent resin/adsorbent from being drained while to maintain good permeable capability. Cell 95 set inside said insulated selected heat media circulation jacket 36 comprising a heat media inlet and outlet to maintain cell 95 in a selected temperature range. Cell 95 having a liquid inlet conduct as temporary transit reservoir 28 extended out of the jacket 36 to receive predetermined volume amount of particular liquid transmitted from corresponding holding tank disposed in said upstream holding tank module A via said upstream rotary union module B, through opened mechanical device flipper 3 into each underneath said temporary transit reservoir 28 disposed around top portion of each cell 95 orderly disposed in said separation module C. Underneath said flipper 4 connected with a less than 180 degree baffle 163 to conduct the predetermined volume amount of transmitted fluid amid short period time duration to splash over like an downward umbrella shape. Such splashed fluid hitting inner container wall, and swiftly sliding downward to partially up-lift and penetrate to stirring upward contained resin/adsorbent grains of resin/adsorbent suspended in liquid. This instantaneous partial mixing effect is for quick contact and dramatic reduction of required time for mass transfer between two phases. Via alternatively controlling on and or off of supplying high range pressurized inert gas via gas pipe 9 and gas pipe 30 to intermittently drop in parts of delivered liquid out of reservoir 28 or stop transmitting such stored liquid as aforementioned selected input format.

As shown, cell 95 bottom portion being exposed to vacuum environment 31, having an exit for mobile phase liquid enriched inert gas via conduct 48 to maintain said resin/adsorbent in new mass transfer condition in a semi-dry status meaning the resin/adsorbent may have wet surface but no liquid exists among resin/adsorbent grains, and to affiliate treated liquid draining via funneled shape liquid conduct 32 through opened flipper 65 into each underneath temporary liquid reservoir 33 means for collected liquids redistributed for further applications. As said, transmitted fluid swiftly penetrating through the remaining of the bed to complete expected mass transfer equilibrium contact. Note that mobile phase being swiftly treated and drained means retained solid phase returns to its initial semi-dry status throughout the whole bed. Thus, it distinguishes the mass transfer mechanism from chromatography. Repeating aforesaid step 2 through step 5 of new mass transfer equilibrium contact method until contained liquid stored in said temporary transit reservoir 28 is exhausted amid predetermined minimal time interval, Δt, being spent. Such said minimal time interval required for completing this new mass transfer equilibrium contact method is the mechanical limitation of the apparatus for swift mobile delivery and draining being the fundamental parameter for converting chromatography into present invention. Preferably, the draining driving force has no limit of combinations through other forms. The primary purpose is for illustration of completing expected mass transfer interaction between solid and mobile phase amid duration in shortest possible time.

Soon said minimal time interval being spent and exerted vacuum 31 being shut off, meanwhile via gas pipe 49 supplying said low range pressurized inert gas and stopping supplying via gas pipe 10 of said medium range pressurized inert gas, resulting collected liquid in reservoir 33 being pushed and transmitted through opened flipper 5 through liquid conduct 34 into said downstream rotary union module D. Again, such preferred mobile phase transmitting mechanism has been thoroughly illustrated in FIG. 2 through FIG. 5 to distinguish fundamental difference between chromatography operations from said new mass transfer equilibrium contact method.

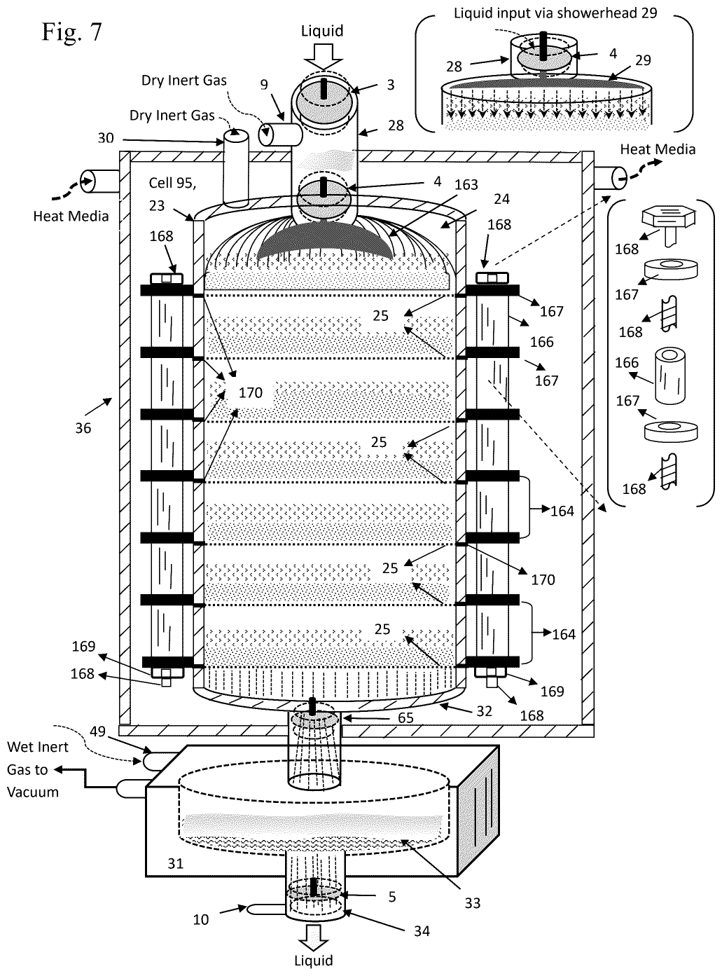

For avoiding reiterate mobile phase transmitting within disclosed apparatus and other same components already illustrated in FIG. 6. Impending FIG. 7 herein is mainly for emphasizing general perspective view for implementation of mixing along with partial fluidized effect of preferred cell construction for single type of solid phase disposed in multiple layers or multiple kinds of resin/adsorbent in multiple layers which aggregates several layers as zone to accommodate single type resin/adsorbent and multiple zones as for multiple type resin/adsorbent in a single column 23 as cell 95 itself. Upper right portion of this FIG. 7 shows alternative liquid input via showerhead 29 already illustrated in FIGS. 2, 3, and 4 for multiple columns 23 disposed in said single cell 95 comprising liquid transmitted through opened flipper 4 disposed inside liquid conduct 28 into underneath showerhead 29 to dash out liquid to wet upper portion of retained resin/adsorbent and promptly sipping through stationary resin/adsorbent particles to create less stirred or mixed fluidized condition. Again, this liquid input alternative is depending upon design preference for particular requirement of target separation system, such as for weak ionic bonding interactions between resin/adsorbent and mobile phase.

The predetermined quantity of one type resin/adsorbent may be subdivided into more than one thin layer to affiliate better liquid permeable capability throughout the cell 95 to reduce pressure drop in order to suit for particular target separation requirement. As shown in FIG. 7, each thin layer of resin/adsorbent is bottom supported by its own said porous filter 25 as divider in between each shallow bed 164. The overall height of individual shallow bed 164 comprises of retained resin/adsorbent depth with an above opening space. Each layer of resin/adsorbent has said bottom porous filter 25 to support such resin/adsorbent means for the mobile phase outlet of current layer and the predetermined top open space as the mobile phase inlet of current layer. As shown by exploded view located on right side of FIG. 7, each bed height 164 is equally stacked up with such predetermined interval and supported by a metal tube 166 disposed in between mounted washers 167. The location of washer 167 is disposed at bottom of each bed 164. A threaded long metal rod 168 with stud is pierced from top through all tubes 166 and washers 167 and secured by a nut 169 to connect all the shallow beds 164 in series. The outmost part of filter 25 has an extended and built in annular shape gasket 170 along with circumference of said filter 25 as component, shown as cross-sectional cut, which is secured in between individual bed 164 to prevent inert gas and mobile phase from leaking. The stacked up structure of all beds with an open space in between individual bed reduces the pressure drop to minimal and for proceeding mass transfer equilibrium contact to possible minimal time interval.

Cell 95 construction is further expanded to accommodate multiple kinds of resin/adsorbent via multiply-layer set up. The multiple-layer set up means single cell 95 construction being shown same in FIG. 7. The multiple kind of packing materials means disposing more than one type resin/adsorbent being packed in different zones of the cell construction. The zone means a grouped number of layers 164 arranged as a zone interval within cell body to accommodate one type of resin/adsorbent and additional zone for additional type of resin/adsorbent. All zones are constructed up and down in series to vertically affiliate fast draining via pressured inert gas exerted from top and vacuum environment 31 exert from bottom portion of said separation C. Multiple kinds of resin/adsorbent can be combinations of named anion exchanger, cation exchanger, reverse phase resin, normal phase resin, activated carbon, or other types of packing material can chemically interact with mobile phase to have adsorption and de-sorption capabilities. Depending on design preference of mobile phase delivering preference for respective liquid through predetermined type of liquid dispenser, either said showerhead 29 or less than 180 degree curved baffle 163 can be installed at top portion of said cell 95 body to transmit fluid into first shallow bed 164 resulting particular fluid with multiple compositions of dissolved solutes to interact with each zone's resin/adsorbent to complete mass transfer interaction as the fluid treated and drained throughout the cell 95 body. The mass transfer interaction means either adsorption and/or de-sorption phenomena shall be proceeded between liquid phase and multiple types of resin/adsorbent within the predetermined minimal time interval, Δt. The minimal time interval is same as formerly defined.

For establishing a generalized differential set-up for large scale production of particular separation target system, it requires to generate an elution characteristic profile from a single column 23 or cell 95 as column itself evaluation employing same combination of solid and mobile phase via applying aforesaid new mass transfer equilibrium contact method. As shown on right portion of FIG. 8, depending on design preference of weak or strong ionic bonding strength of a typical ion exchange chromatography, such step 1 of new mass transfer equilibrium contact method employ onto either a single cell 95 comprising a plurality of bundled columns 23 already illustrated in FIG. 2 through FIG. 5, or, column 23 being cell 95 itself as thoroughly illustrated in construction variance of cell 95 in FIG. 6 and FIG. 7, and shown by an exemplified of twenty-four of minimal time interval, Δt to represent such elution characteristic profile. Two modes of schematic elution diagrams being produced and plotted by the dissolved solute concentration on left-Y-axis and mobile phase parameter (running condition) on right-Y axis, both prevailed vs. time domain on X-axis. Both modes represent such generalized characteristic profile covering feeding zone 20, comprising 3 of cumulated Δt; impurity stripping zone 21, comprising 6 of cumulated Δt; product recovery zone 22, comprising 6 of cumulated Δt; regeneration zone 23, comprising 6 of cumulated Δt; and washing zone or sanitizing zone 24, comprising 3 of cumulated Δt. Integration of all zones in time domain being employed onto disclosed apparatus representing a complete separation cycle being accomplished during each duration of said minimal time interval Δt amid stead state operation. Such operation is corresponding to a separation cycle briefly discussed in FIG. 1 that simulated multiple solid phase cells 95 rotate in horizontal direction to perpendicularly and simultaneously in contact with multiple kinds of mobile phase will further be illustrated thoroughly impending following FIG. 8 through FIG. 11.

The first mode is called isocratic elution, input S-I shown on upper portion of FIG. 8, it is characterized by five consecutive step-input 85 in time domain corresponding to #1, #2, #3, #4, #5 as five different types of mobile phase parameter (running condition) and resulting five of dissolved solute in mobile phase interacting after with retained resin/adsorbent in said cell 95. As aforesaid step 2 through step 5 in new mass transfer equilibrium contact method, said step input 85 is for interpretation of running condition prevailed in time domain and small dose of liquid phase being intermittently transmitted and promptly sipping throughout retained solid phase disposed in said cell 95. The type of liquid input interpreted in time domain is actually as a form of impulse input 86 illustrated in FIG. 1 and amid duration of such liquid input in time domain being reduced to as small as possible corresponding with defined minimal time interval Δt. Therefore, the definition of liquid input for the present invention is preferable described as step input 85 in mobile phase parameter (running condition) but with impulse input 86 in time domain, which is defined as input S-I hereinafter to differentiate from typical chromatographic operation.

The second mode of input is called discrete isocratic elution, input I-I. It is characterized by inputting a group different mobile phases with minor discrete increment of mobile phase parameter in between two major mobile phase parameters (running conditions). The minor increment of step input 85 in mobile phase parameter is defined as little change as possible along an imaginary sloped dot line and being carried out in part of each defined minimal time interval Δt during step 2 through step 5 in said new mass transfer equilibrium contact method. It means an impulse input being represented for both running condition and time duration thus is defined hereinafter as input I-I. The duration of a minor increment of mobile phase parameter may be equivalent to one or multiple minimal time intervals and such slope of imaginary dot line solely being depended upon design preference of target separation system. Via proceeding said input I-I is to simulate typical gradient mobile phase elution during the course of high-pressure liquid chromatography (HPLC) for maximizing the elution of current group of dissolved solutes and minimizing the elution of subsequent solute group to avoid so called co-elution because the iso-points of two adjacent dissolved solute groups are close to each other. Via aforementioned iso-point teaching, this invention utilizes identical mobile and solid phase combination used in chromatography to proceed the separation through said new mass transfer equilibrium contact method to eliminate displacement zone and dead volume for mass production scale up purpose. Via precise controlling various mobile phase parameter intermittently and simultaneously in contact with solid phase to reach mass transfer equilibrium, ultimately, through the new mass transfer equilibrium contact method and impending illustration of differential set-up between two phases and tailored single stage operation procedures, implemented onto said apparatus, can obtain maximum separation efficiency within every spent of minimal time interval, Δt. The integration for either input S-I or input I-I of mobile phase volume amount and its corresponding minimal time interval Δt, which is equivalent to as a complete separation cycle. Therefore, the previous illustration for said apparatus makes the input S-I and input I-I being distinguished from chromatography and yet in better mass transfer efficiency. In general, input I-I is not required unless a better separation is in demand.

An illustrative elution profile for input S-I by sequentially starting from mobile phase #1 (feed condition) through #2, #3, to #4 creates three peaks plotted in solute concentration (left-Y-axis) vs. time domain and mobile phase parameter (right-Y-axis) vs. time domain. The first step is feed loading, #1, onto fresh resin/adsorbent proceeded in feeding zone 20 to obtain the ultimate adsorption efficiency; meaning to spend shortest possible time for maximum feed stock predetermined volume amount throughput. All running conditions of each subsequent elution liquid are predetermined according the previous teaching of iso-point belief. The mobile phase condition is predetermined that #2 condition is preset prior to the iso-point of desired product A, thus, only impurities B1 can be eluted. This covers the impurity-stripping step proceeded in impurity stripping zone 21. Then, #3 mobile phase has its condition just elutes the desired product A and retains the impurities group B2 in solid phase. It covers the product-recovery step proceeded in product-recovery zone 22. The #4 condition is input to cover elution of impurities B2 as regeneration step proceeded in regeneration zone 23. Finally, the washing step is proceeded in sanitizing/washing zone 24 by recycling of #1 mobile phase collected from loading zone 20 to prepare resin/adsorbent ready for loading again.

The input I-I is illustrated by starting from feeding step to obtain the ultimate adsorption efficiency proceeded in feeding zone 20 with #1 mobile phase. The impurity-stripping step is proceeded in impurity-stripping zone 21 by input I-I, minor discrete increment of mobile phase parameter starting from #1 then ending by #2, to maximize the elution of first impurity group B1 to avoid co-elution with product A. The product recovery step is proceeded in product recovery zone 22 via input I-I starting from #2 then ending #3 mobile phase parameter for maximizing the elution of product A to avoid co-elution with 2^{nd}. Impurity group B2. Generally, one increment of mobile phase parameter is sufficient for each increment of minimal interval Δt. Once the product A being eluted, the regeneration step is proceeded in regeneration zone 23 by input S-I #4 mobile phase to completely strip off 2^{nd}. Impurity group B2 from solid phase. Finally, the sanitizing/washing step is proceeded in washing zone 24 by input S-I with #1 mobile phase recycled from loading zone 20 to prepare resin/adsorbent ready for feed stock adsorption.

Note that the resin/adsorbent in both modes of input S-I and input I-I is always maintained in semi-dry status in accordance with criterion of step 3 and step 4 in said new mass transfer equilibrium contact method via bottom exerted vacuum environment and/or top supplying of broad range of pressurized inert gas of each cell 95. Furthermore, typical chromatography operation involves each front part of eluted peak will not emerge from other end of column until all kind of mobile phase being orderly input in sequence for sequential exit of eluted peak. Elution profile illustrated in FIG. 8 being generated via new mass transfer equilibrium contact method consumes exact amount of resin/adsorbent disposed in a typical chromatography column and such profile starts from the beginning of elution time via this cell 95 evaluation, means displacement zone 89 described in FIG. 1 being completely eliminated and yet has no dead volume in fluid delivering system. By the nature of said new mass transfer equilibrium contact method, the input of liquid dose is promptly sipping through resin/adsorbent installed in a single column and been treated and drained by top inputting of pressured inert gas and affiliated with said bottom vacuum environment. The expected mass transfer phenomena has been executed as delivered liquid been swiftly treated and drained through the resin/adsorbent. The concentration and composition of each among all kind of treated liquid mixtures collected from bottom of such cell representing a complete separation cycle. Note also from the previous illustration that zone 89 in chromatography not only contributes nothing but also deteriorates the separation due to aforementioned issues.

As aforesaid step 1 of new mass transfer equilibrium contact method illustrated in FIG. 1, said resin/adsorbent amount 94 disposed in bundled columns 23 as cell 95 or column 23 as cell 95 itself, is equivalent to feeding zone 20. It means the feeding zone 20, representing by resin/adsorbent quantity 94, is the resin/adsorbent been saturated with the fixed feed volume 93 and is disposed in single cell 95 evaluation to obtain satisfactory separation result described in FIG. 8 and such result can be implemented with said apparatus for differential set-up. Actually, there is no specific preference in setting up said number of group cells 95 as coverage of particular zone corresponding to number of rotation steps for said of upstream rotary union module B and downstream rotary module D or predetermined minimal time interval assigned for separation module C. Preferable set up for illustration employed for ion exchange process onto said apparatus is to pick fixed feed volume 93 having 3 of cumulated minimum time interval as range means the most time consuming zone for differential set up protocol and is to maximize adsorption efficiency to promote adsorption of dissolved components onto resin/adsorbent in ⅓ of required time. In any event, therefore, other alternative protocols may be established, yet, such alternations should be confined within the scope of this disclosure. The general method of differential set-up between solid phase material and mobile phases compose the following procedures;
1. Sequentially breaking down the elution profile obtained by said new mass transfer equilibrium contact method as demonstrated in FIG. 8 is the partial time required to spend for respective predetermined mobile phase parameter (running condition) solution input for such zone, this including feed solution in #1 as zone 20, impurity stripping up to #2 as zone 21, product A recovery up to #3 as zone 22, and regeneration up to #4 as zone 23 and washing via #1 recycled from feeding zone as zone 24;
2. Divide each partial time by said minimal time interval to obtain the range of cells 95 disposed for such zone. Then, divide total input volume amount of such liquid by the number of cells to obtain the partial volume amount required for each cell in respective zone; then, divides such said partial volume amount by a preselected number to further differentiate for multiple liquid doses to proceed general procedures of said new mass transfer equilibrium contact method and again depending on design preference of particular target system, wherein such liquid solution being disposed in temporary reservoir 28 of said separation module C simultaneously transmitted via alternate supplying of dry inert gas, thoroughly illustrated procedures in FIGS. 4, 6, and 7, via said gas pipe 9 and 30 to maximize elution efficiency of particular mobile phase parameter solution transmitting through retainer resin/adsorbent in each cell 95. Further divides said resin/adsorbent, which derived from complete saturation with feed solution, by a pre-selected number that corresponds to differential resin/adsorbent amount disposed in at least one column 23 bundled in a single cell 95 disposed in each zone to simultaneously receive the partial volume of such liquid for each cell in said group of cells 95; if such selected number is 1 means column 23 is cell 95 itself;
3. Sequentially allocate all cells with respective mobile phase parameter as the range of respective zone and allocate all zones into an endless format; wherein integrating all zones orderly arranged in such endless format representing a complete elution profile separation cycle via upstream rotary union module B and downstream rotary module D to transmitting all kind of mobile phase parameter solution into underneath stationary separation module C is to simulate all cells 95 in horizon moving direction whereas mobile phase is simultaneously traveling in vertical direction;
4. Prepare predetermined volume amount of respective predetermined mobile phase parameter solution to store in respective holding tank in said upstream holding tanks module A for such liquid distribution throughout this disclosed apparatus to achieve expected separation.

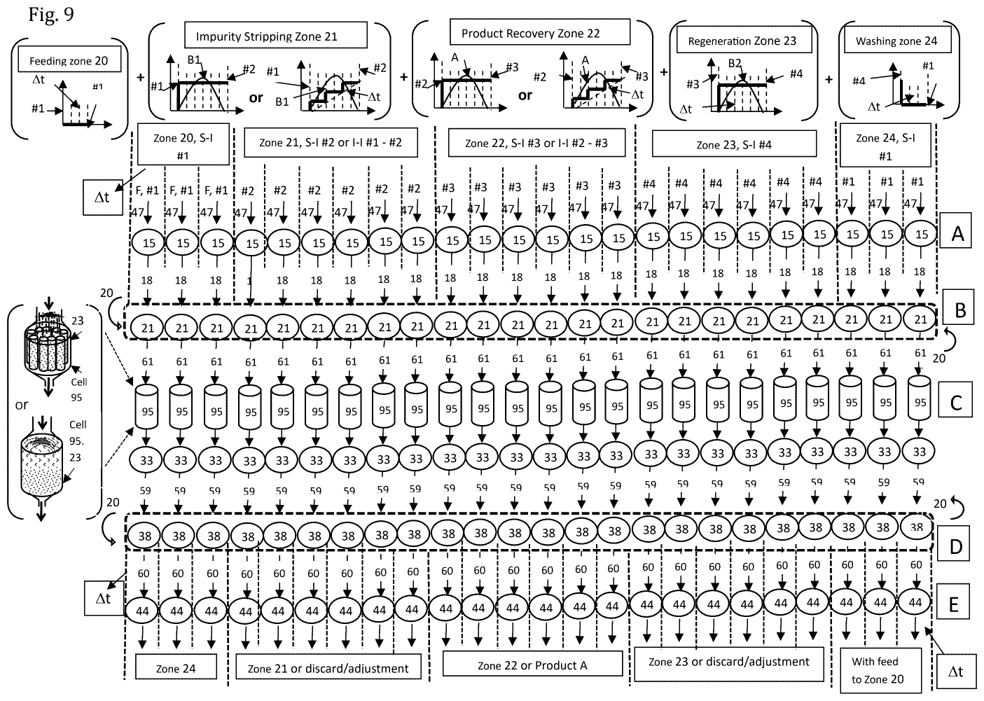

FIG. 9 is to carry out said differential set up illustrated in FIG. 1 and employed by said apparatus between mobile phase parameter and resin/adsorbent via test result explicated in FIG. 8 for single stage recycle protocol to implement for continuous and simultaneous isolation of single product A from mixture of impurity group B1 and B2. This schematic drawing elucidates the preferred apparatus comprising aforementioned modules A, B, C, D and E being exemplified demonstration via twenty-four cumulated minimal time Δt. Such characteristic elution profile is divided into five sections corresponding to the feeding zone 20, first impurity B1 stripping zone 21, product A recovery zone 22, regeneration zone 23, and washing zone 24, respectively. Liquid input format can either be isocratic elution 85 input S-I as indicated on upper portion of FIG. 8 or discrete isocratic elution 85 input I-I as shown in lower portion, both are in accordance with earlier illustration. The input S-I only differentiates in predetermined volume amount of same mobile phase parameter 85, means delivering said partial volume differentiating in multiple liquid doses within every spent of minimal time interval for maximizing mass transfer equilibrium contact efficiency. The input I-I differentiates both the partial input volume amount in multiple liquid doses and mobile phase condition in said discrete format in predetermined slope in accordance with each minimal time interval spent. Each partial input volume amount is a discrete increment of mobile phase condition fallen in between two adjacent running conditions with each corresponding number of step to avoid said co-elution of two adjacent elution peaks. Note that liquid delivering module of either input S-I or input I-I employed via said apparatus, such preset intermediate mobile phase's condition is separately delivered via its preset routing in a closed loop in such partial volume amount for the corresponding cell that being collected and then transmitted into underneath into selected holding tank 44 disposed in said downstream holding tanks module E. As shown, the range variance of respective zone is intended to exemplify realistic time may actually be required for completing respective mass transfer equilibrium contact for specific zone. It means not necessary all target separation system requires five zones set-up, it relies on the nature of target system. FIG. 9 exemplifies such cumulated twenty-four minimal time intervals Δt employed via said differential set-up protocols onto disclosed apparatus for simultaneous inputting of feed solute in #1, and #2, #3 #4, #1 of mobile phase parameter solution in selected either input S-I or I-I mode. Each stored liquid in assigned holding tank 15 in upstream holding tanks A and its output distribution route thereafter; wherein various recycle solution collected in respective holding tank 44 disposed in downstream holding tank module E simultaneously transferring predetermined volume amount of various type of solution via each liquid line 47 into respective holding tank 15 and then via each line 18 into respective temporary holding reservoir 21 disposed in said upstream rotary union module B, further via each line 61 into top portion of each cell 95 disposed in said separation module C and via top supplying pressurized inert gas and bottom exerted vacuum environment to drain and collect treated liquid in each underneath temporary holding tank 33; and then transmitting via each line 59 via reservoir 38 disposed in said downstream rotary module D and finally via each line 60 back to respective holding tank 44 in said downstream holding tanks module E. This simultaneous mobile phase closed loop transmitting routings has been thoroughly illustrated in FIG. 2 through FIG. 5. This FIG. 9 outlines such complete separation cycle, which is based on each spent of single minimal time interval Δt, and amid each spent of each spent of time interval orderly cumulated in sequence to complete proceeding said profile derived in FIG. 8. This figure further illustrates the single stage recycle protocol for elevating the concentration level of isolated peaks including product A in #3 solution and minimizing consumption of #1, #2 and #4 mobile phase parameter solution. Depending on requirement of particular target system, #2 and #4 solution has option of being continue recycling back to identical said holding tank 15 via its predetermined recycle route of liquid distribution loop or discarded if running condition of such parameter is getting weak, or adjusted its running condition for other usage; wherein #1 can either be continue recycling or blending with feed solution for feeding zone 20. From a single column study means this elution profile illustrated in FIG. 8 representing multiple of said mass transfer phenomena/equilibrium status are reached in sequence and yet simultaneously employed via this disclosed apparatus to carry out mass transfer equilibrium contact between particular mixtures of mobile phase parameter solution entering from top of each cell 95 promptly sipping through resin/adsorbent bed for expected separation. Via simultaneous transmitting of various liquid into respective zone during steady state operation in this disclosed apparatus, by which it transforms the traditional chromatographic separation path from parallel into vertical with mobile phase's flow direction. At any instance of steady state operation, a complete separation cycle is accomplished after every spent of minimal time interval for all zones through elution result of said single column testing to achieve major object of said Parametric Differential Moving Bed (PDMB) briefly illustrated in FIG. 1 of this disclosure.

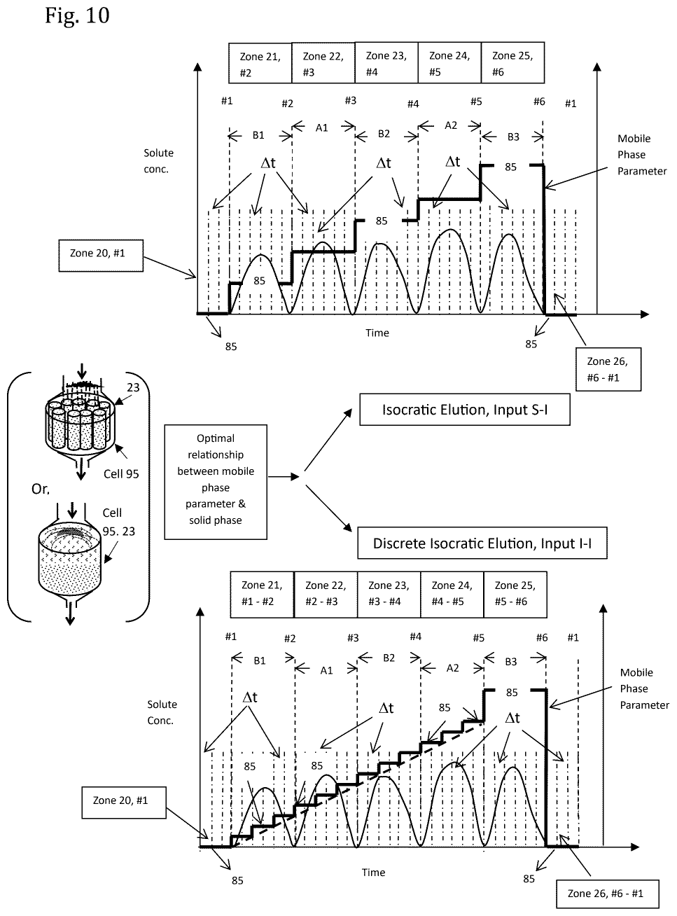

This differential set-up employed with single stage recycle protocol onto disclosed apparatus is further extended to simultaneous isolation of plural streams of different product with simultaneous and continuous execution of feeding, multiple groups of impurity stripping, regeneration, and sanitizing/washing. Again, depending upon nature of the target system, it requires producing an elution characteristic profile from a single cell by applying new mass transfer equilibrium contact method described previously. A wide variance can be existed and resulting with different separation protocol, however, the result of such profile is sufficient to designate various zones for process design employed via disclosed apparatus. For exemplified illustration, FIG. 10 is a schematic diagram to elucidate such extension for simultaneous two products recovery through seven zones set-up. It depends upon how the product and impurities are defined thus ends up less than seven zones to recover more than two products. It is therefore to specify that a desired product is isolated in between two impurities groups, considering that has three impurities groups and two products with additional feeding and sanitizing/washing ends up total seven zones. The solute concentration is plotted on left-Y-axis as a function of cumulative time. Moreover, the mobile phase parameter is plotted on right-Y-axis as a function of cumulative time. Liquid input format can either be isocratic elution differentiates in predetermined volume amount of same mobile phase parameter 85 input S-I as indicated on upper portion of this figure, or discrete isocratic elution 85 input I-I differentiates both the partial input volume in multiple liquid doses and mobile phase condition in said discrete format in predetermined slope in accordance with each minimal time interval spent as shown in lower portion, wherein both formats are in accordance with earlier illustration.

The illustrative elution profile for isocratic elution input S-I mode in format of 85 via beginning with mobile phase parameter solution #1 (feed condition) through #2, #3, #4, #5 to final mobile phase #6 generates five peaks. After completing the loading by the same previous teaching of differential set-up between two phases in loading zone 20 for gaining maximum adsorption efficiency and selected as most time consuming zone. All subsequent elution liquid's conditions are derived and predetermined with earlier teaching of iso-point belief. The #2 condition has been preset prior to the iso-point of desired product A1 such that all impurities are grouped, as B1 will be eluted prior to product A1. This covers first impurity-stripping step proceeds in first impurity-stripping zone 21. The #3 mobile phase has its condition just elutes the desired product A1 prior to iso-point of impurities group B2. This covers the first product-recovery step proceeding in first product-recovery zone 22. The #4 condition is input to cover elution of impurities B2 as second impurity-stripping step proceeding in second impurity-stripping zone 23. The #5 condition is input to cover elution of desired product A2 prior to iso-point of impurity group B3. This covers the second product recovery carrying out in second product-recovery zone 24. The #6 condition is input to cover elution of 3^{rd}-impurity step proceeding in 3^{rd}-impurity-stripping zone 25. Finally, the washing/sanitizing step is proceeded in washing zone 26 by recycling of #1 mobile phase collected from feeding zone to prepare resin/adsorbent ready for loading again.

The input I-I is illustrated by starting from loading step to obtain the maximum adsorption efficiency proceeded in feeding zone 20 with #1 mobile phase. The first impurity-stripping step being followed and proceeded in first impurity-stripping zone 21 via input I-I 85 in format of minor discrete increment of mobile phase parameter starting from #1 then ending by #2 maximize elution of B1 and to avoid the co-elution with product A1. The first product recovery step is proceeded in first product recovery zone 22 by input I-I 85 starting #2 then ending #3 to maximize the elution of product A1 and to avoid co-elution of second impurity group B2. The second impurity-stripping step being proceeded in second impurity-stripping zone 23 via input I-I starting from #3 then ending by #4 maximize the elution of second impurity group B2 and to avoid co-elution of second product A2. The second product recovery step is proceeded in second product recovery zone 24 by input I-I starting #4 then ending #5 for maximizing the elution of product A2 and for avoiding co-elution of third impurity group B3. Since product A2 being eluted, the regeneration step is proceeded in regeneration zone 25 by input S-I 85 #6 mobile phase to strip third impurity group B3. Generally, one increment of mobile phase parameter is sufficient for each increment of minor interval Δt, and again such slope of imaginary dot line solely being depended upon design preference of target separation system; both yet require experimental validation from the target separation system. Lastly, the washing/sanitizing step is proceeded in washing zone 26 via input S-I 85 with #1 mobile phase recycled from zone 20 to prepare resin/adsorbent ready for feeding zone 20 adsorption.

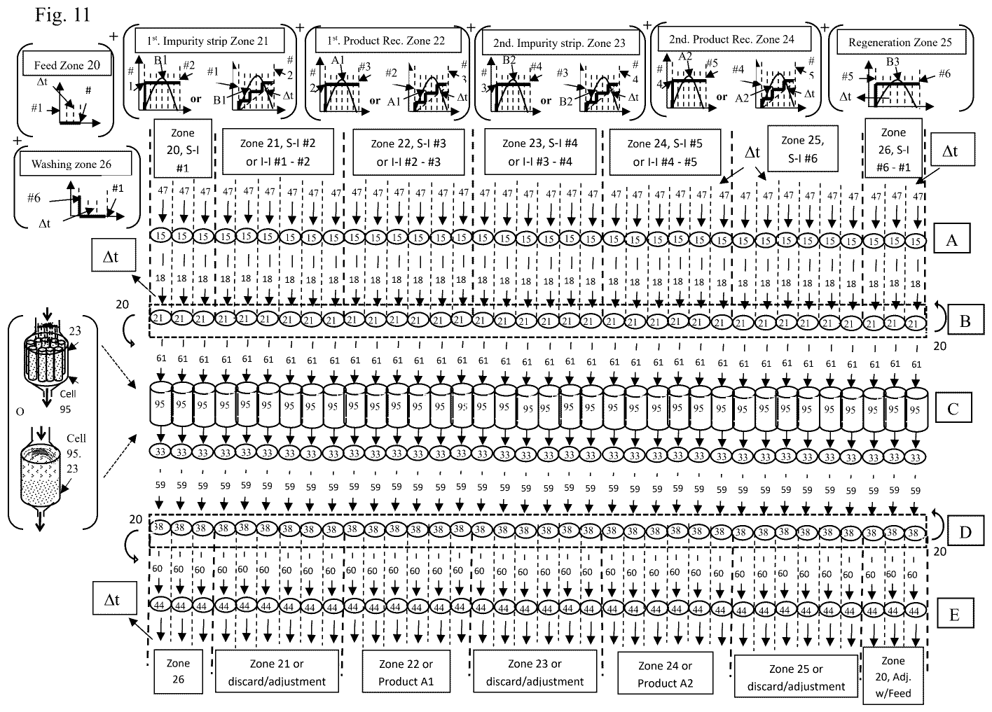

FIG. 11 being elucidated for carrying out said differential set up explicated in FIG. 1 and employed by said apparatus between mobile phase parameter and resin/adsorbent via test result illustrated in FIG. 10 for single stage recycle protocol to explicate implement for continuous and simultaneous isolation of multiple products A1 and A2 from mixture of impurity group B1, B2, and B3. This schematic drawing elucidates the preferred apparatus comprising aforementioned modules A, B, C, D and E being exemplified demonstration via thirty-six cumulated minimal time Δt. Such characteristic elution profile is divided into seven sections corresponding to following zones; wherein feeding zone 20 comprising 3 of Δt; first impurity B1 stripping zone 21 comprising 6 of Δt; product A1 recovery zone 22 comprising 6 of Δt; second impurity B2 stripping zone 23 comprising 6 of Δt; second product A2 recovery zone 24 comprising 6 of Δt; regeneration zone 25 comprising 6 of Δt; and washing/sanitizing zone 26 comprising 3 of Δt; respectively.

Note that liquid delivering module of either input S-I or input I-I employed via said apparatus, such preset mobile phase parameter solution is separately delivered via its preset routing in a closed loop in such partial volume amount for the corresponding cell that being collected and then transmitted into underneath into selected holding tank 44 disposed in said downstream holding tanks module E.

As shown in FIG. 11, the range variance of respective zone is intended to explicate realistic time may actually be required for completing respective mass transfer equilibrium contact for specific zone and means not necessary all target separation system requires seven zones set-up. This figure exemplifies such cumulated thirty-six minimal time intervals Δt employed via said differential set-up protocols onto disclosed apparatus for simultaneous inputting of feed solute in #1, and #2, #3 #4, #5, #6 and #1 of mobile phase parameter solution in selected either input S-I or I-I mode. Resemble to explicated illustration in FIG. 9, each stored liquid in assigned holding tank 15 in upstream holding tanks A and its output distribution route thereafter; wherein various recycle solution collected in respective holding tank 44 disposed in downstream holding tank module E simultaneously transferring predetermined volume amount of various type of solution via each liquid line 47 into respective holding tank 15 disposed in said upstream holding tanks module A and then via each line 18 into respective temporary holding reservoir 21 disposed in said upstream rotary union module B, further via each line 61 into top portion of each cell 95 disposed in said separation module C, and via top supplying pressurized inert gas and bottom exerted vacuum environment to drain and collect treated liquid in each underneath temporary holding tank 33; and then transmitting via each line 59 via reservoir 38 disposed in said downstream rotary module D and finally via each line 60 back to respective holding tank 44 in said downstream holding tanks module E. Again, this simultaneous mobile phase closed loop transmitting routings has been thoroughly illustrated in FIG. 2 through FIG. 5. This FIG. 11 outlines such complete separation cycle, which is based on each spent of single minimal time interval Δt, and amid each duration of spent time interval orderly cumulated in sequence to complete proceeding said profile derived in FIG. 11. This figure further illustrates the single stage recycle protocol for elevating the concentration level of isolated peaks including first product A1 in #3 and second product A2 in #5 solution and minimizing consumption of #1, #2, #4 and #6 mobile phase parameter solution. Depending on requirement of particular target system, #2, #4, and #6 solution has option of being continue recycling back to identical said holding tank 15 via its predetermined recycle route of liquid distribution loop or discarded if running condition of such parameter is getting weak, or adjusted its running condition for other usage; wherein #1 can either be continue recycling or blending with feed solution for feeding zone 20. From a single column study means this elution profile illustrated in FIG. 10 representing multiple of said mass transfer phenomena/equilibrium status are reached in sequence and yet simultaneously employed via this disclosed apparatus to carry out mass transfer equilibrium contact between particular mixtures of mobile phase parameter solution entering from top of each cell 95 promptly sipping through resin/adsorbent bed for expected separation.

Via aforesaid single stage recycle protocol explicated thoroughly in FIG. 9 and FIG. 11, simultaneous transmitting of various liquid into respective zone during steady state operation employed by this disclosed apparatus, again, through which it transforms traditional chromatographic separation path from parallel into vertical with mobile phase's flow direction. From the viewpoint of entire separation cycle amid instance of steady state operation, a complete separation cycle is accomplished after every spent of minimal time interval for all zones through elution result of said single column testing illustrated in FIG. 8 and FIG. 10 to achieve major object of said Parametric Differential Moving Bed (PDMB) briefly illustrated in FIG. 1 of this disclosure. Moreover, the resin/adsorbent loaded in each cell 95 disposed in various zones is always active and independent from each other. It means the native engineering drawbacks of conventional column process, such as high-pressure operation and axial dispersion and end effects will not deteriorate the efficiency of new separation process. It means the impurity-stripping zone will maximize its stripping efficiency to assure high throughput of impurities. It means for multiple product recovery zone maximize the production rate, product yield and economic efficiency. It means for regeneration and washing/sanitizing zone, located after the product recovery zone and before the feeding zone minimize the process time and to maximize the production rate. It then concludes that the disclosed apparatus provide the maximum operation efficiency and such efficiency is limited only by the mechanical capability of preferred apparatus to proceed amid minimum time interval to achieve the expected separation results. Evidently, such operation efficiency can be preserved and under control by process itself inasmuch as the predetermined or selected combination of mobile phase parameters in related with resin/adsorbent are suitable for target system. Generally speaking, the scale up of target system from bench top scale to production scale is to quantify between increments of feed solution throughput requirements. The production scale simply magnifies with size increments to a larger process size. This disclosure has evidently changed the rule that simply by increasing the quantity of multiple bench-top scale to meet such feed throughput requirements. As all cells 95 disposed in said apparatus representing as one small scale that are independent from each other and simultaneously, perform one task at any instance such that the integration and coordination of all cells become a complete process. Again, with employment of taught methods onto disclosed apparatus, based on same throughput between chromatography and this invention, it has successfully demonstrated for reduction of cycle time to each spent of said minimal time interval, Δt. It means that the resin/adsorbent inventory can be proportionally reduced as dramatic cycle time reduction. It then advantageously reduces the cost of production due resin/adsorbent reduction that gives rise to smaller equipment to generate numerous economic benefits.

The principle objects of the present invention is to provide a corresponding operation protocol for disclosed apparatus to implement the aforesaid methods; to continuously and automatically isolate a single product or multiply products from a target mixtures, through which can be readily comprehended from the following exemplified target separation systems, tables of separation result from single column test via execution of said new mass transfer equilibrium contact method, single stage recycle protocol for large scale production apparatus, operation protocol of disclosed apparatus, and resin/adsorbent inventory calculated based upon specified throughput for disclosed apparatus through impending illustration of FIG. 12 through FIG. 14. Again, prior to the implementation of differential set-up between two phases employed onto disclosed apparatus, a preliminary study to obtain characteristic profile via a single column test for a satisfied separation is required. Such column construction can be choice between said single columns 23 bundled as group disposed in cell 95 illustrated in FIG. 1 through FIG. 5 and cell 95 as column 23 itself been illustrated in FIG. 6 and FIG. 7. Due to combined characteristic property between feed solution and matched resin/adsorbent, following demonstration utilizes cell construction as embodiment in FIG. 2 through FIG. 5 via binary target system of glucose and fructose separation.
a) Feed solution: High Fructose Corn Syrup (HFCS) received from domestic corn refiner, having composition of Fructose 43.05%, Glucose 51.09%, and balance of Oligos, with concentration of 71.1% dry substance. This homogeneous aqueous liquid mixture is diluted with dirt-free de-ionized eluent water to 60% dry substance.
b) Resin/adsorbent: Dowex Monosphere 99, Calcium base strongly acidic cation exchanger with mean particle size of 320 μm±10 μm.
c) Eluent liquid: dirt free de-ionized water.

Above said aqueous feed solution provided from domestic corn refiner and same resin/adsorbent specification are investigated via single column testing, through which to demonstrate significant distinction of mass transfer phenomena between this disclosure and well adopted chromatographic process like simulated moving bed (SMB). The new mass transfer equilibrium contact method is investigated under 27 inch-Hg vacuum applied from bottom of resin/adsorbent bed to continuously drain off the inter-particle's fluid; wherein resin/adsorbent bed is 0.95 cm in I.D. and 206 cm in bed height. The resin/adsorbent is filled to 195.6 cm in bed height and occupied total bed volume of 139.6 cc. The 36 cc of feed volume amount is introduced is equivalent to 25.8% of resin/adsorbent bed volume. The transit reservoirs of feed solution, recycled streams, and eluent water are all jacketed with 65° C. water circulation. All liquid inputs are simulated by a quick stroke of liquid pipette to deliver the predetermined volume amount in a form of said input S-I during each very short time duration. The bottom of resin/adsorbent bed is equipped with an airtight easy thread on and off bottle for sample collection by every prearranged time interval, which is said minimal time interval. The vapor recovery unit jacketed with circulated cold water is installed in between the bed and vacuum pump, thus condensed water is collected from bottle installed under such condenser. Instead of providing pressurized inert gas in between each dose of liquid delivery, pressurized air is supplied from column top to drain treated liquid for convince and affiliated with bottom exerted vacuum for fast liquid draining.

As shown in FIG. 12, wherein the glucose, fructose, and oligosaccharide concentration are plotted as D.S. % (dry solid percentage) in Y-axis vs. elution time in X-axis indicated total cumulated of ninety-six of said minimal time intervals as one minute representing one Δt. Such characteristic elution profile is resulting from execution of said new mass transfer equilibrium contact method and Table 1 has listed the composition and concentration of retrieved glucose as raffinate in zones 5, 6, 7 and fructose as product in zone 21, which demonstrates the ultimate separation results are obtained on both glucose and fructose with elevated concentration level. The concentration of nearly pure fructose product is elevated to over 51 D.S. % as indicated.

TABLE 1

| Zone | D.S. % | Recovery % | Glucose % | Fructose % |
|---|---|---|---|---|
| 5, 6, 7 | 35.7 | 100% of glucose | 100.00 | 0.00 |
| 21 | 51.55 | 100% of fructose | 0.015 | 99.985 |

Those experimental procedures and satisfactory elution profile are actually set to simulate aforesaid new mass transfer equilibrium contact method and employed such profile in accordance with the disclosed apparatus as illustrated in FIG. 2 through FIG. 7, for upstream holding tanks A of inputting of all kind of sugar mixtures including feed solution and eluent water, via upstream rotary union valves module B for precise liquid distribution afterward, for separation module C integrated with inert gas supply module F to preform separation, further for treated and drained liquid via downstream valves body D, and finally through downstream holding tanks module E for further liquid distribution during each spent of time interval.

In order to employ said general method of differential set-up for this binary glucose and fructose enrichment onto said apparatus comprises following revised procedures:
1. Determining optimal full-strength bonding capacity of said resin/adsorbent with a prefixed feed throughput and filling such resin/adsorbent amount into a said cell 95;
2. sequentially breaking down the elution profile obtained by said new mass transfer equilibrium contact method as shown in FIG. 12 is the partial time required to spend for respective predetermined mobile phase solution input for each zone, this including feed solution, eluent water, and multiple recycle streams except retained raffinate and product;
3. divide each partial time by said minimal time interval to obtain the range cumulated Δt as major minimal time interval of cell 95 disposed for feeding zone and other zones following same major time interval of most time-consuming feeding zone. Then, divide total input volume amount of such liquid by the number of cells to obtain the partial volume amount required for each cell disposed in respective zone; then, divides such said partial volume by a preselected number to further differentiate for multiple liquid doses sipping through resin/adsorbent in each cell 95 to reflect general procedures of said new mass transfer equilibrium contact method. Further divides said resin/adsorbent amount in step 1, which derived from complete saturation with feed solution throughput, by a pre-selected number that corresponds to differential resin/adsorbent amount disposed in at least one column 23 bundled in a single cell 95 disposed in each zone to simultaneously receive the partial volume amount of such liquid for each cell among said group of cells 95;
4. sequentially allocate all cells with respective mobile phase solution as the range of respective zone and allocate all zones into an endless format; wherein integrating all zones orderly arranged in such endless format representing a complete elution profile separation cycle via upstream rotary union module B and downstream rotary module D to transmitting all kind of mobile phase parameter solution into underneath stationary separation module C is to simulate all cells 95 in horizon moving direction whereas mobile phase is simultaneously traveling in vertical direction;
5. prepare predetermined volume amount of respective predetermined mobile phase solution according to obtained characteristic profile to store in respective holding tank in said downstream holding tanks module E for such liquid distribution thereinafter throughout the disclosed apparatus to achieve expected separation.

As shown in FIG. 12, a preferable elution profile for complete separation cycle obtained from single column 23 is derived via above revised differential set-up procedures resulting as one minute per minimal time interval, Δt; 4 minutes as a major minimal time interval per zone thus converted to total 24 zones arranged in sequence to reflect such profile in total of ninety-six minute time. In fact, one minute per Δt is randomly chosen and it can be in multiple as another predetermined minimal intervals, which is interpreted as a predetermined major zone to proportionally reduce number of zones with modification of procedures. Note that obtained elution profile beginning from time zero means elution proceeded via general procedures of said new mass transfer equilibrium contact method starts from beginning of column 23 and is fundamental difference from typical chromatographic operation. Such profile justifies previous illustration to eliminate said displacement zone, and further utilize the void volume available for prompt mass transfer proceeding, and meanwhile creating a zero dead volume process of said Parametric Differential Moving Bed (PDMB).

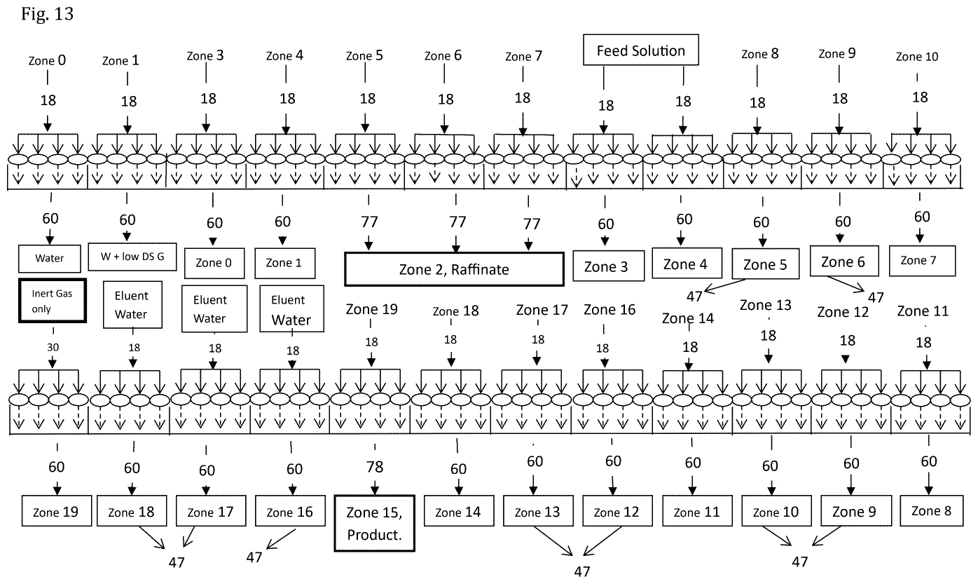

FIG. 13 exemplifies preferred twenty-four zones set up employed via said differential set-up protocols onto disclosed apparatus for simultaneously and intermittently inputting via said input S-I format for said feed solution and eluent water transmitted from its source, various recycle sugar mixtures being orderly transmitted via liquid line 47 and stored in assigned holding tank 15 of said upstream holding tanks module A (not shown to simplify drawing), and via liquid line 18 to distribute thereafter. All kind of liquids stored in each tank 15 being orderly disposed from named zones 0, 1, 3, 4, 5, 6, 7, feed solution comprising of two zones inputting 36 cc of volume, zones 8, 9, 10, 11, 12, 13, 14, 16, 17, 18, 19, eluent water comprising of three zones consuming total of 58.5 cc, and lastly pressurized inert gas to purge all remaining liquid preparing semi-dry resin/adsorbent ready for next separation cycle, wherein all said liquids amid steady state operation being simultaneously transmitted via respective liquid line 18 into underneath each cell shown as “oval” to simplify drawing for representing a minimal time interval Δt in time domain; thus 4 of Δt disposed as a major minimal time interval per zone shown in between two solid lines, to simultaneously and intermittently receiving said multiple liquid doses in sequence; and wherein each dropped liquid dose promptly sipping through resin/adsorbent bed to proceed expected mass transfer phenomena; wherein various treated and collected liquid solutions, transmitted via each underneath various liquid lines 60, 77, 78 as shown into respective holding tank 44 in said downstream holding tanks E and such mobile phase distribution routing has been thoroughly illustrated in FIG. 2 through FIG. 5; wherein as orderly disposed in assigned tank 44 counting from upper left of this figure named as “water” for predetermined recycle usage, low D.S. % glucose in dilute solution for other usage, zones 0, 1 for recycle, raffinate recovery zone 2 comprising 3 consecutive cells 95, zones 3, 4, 5, 6, 7, 8, 9, 10, 11, 12, 13, 14 for recycle, product recovery zone 15, and zones 16, 17, 18, 19 for recycle respectively. With both retrieved water from above said “water” via inputting zone 0 recycled solution is 10.8 cc and aforesaid moisture enriched wet inert gas first through mist separator 50 disposed in said inert gas supply module F to convert wet to dry inert gas which is liquid water in this system in reservoir 52 for recycle is 5 cc, this binary purification system further evidently illustrates the single stage recycle protocol can proceed separation and meantime being for elevating the concentration level of purified fructose product and glucose raffinate. Via this binary glucose and fructose separation following example is the direct comparison between said Parametric Differential Moving Bed (PDMB) and Simultaneous Moving Bed (SMB).

### Example 1

To handle a 200 gallons per minute of 60% D.S. feed throughput; the typical industrial apparatus of Simulated Moving Bed (SMB) process is designed as four columns having each of 14 feet in I.D. and 27.5 feet in height. Each column loaded with 4125 cubic-ft., or, 30,855 gallons has total of 123,420 gallons resin/adsorbent stock. SMB requires 350 gallons per minute input rate of eluent water to retrieve 88% of fructose recovery in purity as 90% of fructose and 10% glucose. Direct comparison in between SMB process and current disclosure is based in terms of resin/adsorbent stock and eluent consumption under same throughput and feed composition. As indicated in single column test, total 5 cc of condensed water and 10.8 cc of zone 0 being retrieved to make consumption 58.5 cc as net water consumption is 42.7 cc, thus, volume ratio of water to 36 cc of feed is 1.19. It means 238 gallons of eluent water is required based on 200 gallons throughput. The current disclosure has 68% water consumption compared to 350 gallons in traditional SBM process.

The 36 cc of feed volume being input amid single column test and such feed volume is equivalent to 25.8% of said resin/adsorbent 139.6 cc bed volume. Thus, volume ratio of feed input to bed volume is 0.258. The cycle time is 96 minutes shown in FIG. 12, which is 96 minimal time interval. The resin/adsorbent stock required for 96 minutes cycle time is calculated by 200 divided by 0.258 then multiplied by 96, which is equivalent to 74419 gallons to handle 200 gallons per minute feed throughput. In comparison to 123,420 gallons used up in SMB process, the resin/adsorbent stock calculated with said 123420 gallons is 60.3% based on alike feed throughput. Furthermore, the superior separation result demonstrated in previous examples is evidently relevant to this cycle time and is fundamental to calculate required resin/adsorbent stock to be employed by this disclosed apparatus and process.

For sake of large scale separation process, again, glucose and fructose binary purification system is explicated onto disclosed apparatus in connection with differential set-up illustrated in FIG. 12 for such demonstration, wherein said general procedures of new mass transfer equilibrium contact method starting from carrying out a start-up state operation means for generating fresh semi-dry status resin/adsorbent installed in separation module C as fresh status in order to reach initial equilibrium status throughout disclosed apparatus via each incoming sugar mixture, wherein start-up operation comprise following:
1. through means of aforesaid various liquid delivery route illustrated in FIG. 2 through FIG. 5, a predetermined volume amount of various liquids from respective holding tanks 15 starting internally from zone 0, then, expand simultaneous liquid input covering next zone in sequence among zones 0, 1, 3, 4, 5, 6, 7, feed solution, 8, 9, 10, 11, 12, 13, 14, 16, 17, 18, 19, eluent water, and lastly inert gas followed after eluent water, being transmitting entire available liquid volume simultaneously via means of pipelines 18 into transit reservoir 21 disposed in said upstream rotary union module B; advance one rotation step through means of rotation and positioning together with seal mechanism in predetermined rotating direction, then via of pipelines 61 as indicated into each underneath cell's top-inlet for carrying out following mass transfer equilibrium contact process;
2. intermittently deliver through means of alternated supplying of pressurized inert gas between pipe 30 and pipe 9 following delivery of various liquids in dose of predetermined volume amount to force draining of dropped liquid promptly sipping through said resin/adsorbent to complete expected mass transfer equilibrium contact between two phases;
3. maintain a vacuum 31 to continuous drain the individual liquid solution into respective underneath temporary reservoir 33 and to maintain resin/adsorbent in a semi-dry status;
4. intermittently collect of all kind of treated and drained liquids in each temporary reservoir 33; transmitting by means of pipelines 59 into transit reservoir 38 disposed in said downstream rotary union module D; advance one rotation step through means of rotation and positioning together with seal mechanism in predetermined rotating direction, then, through 60 shown in FIG. 2 through FIG. 5 into each assigned holding tanks 44 in downstream holding tanks module E, transmitting predetermined volume amount out of holding tank 44 via means of pipelines 47 to assigned holding tank 15 in upstream holding tanks module A;
5. Repeating repeatedly step 1 through step 4 initially for zone 0, then “zone 0 together with zone 1” until transit reservoir 21 in upstream rotary union module B and transit reservoir 38 in downstream rotary union module D return to each initial position to complete one revolution, so that, start-up operation can be concluded, wherein retrieved all kinds of liquids during start-up operation as “water” for predetermined recycle usage, water with low D.S. glucose solution for other usage, recycle streams of zone 0, 1, 3, 4, 5, 6, 7, 8, 9, 10, 11, 12, 13, 14, 16, 17, 18, and 19; except the solution collected of zone 2 is glucose Raffinate and solution of zone 15 is fructose product as illustrated in FIG. 13; further transmitting all kind of sugar mixtures for recycling except Raffinate and Product, from each assigned holding tank 44 in downstream holding tanks module E via means of pipelines 47 to each corresponding holding tank 15 in upstream holding tanks module A.

Soon, start-up operation being concluded, thereafter disclosed apparatus can shift into steady state operation. Through all kind of liquids set for all zones arranged in FIG. 13 through means of liquid delivery described in FIG. 2 through FIG. 5 that is related with satisfied sugar mixture separation as illustrated in FIG. 12. Within predetermined time spent for each zone, such plurality of transit reservoirs 21 simultaneously receive entire available predetermined amount of various kinds of liquid delivery and simultaneously transmitted into assigned cell proceeding said new mass transfer equilibrium contact method carried out in separation module C to obtain each treated sugar mixtures from respective cell bottom as steady state operation. The same procedures repeat repeatedly as following steady state operation;
1. through means of aforesaid various liquid delivery route illustrated in FIG. 2 through FIG. 5, a predetermined volume amount of various liquids from respective holding tanks 15 of zone 0, 1, 3, 4, 5, 6, 7, feed solution, 8, 9, 10, 11, 12, 13, 14, 16, 17, 18, 19, eluent water, and lastly inert gas followed after eluent water, are simultaneously transmitting entire available liquid volume via means of pipelines 18 into transit reservoir 21; advance one rotation step through means of rotation and positioning together with seal mechanism in predetermined rotating direction, then via of pipelines 61 as indicated into each underneath cell's top-inlet for carrying out following mass transfer equilibrium contact process;
2. intermittently deliver through means of alternated supplying of pressurized inert gas between pipe 30 and pipe 9 following delivery of various liquids in dose of predetermined volume amount to force draining of dropped liquid promptly sipping through said resin/adsorbent to complete expected mass transfer equilibrium contact between two phases;
3. maintain a vacuum 31 to continuous drain the individual liquid solution into respective underneath temporary reservoir 33 and to maintain resin/adsorbent in a semi-dry status;
4. intermittently collect of all kind of treated and drained liquids in each temporary reservoir 33; simultaneously transmitting by means of pipelines 59 into transit reservoir 38; advance one rotation step through means of rotation and positioning together with seal mechanism in predetermined rotating direction, then, through 60 shown in FIG. 2 into each assigned holding tanks 44 disposed in downstream holding tanks module E; wherein all kind of liquids retrieved as “water” for predetermined recycle usage, water with low D.S.-glucose solution for other usage, recycle streams of zone 0, 1, 2, 3, 4, 5, 6, 7, 8, 9, 10, 11, 12, 13, 14, 15, 16, 17, 18, and 19; wherein the solution collected from zone 2 is glucose Raffinate and solution from zone 15 is fructose product;
5. as illustrated in FIG. 2, further transmitting all kind of sugar mixtures for recycling except Raffinate and Product, from each assigned holding tank 44 in downstream holding tanks module E via means of pipelines 47 to each corresponding holding tank 15 in upstream holding tanks module A.

All the repeated disclosed apparatus operation procedures are accomplished during accumulation of each spent of said minimal time interval, Δt, which is covered from step 1 through step 5. Such minimal time interval specified in FIG. 12 represents the elution profiles obtained from a single cell's study. Through implementation of said new mass transfer equilibrium contact method and said differential set-up between two phases onto disclosed apparatus, every four minutes time spent for each particular liquid zone is equivalent to one separation cycle. Nevertheless, this invention has shown that the traditional mass transfer path occurred in chromatography, typically in parallel with liquid flow direction, has been converted into perpendicularity with flow direction. Also, note that aqueous feed solution is introduced from its source via line 47 located in between recycled stream of zone 7 and zone 8, wherein feed solution has glucose content slightly lower than that in zone 7 and slightly higher than that in zone 8. The component of glucose and fructose originally contained in the feed solution is thus migrating horizontally through recycle streams toward zone 2 recovered as a raffinate stream of pure glucose via line 77, and toward zone 15 recovered as a product stream of pure fructose via line 78. Furthermore, the traditional chromatography spends extra time for pushing off the displacement zone, in which the separated component is travelling with bulk liquid flow. This invention has demonstrated the elimination of such said displacement zone 89 described in FIG. 1 and therefore the cycle time is dramatically reduced to 4 minutes, thus, the resin/adsorbent inventory, eluent water consumption, and other unspecified operation cost can be diminished proportionally. Again, binary feed solution being determined to introduce in between recycled stream of zone 7 and zone 8 mainly because single column test result concludes such differential set up and single stage recycle protocol employed by disclosed Parametric Differential Mobile Bed (PDMB) is major difference among chromatographic operations and well adopted Simultaneous Moving Bed (SMB) process. In fact, the characteristic elution profile obtained via general procedures of new mass transfer equilibrium contact method single column test inherently points out this HFCS separation requires very long and narrow column in chromatographic operation and is merely impossible for very long and narrow column due to high pressure drop that need to install rigid resin/adsorbent to withstand such pressure and all kind of concurrence fluid dynamic issues such as diffusion/mixing and column boundary effect, whereas disclosed hybrid PDMB solved those issues.

Said termination stage is the reverse protocols of start-up operation for generating resin/adsorbent installed in separation module C back to fresh semi-dry throughout disclosed apparatus comprises following:
1. through means of aforesaid various liquid delivery route illustrated in FIG. 2 through FIG. 5, stop transmitting a predetermined volume amount of various liquids from respective holding tanks 15 starting internally from zone 0, yet still providing simultaneous liquid input covering next zone in sequence among zones 0, 1, 3, 4, 5, 6, 7, feed solution, 8, 9, 10, 11, 12, 13, 14, 16, 17, 18, 19, eluent water, and lastly inert gas followed after eluent water, being transmitting entire available liquid volume simultaneously via means of pipelines 18 into transit reservoir 21 disposed in said upstream rotary union module B; advance one rotation step through means of rotation and positioning together with seal mechanism in predetermined rotating direction, then via of pipelines 61 as indicated into each underneath cell's top-inlet for carrying out routine mass transfer equilibrium contact process;
2. intermittently deliver through means of alternated supplying of pressurized inert gas between pipe 30 and pipe 9 following delivery of various liquids in dose of predetermined volume amount to force draining of dropped liquid promptly sipping through said resin/adsorbent to complete expected mass transfer equilibrium contact between two phases for zones receiving transmitted liquid;
3. maintain a vacuum 31 to continuous drain the individual liquid solution into respective underneath temporary reservoir 33 and to maintain resin/adsorbent in a semi-dry status;
4. intermittently collect of all kind of treated and drained liquids in each temporary reservoir 33; transmitting by means of pipelines 59 into transit reservoir 38; advance one rotation step through means of rotation and positioning together with seal mechanism in predetermined rotating direction, then, through 60 shown in FIG. 2 through FIG. 5 into each assigned holding tanks 44 in downstream holding tanks module E, transmitting predetermined volume amount out of holding tank 44 via means of pipelines 47 to assigned holding tank 15 in upstream holding tanks module A;
5. Repeating repeatedly step 1 through step 4 initially for stopping transmitting liquid starting zone 0, then “zone 0 together with zone 1” until transit reservoir 21 in upstream rotary union module B and transit reservoir 38 in downstream rotary union module D return to each initial position to complete one revolution, so that, termination operation can be concluded to producing installed resin/adsorbent back to initial fresh semi-dry status.

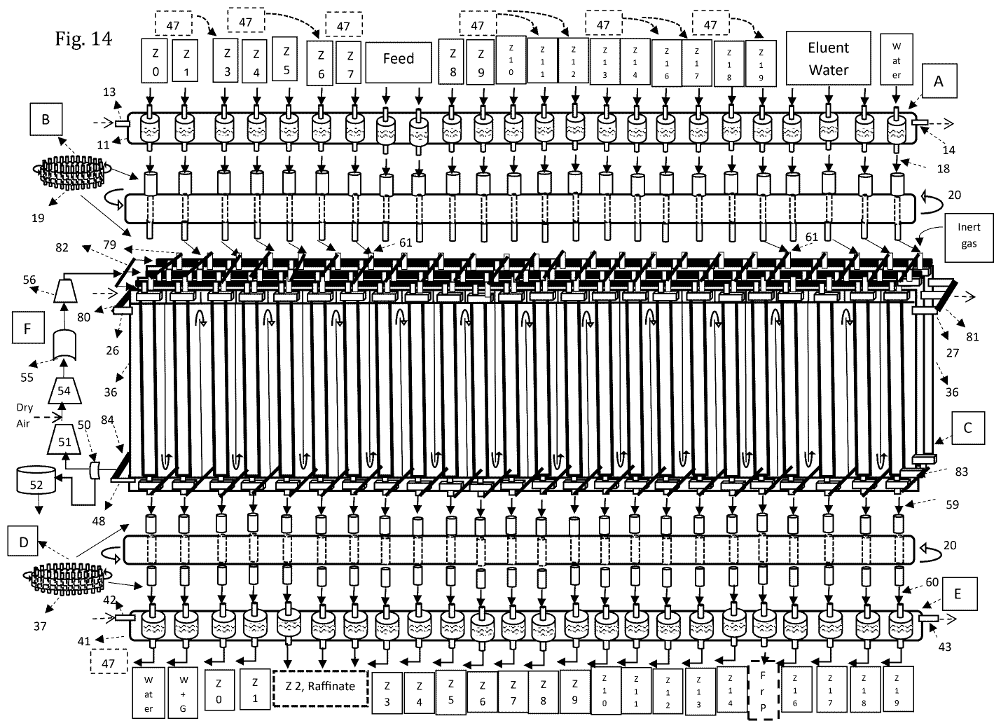

As shown in schematic drawing of FIG. 14, this drawing means for briefly reiterating exemplifies preferred twenty-four zones set up illustrated in FIG. 13 in connection with FIG. 2 on all kind of liquid flow route amid steady state operation and meanwhile emphasizing preferred insulated heat media circulation jacket for upstream holding tanks module A, separation module C, and for downstream holding tanks module E; wherein all mechanical components contained in above said three modules are arranged in an endless format as some other preferential set up pattern. Again, water can be preferred heat media unless specified otherwise based on requirement of particular separation system and is the heat media selected to exemplify this glucose and fructose binary purification system.

Meanwhile, this FIG. 14 further illustrates multiple separation module C simultaneously operated in parallel exemplified in three of such modules as following steps, wherein
1. via aforesaid respect pipeline 47 out of downstream holding tanks E transmitting all kind of recycle mixture except zone 2 glucose raffinate and zone 15 fructose product in predetermined volume amount from zone 0, 1, 3, 4, 5, 6, 7, 8, 9, 10, 11, 12, 13, 14, 16, 17, 18, 19, eluent water, and recycled water that is collected from bottom portion of separation module C; followed with inert gas after recycled water input to flush liquid residue to maximize fructose recovery as zone 19 recycled liquid to assigned holding tank in upstream holding tanks module A; such plurality of holding tanks disposed in module E arranged in said endless format set inside said insulated warm water circulation jacket 41 having a manifold inlet 42 and manifold outlet 43 for water circulation to maintain whole plurality of holding tanks in a selected temperature range;
2. via aforesaid respect pipeline 47 transferring above said recycling liquid into each of corresponding plurality of holding tanks in said upstream holding tanks module A arranged in same endless format set inside a water circulating jacket 11 having a manifold inlet 13 and manifold outlet 14 for water circulation; and further 3. via aforesaid respect liquid pipeline 18 transmitting entire specified recycle stream in predetermined volume amount from respective tank in said upstream holding tanks A of zone 0, 1, 3, 4, 5, 6, 7, feed solution from its source, zone 8, 9, 10, 11, 12, 13, 14, 16, 17, 18, 19, eluent water from its source, and recycled water are simultaneously delivered via means of pipelines 18 into said upstream rotary union valves module B; wherein said upstream rotary union valves module B having a valve body 19 comprising a plurality of top side liquid transit storage reservoirs arranged in an endless format, installed at predetermined location to simultaneously receiving said predetermined volume amount of liquid transferred from particular holding tank of above said holding tanks module A. Said valves body 19 having an equal quantity of outlet conduct installed at bottom side of corresponding location of such valve body means for transferring all kind of liquids via each manifold alike 79 disposed above top portion of respective separation module C to precisely transmit said predetermined volume amount of liquid in equal portion simultaneously into each corresponding cell top of such module operated in parallel; soon top side liquid transit reservoir receiving entire liquid solution is completed, advance one rotation step through means of rotation and positioning together with seal mechanism in predetermined rotating direction 20.
4. via aforesaid each liquid pipeline 61 as indicated simultaneously transmitting all kind of liquid into following multiple separation module C operated in parallel along providing inert gas into last set of cells to purge off remaining liquid; wherein said each module C comprising plurality of columns with top opening and bottom meshed filter installed in each cell and all cells arranged in an endless format disposed in an preferred insulated water circulation jacket 36, such jacket having plurality of baffle plates vertically installed to confine each cell inside a predetermined compartment, such plate alternatively arranged as indicated to allow water freely enter from one inlet and exit next outlet into next compartment; so that warm water entered via each manifold alike 80 through each liquid conduct 26 of respective jacket 36, freely circulating through first cell in each module, then continue entering 2^{nd} cell, 3^{rd} cell until water stream pass through all confined cell compartments, then exit each of said jacket 36 via manifold alike 81 through each liquid conduct 27 as indicated to maintain all installed cells in an predetermined temperature range of multiple separation module C operated in parallel;
   a. aforesaid particular liquid transferred via respective pipeline 61, only showing six of such pipeline to simplify drawing, through each said manifold 79 disposed above of particular cell top to distribute such liquid in equal portion through each cell's top liquid inlet means for wetting partial of contained resin/adsorbent in a cell; intermittently and simultaneously deliver through means of integrated inert gas supply module F to force draining of delivered liquid dose sipping through said resin/adsorbent to complete expected mass transfer equilibrium contact between two phases;
   b. maintain a vacuum environment of each cell bottom of respective separation module C operated in parallel to drain the particular liquid into respective underneath temporary reservoir as indicated and to maintain resin/adsorbent in a semi-dry status;
   c. aforesaid integrated inert gas supply module F with each separation module being operated in an closed loop exerted evenly onto entire bottom portion of multiple separation module C operated in parallel, such vacuum environment being exerted via a central vacuum pump 51; wherein inert gas supply module F comprising manifold alike 84 disposed around each cell bottom portion of respective separation module C via each gas pipe 48 connected to respective separation module C operated in parallel to extract water moisture enriched wet inert gas; first through mist separator 50 to convert wet to dry inert gas and meanwhile to collect water liquid in reservoir 52 for recycle; such vacuum exerted around each cell bottom means to maintaining said resin/adsorbent in a semi-dry status to meet criterion of new mass transfer equilibrium contact method; means to create a heterogeneous contact as liquid promptly sipping through stationary resin/adsorbent particles to reach mass transfer equilibrium contact status. Such dry inert gas exiting mist separator 50 is combined with pressurized dry air and deployed through an inert gas generator 54 to obtain fresh dry inert gas and to store in a steel tank vessel 55 maintaining at preferred broad range of pressure level ready for deploying back to said top portion of each separation module C operated in parallel via inline gas temperature adjuster 56 through each manifold alike 82 disposed above each cell top portion of respective separation module to promptly force out dropped dose of all kind of liquid to carry out mass transfer equilibrium contact through solid phase resin/adsorbent material and gathering treated liquid in each bottom cell liquid reservoir as preferred operation into downstream holding tanks module E;
5. intermittently collect of all kind of treated and drained liquids from respective cell bottom of each said separation module C operated in parallel; wherein transmitting altogether of such same liquid via means of respective manifold alike 83 disposed underneath each particular cell bottom portion of respective separation module C through each liquid pipelines 59 into said downstream rotary union valves module D, wherein said downstream rotary union valves module D having a valve body 37 comprising a plurality of top side liquid transit storage reservoirs arranged in an endless format, installed at predetermined location to simultaneously receiving said predetermined volume amount of liquid transferred from particular transit reservoir of above said separation module C operated in parallel, and wherein said valves body 37 having an equal quantity of outlet conduct installed bottom side at corresponding location to precisely transmit said predetermined volume amount of liquid; soon top side liquid transit reservoir receiving entire liquid solution is completed, advance one rotation step through means of rotation and positioning together with seal mechanism in predetermined rotating direction 20;
6. via aforesaid respect liquid pipeline 60 transmitting entire specified stored liquid solution at downstream rotary union valves module D as indicated in this FIG. 14 into each assigned holding tank in downstream holding tanks module E; wherein retrieved liquid as water for recycle, water with low D.S.-glucose solution for other usage, recycle streams of zone 0, 1, 2, 3, 4, 5, 6, 7, 8, 9, 10, 11, 12, 13, 14, 15, 16, 17, 18, and 19; wherein the solution collected from zone 2 is a Raffinate of pure glucose and solution from zone 15 is a product of pure fructose; wherein said downstream holding tanks module E as shown in bottom part of FIG. 14 arranged in same endless format set inside a water circulating jacket 41 having a manifold inlet 42 and manifold outlet 43 for water circulation to maintain whole plurality of holding tanks in a selected temperature range. Moreover, repeating step 1 through step 6 indicated in this FIG. 14 as steady state operation means to provide single stage recycle protocol employed by the disclosed apparatus as purpose for further breaking down massive feed solution throughput requirement via illustrating binary glucose and fructose system through multiple separation module C simultaneously operated in parallel for object mentioned previously.

### Example 2

In this example, a single component protein solution, hemoglobin abbreviated as Hm, is explored on traditional chromatography to demonstrate the iso-point belief by cyclic adsorption and desorption. Hm has molecular weight of 63,000 and iso-electric point is at pH6.7 means protein in this solution carry no charge. The protein carries positive charge in solution with pH value below 6.7 and conversely carrying a negative charge in solution with pH value above 6.7. In fact, this pH value is corresponding to mobile phase parameter said in FIG. 8 through FIG. 10 to control solute which is Hm behavior in contact with disposed resin/adsorbent column. The chromatography column has 2.6 cm in I.D. and 15 cm in length, was fully loaded with CM Sepharose; a cation exchanger (R″). The Hm feed solution is prepared at 0.01 wt. % in 0.1 M Tris-HCl buffer solution. The reciprocating flow through the column was achieved by a reversible peristaltic pump, which is connected to a timer for precise measurement of sample input volume. Multi-way valves are installed on column inlet to introduce the feed and elution buffer at different pH value. Each sample stream was collected at equal 3 minutes time intervals which is 7.5 c.c. for pH value and protein concentration measurement.

In FIG. 15 shows three consecutive cyclic waves of pH and Hm characteristic elution profile denoted in dimensionless form as relative concentration ratio (Yp/Yo) for each collected sample with respected to the accumulated elution volume (E.V.), cc., wherein “Yp” stands for sample concentration vs. “Yo” stands for one unit of feed concentration as relative ratio. The feed solution was prepared at pH 6.0 and Hm carries positive charge, oppositely to cation exchanger (R⁻) loaded in column. Total 67.5 cc of feed solution is introduced via said pulse input 86 as described in FIG. 1, resulting Hm been adsorbed onto the resin/adsorbent starting from very beginning of the column. This saturated resin/adsorbent with incoming feed solution is corresponding to feeding zone 20 described in FIG. 1, and FIG. 8 through FIG. 11. Remaining unsaturated resin/adsorbent parallel with mobile phase moving direction is so called displacement zone 89 being saturated with pH 6.0 mobile phase parameter (buffer) solution. Following total 67.5 cc of pH 8.0 buffer solution is introduced via same pulse input 86 pushing existing pH6 buffer exiting from other end of column. Analogous to the narrow transient region 88 illustrated in FIG. 1, resulting mobile phase parameter being progressively changing from pH6 to pH8, in which eluted Hm elution profile is confined in between this two pH level as pH8.0 is behind pH6 as transient profile.

This example shall elucidate fundamental issues in typical ion exchange chromatography operation; yet, other combination of mobile phase and resin/adsorbent performing similar purification mechanism for large scale production like affinity, reverse phase, normal phase, and ligand exchange that can chemically and selectively interact with the dissolved components in mobile phase are somehow in general suffering deteriorating separation efficiency due to aforesaid native deficiency of chromatography process. Via controlling said mobile phase parameter and by passing mobile phase transport dynamics issues toward employing said new mass transfer equilibrium contact method and differential set-up between two phases onto disclosed apparatus, following are distinct differences between this Parametric Differential Mobile Bed (PDMB) and chromatography, such as well adopted Simultaneous Moving Bed (SMB) process.

As shown, each of Hm elution profile has a tall and sharp turning at its corresponding pH 6.7, which is matching with said Hm's iso-electric point that Hm in this neutral pH solution is the minimal pH not be adsorbed by R″ resin/adsorbent and is the critical pH causing Hm starting to elute. Again, note that both Hm and pH profiles are concurrently traveling starting from zone 20 throughout adjacent zone 89 and collected as samples, wherein such outgoing total solution volume comprise of said dead volume and void volume of typical chromatographic operation. This shall justify iso-point belief as fundamental for disclosed PDMB process to eliminate the displacement zone 89 in chromatography.

Initially, such Hm is a very sharp and narrow band when eluted and progressively turning wider as eluted Hm band being pushed and approaching toward column outlet, this irrevocable deteriorated separation efficiency mainly caused by the diffusion, axial dispersion and column end effect commonly noted in chromatography. Furthermore, due to parabolic profile of mobile phase velocity distribution resulting eluted Hm unavoidable to enter near column wall region that mobile phase pH is below 6.7 causing such Hm being adsorbed again and eluted by upcoming pH higher than 6.7. This explains each Hm profile shown in this figure has flat front located in region 173 between pH 6.0 and 6.7 while long trailing tail been expanded in region 174 located after pH 6.7 toward the end of pH 8.0. This native issues of fluid dynamitic phenomenon cause overlapping or so called co-elution that gets worse in large-scale column or slowing moving mobile phase is required, thus, creating feed solution loading limitation to avoid badly deteriorated separation efficiency and has been tolerated ever since chromatography related process being explored for large scale purification process. As aforesaid discussion of those native engineering drawbacks in conjunction with traditional chromatography operation is time consuming, inefficient usage of resin/adsorbent, limited loading capacity, and activate the axial dispersion and column end-effects to ruin the initial separation, and so forth. This mobile phase transport phenomenon also validates the belief for desorption of adsorbed solute components will not be materialized unless surrounding mobile phase parameter has exceeded this component's iso-point and again is fundamental to develop alternative for eluding chromatography as mass production purpose. Analytical chromatography justifies being a great tool for analytical purpose; yet, large scale production apparatus utilizing identical methodology or concept definitely requires different approach to preserve such useful methodology of chromatography.

Note again, single column test via general procedure of new mass transfer equilibrium contact method, elution profile starts from beginning of column thus displacement zone is completely eliminated. Furthermore, this example also justifies disclosed PMBD convert an elution profile of a particular separation system derived from typical chromatography sequential operation being arranged along disclosed apparatus in horizontal direction to receive mobile phase transmitted in vertical direction to simultaneously achieve a complete separation cycle during duration of each said minimal time interval, Δt, being spent.

### Example 3

In following impending examples, partially purified human placenta crude enzyme alkaline phosphatase having an isoelectric point of pH 4.5 with 2.6 units per milligram (mg.) feed solution is used to demonstrate said PDMB employed for ion exchange chromatography large scale purification. This example is to determine solid phase amount 94 to saturate with predetermined volume amount feed solution 93 as zone 20 disposed in each cell 95 described in FIG. 1, wherein
1) Feed solution: 0.03 wt. % crude enzyme dissolved in cationic buffer (positive) 0.1M, pH7.4 Tris-HCl buffer solution and dissolved total protein comprising enzyme and other major impurity is albumin and all dissolved proteins carry negative charge;
2) Resin/adsorbent: DEAE-Sepharose CL-6B anion exchanger (R+) with particle 40-160 μm.

Above selected combination of mobile phase buffer solution and solid phase is based on following criteria; wherein cationic buffer matched with selected anion exchanger (R+) and counter ion for above said resin/adsorbent is Cl⁻, thus, this Cl⁻ is the index for corresponding ionic strength of this selected cationic buffer (positive) system and pCl is the mobile phase measurable parameter for this buffer system. As aforesaid step 1 in general procedures of new mass transfer equilibrium contact method is to determine the resin/adsorbent amount 94 to saturate with predetermined feed volume 93 via incremental adding said resin/adsorbent (R+) into 200 cc of said feed solution comprising negative charged total proteins homogeneous buffer solution. By doing so, resulting instant adsorption of total dissolved protein in mobile phase onto resin/adsorbent as solid phase via mixing; and by measuring each remaining total protein concentration in buffer solution after adding predetermined incremental resin/adsorbent amount, in terms of r595 relative total protein concentration in buffer solution comparing to feed solution, to determine such resin/adsorbent amount 94, wherein total protein comprise enzyme and other protein impurities reduced to zero in said mobile phase buffer solution. Note that 595 is the wave length set in spectrophotometer for total protein concentration measurement.

TABLE 2

| | Cumulated added resin | | | | | | |
|---|---|---|---|---|---|---|---|
| | 0.5 gm | 1.0 gm | 1.2 gm | 1.4 gm | 1.6 gm | 1.8 gm | 2.0 gm |
| r595 | 0.915 | 0.517 | 0.327 | 0.165 | 0.105 | 0.00 | 0.00 |

For this particular liquid/solid combination and with referring to FIG. 1, added resin/adsorbent 1.8 gram is the nominal amount to completely saturate with 200 cc of dissolved enzyme and impurities feed solution 93 and may be multiplied with 1.5 safety factor as 2.7 gram of resin/adsorbent 94 being disposed in said cell 95 to prevent possible adsorption leakage. Continuing with this example, following impending examples will illustrate said PMBD via methods of new mass transfer equilibrium contact method through single column test, differential set up between mobile and solid phase, employed onto said apparatus with operation protocols.

### Example 4

In order to obtain optimal mobile phase parameter illustrated in FIG. 8 and FIG. 9 employed onto this enzyme system, options can be using elution profile data from an high pressure liquid chromatography (HPLC) that provides less realistic circumstance for scale up purpose, or using low pressure chromatography column using same ion exchange resin/adsorbent, DEAE-Sepharose CL-6B anion exchanger (R+) with particle 40-160 μm, in above sample that is the one being selected. Again, pH7.4 Tris-HCl buffer system having Cl⁻ is the index for corresponding ionic strength of this selected cationic buffer (positive) and pCl represents the mobile phase measurable parameter corresponding to particular concentration level. With referring to FIG. 8 and FIG. 9 as enzyme is the single component to be isolated among components, following table exhibits three of critical mobile phase parameters representing in part of characteristic elution profile comprising impurity striping zone 21 for B1, product recovery zone 22 for A, and regeneration zone 23 for B2; and wherein r405 is the relative isolated enzyme concentration in buffer solution sample comparing to feed solution. As shown in Table 3 and referring to FIG. 8, after inputting 0.1 M pH7.4 or pCl equals to 1.57, feed solution in zone 20:
1) Zone 21: inputting same pH 7.4 buffer at pCl equals to 1.28 or ionic strength equals to 0.17 M means this mobile phase solution being capable to start eluting B1 impurity group and means pCl 1.28 is the lowest nominal mobile phase parameter or highest ionic strength to avoid eluting product A; next to zone 21,
2) Zone 22: inputting same pH7.4 buffer at 0.18 M or pCl equal to 1.22 will start to elute enzyme and is the lowest ionic strength to retrieve target component as zone 22, enzyme; next to zone 22,
3) Zone 23: inputting same pH7.4 buffer at 0.325 M or pCl equal to 1.03 will start to elute impurity group B2 and is the lowest ionic strength to regenerate resin/adsorbent as regeneration zone 23; means inputting various selected pH 7.4 buffer solutions can be optimized in between this 0.18 M and 0.325 M ionic strength window in order to maximize isolation of product A, enzyme.

TABLE 3

| | pCl index-pH 7.4 | Iso-ionic point-pH 7.4 | Named partial profile | Measured |
|---|---|---|---|---|
| Zone # | Tris-HCl buffer | Tris-HCl buffer conc. | in FIG. 8 & FIG. 9 | Protein Conc. |
| 21 | 1.28 | 0.17M | B1 | r595 |
| 22 | 1.22 | 0.18M | A | r405 |
| 23 | 1.03 | 0.325M | B2 | r595 |

Note that 405 is the wave length set in spectrophotometer for enzyme concentration measurement.

### Example 5

This example is proceeded as general procedures of new mass transfer equilibrium contact method, wherein only vacuum is bottom exerted without supplying inert gas from top via said cell 95 as single column 23 itself illustrated in FIG. 6; and wherein via first inputting 200 cc of 0.1 M pH 7.4 Tris-HCl feed solution to mix with sufficient amount 5 grams, nominal volume like 6 cc, of said adsorbent DEAE-Sepharose CL-6B anion exchanger (R+) indicated in example 3 to promote swift adsorption of total protein onto disposed resin/adsorbent in such column. With referring to FIG. 8, soon input feed solution being swiftly treated and drained via cell bottom exerted vacuum and collected to maintain said resin/adsorbent disposed in cell 95 in semi-dry condition and collected liquid reserved as zone 20, following then is to intermittently transmit multiple doses of selected buffer solution in said format of input S-I between liquid inputting and draining to achieve swift first impurity group B1 stripping and collected liquid reserved as zone 21, then, target component enzyme recovery product A treated and drained liquid as zone 22 and second impurity group B2 stripping treated and collected liquid as zone 23 in order to conclude obtaining acceptable elution result for differential set up and operation protocol disposed onto disclosed apparatus.

The first impurity group is eluted via said input S-I via 8 times of 25 cc of total 200 cc of 0.16 M buffer, and following target item enzyme is eluted via said input I-I in discrete format of mobile phase parameter in between two major mobile phase parameters as 4 times 25 cc of 0.27 M buffer and 6 times 25 cc of 0.29 M buffer, total 250 cc of buffer solution to simulate mobile phase gradient elution in HPLC operation to maximize eluting as much as possible for enzyme, then, inputting 8 times 25 cc of 1.0 M buffer regenerate retained adsorbent disposed in cell 95 to complete such test. Note again all transmitted multiple liquid doses being treated and collected swiftly to maintain resin/adsorbent in semi-dry status amid each spent very least of said minimal time interval, Δt. Mainly because only 5 grams, nominal volume like 6 cc, of disposed adsorbent in a cell 95 as column 23 itself to encounter with 200 cc of homogeneous feed solution is most time consuming zone 20 and yet is still a very quick draining and is in duration seconds procedure to complete expected mass transfer phenomena as illustrated in FIG. 6. Total pure enzyme recovery is 55.8% calculated by 0.446×250 cc/200 cc=55.8% as shown in following table.

TABLE 4

| | pH 7.4 Tris-HCl buffer concentration | | | |
|---|---|---|---|---|
| | 0.1M/feed, 20 | 0.16M/zone 21 | 0.27M & 0.29M/zone 22 | 1.0M/zone 23 |
| r405 | 0.016 | 0.124 | 0.446 | 0.401 |
| r595 | 0.065 | 0.095 | 0.178 | 0.400 |
| In/out volume | 200 cc | 200 cc | 250 cc | 200 cc |

### Example 6

This example is proceeded same as general procedures of new mass transfer equilibrium contact method, wherein only vacuum is bottom exerted without supplying inert gas from top via said cell 95 as single column 23 itself illustrated in FIG. 6; and wherein via first inputting 200 cc of 0.1 M pH 7.4 Tris-HCl feed solution to mix with sufficient amount 5 grams, nominal volume like 6 cc, of said adsorbent DEAE-Sepharose CL-6B anion exchanger (R+) indicated in example 3 to promote swift adsorption of total protein onto disposed resin/adsorbent in such column. With referring to FIG. 8, soon input feed solution being swiftly treated and drained via cell bottom exerted vacuum and collected to maintain said resin/adsorbent disposed in cell 95 in semi-dry condition and collected liquid reserved as zone 20, following then is to intermittently transmit multiple doses of selected buffer solution in said format of input S-I between liquid inputting and draining to achieve swift first impurity group B1 stripping and collected liquid reserved as “recovered stream 1” in zone 21, then, target component enzyme recovery product A treated and drained liquid as zone 22 and second impurity group B2 stripping treated and collected liquid as “recovered stream 2” in zone 23 in order to conclude obtaining acceptable elution result for operation protocol disposed onto disclosed apparatus. Said recovered stream 1 and recovered stream 2 are further adding water to adjust/dilute liquid solution to 0.1 M pH 7.4 for further adsorption in feeding zone 20.

The first impurity group is eluted via said input S-I via 100 cc of 0.18 M buffer and treated then collected liquid reserved as said recovery stream 1, and following target item enzyme is eluted via said input S-I in format of 8 times each 25 cc of 0.25 M buffer, total 200 cc of buffer solution to maximize eluting as much as possible for enzyme as product 1, then, inputting via said input S-I in format of 8 times 25 cc of 1.0 M buffer regenerate retained adsorbent disposed in cell 95 and treated then collected liquid reserved as said recovery stream 2. Said recovery stream 1 via adding 80 cc of water dilute/adjust to total 180 cc of 0.1 M pH 7.4 solution to inputting into cell 95 to promote adsorption and then inputting 4 times each 25 cc of 0.16 M buffer to stripping impurity B1 and then inputting 100 cc of 0.4 M strong enough ionic strength to elute enzyme as example to recover enzyme as product 2, purposely to validate 0.325 M buffer said in Table 3 for elution all adsorbed proteins. Said recovery stream 2 via adding water to dilute/adjust to 0.1 M pH 7.4 solution to inputting into cell 95 to promote adsorption and then inputting 5 times each 20 cc of 0.27 M buffer to recover enzyme as product 3 and then stripping impurity B2 via inputting 1.0 M buffer to regenerate retainer resin/adsorbent disposed in cell 95.

Note again all transmitted multiple liquid doses being treated and swiftly collected to maintain resin/adsorbent in semi-dry status amid each spent very least of said minimal time interval, Δt. Mainly because only 5 grams, nominal volume like 6 cc, of disposed adsorbent in a cell 95 as column 23 itself to encounter with 200 cc and other added streams from zone 21 and zone 23 of homogeneous feed solution is most time consuming zone 20 and again is still a very quick draining and short duration procedures to complete expected mass transfer phenomena as illustrated in FIG. 6. Total pure enzyme recovery increased from 55.8% in previous example to 63% as total of products 1, 2, and 3 as shown in following table. Impending next Example 7 will elucidates both consolidated examples 5 and 6 employed onto disclosed apparatus to carry out simultaneous and continuous proceeding of said PMBD process for single component isolation, enzyme.

TABLE 5

pH 7.4 Tris-HCl buffer concentration

| | 0.1M | 0.18M | 0.25M | 0.25M | 0.25M | 0.25M | 0.25M | 0.25M | 0.25M | 0.25M | 1.0M |
|---|---|---|---|---|---|---|---|---|---|---|---|
| r405 | 0.00 | 0.258 | 1.19 | 1.09 | 0.687 | 0.453 | 0.296 | 0.188 | 0.153 | 0.094 | 0.303 |
| r595 | 0.00 | 0.188 | 0.341 | 0.313 | 0.227 | 0.17 | 0.097 | 0.085 | 0.097 | 0.084 | 0.526 |
| Vol. | 200 cc | 100 cc | 25 cc | 25 cc | 25 cc | 25 cc | 25 cc | 25 cc | 25 cc | 25 cc | 200 cc |

| | | |
|---|---|---|
| Strm. 1 | Product 1: 52% enzyme recovery | Strm. 2 |

| Recovery Stream 1, pH 7.4 Tris-HCl buffer | | | | | Recovery Stream 2, pH 7.4 Tris-HCl buffer | | | | |
|---|---|---|---|---|---|---|---|---|---|
| | 0.1M | 0.16M | 0.4M | Product 2 | | 0.1M | 0.27M | 1.0M | Product 3 |
| r405 | 0.03 | 0.03 | 0.16 | 8% | r405 | 0.00 | 0.06 | 0.43 | 3% |
| r595 | 0.08 | 0.08 | 0.11 | enzyme | r595 | 0.00 | 0.00 | 0.841 | enzyme |
| Vol. | 180 cc | 4 × 25 cc | 100 cc | recovery | Vol. | 1400 cc | 5 × 20 cc | 100 cc | recovery |

### Example 7

This example is to illustrate both elution characteristic results in Examples 5 and Example 6 obtained via cell 95 construction shown in FIG. 6 as column 23 itself proceeded in general procedures of new mass transfer equilibrium contact method employed with differential set up between mobile phase and retained solid phase illustrated in FIG. 1 onto disposed apparatus to elucidate via single stage recycle protocol to implement for continuous and simultaneous isolation of partial purified alkaline phosphatase (enzyme) isolation from mixture of other protein impurity group B1 and B2.

This schematic drawing FIG. 16 elucidates the preferred apparatus comprising aforementioned modules A, B, C, D and E being exemplified demonstration via seven cumulated minimal time Δt. Such characteristic elution profile is divided into five sections corresponding to the feeding zone 20, first impurity B1 stripping zone 21, enzyme recovery zone 22, B2 stripping regeneration zone 23, and washing zone 24, orderly in sequence. With referring to FIG. 8 and as indicated on upper portion of this drawing, such liquid input formats are isocratic elution 85 input S-I for feeding 0.1 M buffer duration of one Δt, B1 impurity stripping 0.16 M buffer duration of two Δt, B2 impurity stripping 1.0 M buffer duration of one Δt, and washing zone 0.1 M buffer duration of one Δt; whereas enzyme recovery zone is discrete isocratic elution 85 input I-I in multiple liquid doses and mobile phase condition in said discrete format in predetermined slope in between 0.27 M and 0.29 M each in duration of one Δt to maximize enzyme recovery. Note that liquid delivering module of either input S-I or input I-I employed via said apparatus, such preset intermediate mobile phase's condition is separately delivered via its preset routing in a closed loop in such partial volume for the corresponding cell that being collected and then transmitted into underneath into selected holding tank 44 disposed in said downstream holding tanks module E.

As shown, each stored liquid in assigned holding tank 15 in upstream holding tanks module A and its output distribution route thereafter; wherein various recycle solution collected in respective holding tank 44 disposed in downstream holding tank module E simultaneously transferring predetermined volume amount of various type of solution via each liquid line 47 into respective holding tank 15 and then via each line 18 into respective temporary holding reservoir 21 disposed in said upstream rotary union module B, further via each line 61 into top portion of each cell 95 disposed in said separation module C and via top supplying pressurized inert gas and bottom exerted vacuum environment to drain and collect treated liquid in each underneath temporary holding tank 33; and then transmitting via each line 59 via reservoir 38 disposed in said downstream rotary module D and finally via each line 60 back to respective holding tank 44 in said downstream holding tanks module E. This simultaneous mobile phase closed loop transmitting routings has been thoroughly illustrated in FIG. 2 through FIG. 5. This drawing outlines such complete separation cycle, which is based on each spent of single minimal time interval Δt, and amid each spent of time interval orderly cumulated in sequence to complete proceeding such result illustrated in previous examples.

This drawing further illustrates said single stage recycle protocol for elevating the concentration level of isolated enzyme in 0.27 M and 0.29 M buffer solution disposed in each holding tank 44 via its predetermined recycle route of liquid distribution loop back to said holding tank 15 disposed in zone 22 to minimize consumption of respective buffer solution until satisfied enzyme concentration level is obtained. As illustrated in Example 6, 0.16 M and 1.0 M buffer solution collected in respective holding tank 44 can be recycled back via predetermined recycle route of liquid distribution loop to zone 21 and zone 23 respectively to elevate concentration level of eluted proteins. Alternatively, by adding water to dilute/adjust each retained buffer concentration to 0.1 M back to adsorption zone 20 to maximize recovery stream 1 and stream 2 of enzyme until satisfactory result are obtained, or discarded if running condition of such parameter 0.16 M or 1.0 M buffer is getting weak. Liquid 0.1 M buffer collected in tank 44 in zone 20 transferred via predetermined recycle route of liquid distribution loop through washing zone 24, treated then collected 0.1 M buffer solution in tank 44 can be blended with fresh protein mixture for feeding zone 20 to save 0.1 M buffer. Such preference process design are observed and derived for single stage recycle protocol and disclosed apparatus provides such flexibility to avoid tedious procedures in chromatography to carry out a separation cycle during each spent of minimal time interval, Δt.

For sake of large scale separation of this exemplified enzyme system to carry out said general procedures of new mass transfer equilibrium contact method starting from a start-up state operation means for generating fresh semi-dry status resin/adsorbent installed in said separation module C as fresh status in order to reach initial equilibrium status throughout disclosed apparatus via each incoming buffer solution, wherein start-up operation comprise following; wherein:
1. through means of aforesaid various liquid delivery route illustrated in FIG. 2 through FIG. 5, a predetermined volume amount of various buffer solution from respective holding tanks 15 starting internally from feeding zone 20, then, expand simultaneous liquid input covering next zone in sequence among zones 21, 22, 23, and lastly zone 24 via means of pipelines 18 into transit reservoir 21 disposed in said upstream rotary union module B; advance one rotation step through means of rotation and positioning together with seal mechanism in predetermined rotating direction, then via of pipelines 61 as indicated into each underneath cell's top-inlet for carrying out following mass transfer equilibrium contact process;
2. intermittently deliver through means of alternated supplying of pressurized inert gas between pipe 30 and pipe 9 following delivery of various buffer solution in dose of predetermined volume amount to force draining of dropped liquid promptly sipping through said resin/adsorbent to complete expected mass transfer equilibrium contact between two phases;
3. maintain a vacuum 31 to continuous drain the individual liquid solution into respective underneath temporary reservoir 33 and to maintain resin/adsorbent in a semi-dry status;
4. intermittently collect of all kind of treated and drained liquids in each temporary reservoir 33; transmitting by means of pipelines 59 into transit reservoir 38; advance one rotation step through means of rotation and positioning together with seal mechanism in predetermined rotating direction, then, through 60 shown in FIG. 2 through FIG. 5 into each assigned holding tanks 44 in downstream holding tanks module E, transmitting predetermined volume amount out of holding tank 44 via means of pipelines 47 to assigned holding tank 15 in upstream holding tanks module A;
5. Repeating repeatedly step 1 through step 4 initially for zone 20, then “zone 21 together with zone 22” until transit reservoir 21 disposed in upstream rotary union module and transit reservoir 38 disposed in downstream rotary union module return to each initial position to complete one revolution, so that, start-up operation can be concluded, wherein retrieved all kinds of liquids during start-up operation as recycle streams collected in zone 20 for zone 24 recycle, and zone 21, zone 22, and zone 23 from each assigned holding tank 44 in downstream holding tanks module E via means of pipelines 47 to each corresponding holding tank 15 in upstream holding tanks module A.

Soon, start-up operation is concluded, thereafter disclosed apparatus can shift into steady state continuous operation. Through all kind of liquids set for above illustrated preference of either recycling back to same zone for concentration elevation of eluted stream or adding water to adjust to 0.1 M buffer to joint feeding zone 20 or discarded such 0.16 M or 1.0 M buffer solution, within predetermined time spent for each zone, such plurality of transit reservoirs 21 simultaneously receive entire available predetermined amount of various kinds of buffer solution delivery and simultaneously transmitted into respective cell proceeding said new mass transfer equilibrium contact method illustrated in separation module C to obtain each treated solution mixtures from respective cell bottom. The same procedures repeat repeatedly as following steady state operation; wherein:
1. through means of aforesaid various liquid delivery route illustrated in FIG. 2 through FIG. 5, a predetermined volume amount of various buffer solution from respective holding tanks 15 of zone 20, 21, 22, 23 and 24 are simultaneously transmitting entire available liquid volume via means of pipelines 18 into transit reservoir 21; advance one rotation step through means of rotation and positioning together with seal mechanism in predetermined rotating direction, then via of pipelines 61 as indicated into each underneath cell's top-inlet for carrying out following mass transfer equilibrium contact process;
2. intermittently deliver through means of alternated supplying of pressurized inert gas between pipe 30 and pipe 9 following delivery of various liquids in dose of predetermined volume amount to force draining of dropped liquid promptly sipping through said resin/adsorbent to complete expected mass transfer equilibrium contact between two phases;
3. maintain a vacuum 31 to continuous drain the individual liquid solution into respective underneath temporary reservoir 33 and to maintain resin/adsorbent in a semi-dry status;
4. intermittently collect of all kind of treated and drained liquids in each temporary reservoir 33 and simultaneously transmitting by means of pipelines 59 into transit reservoir 38; advance one rotation step through means of rotation and positioning together with seal mechanism in predetermined rotating direction, then, through 60 shown in FIG. 2 into each assigned holding tanks 44 disposed in downstream holding tanks module E;
5. as illustrated in FIG. 2, transmitting all kind of buffer solution for recycling from each assigned holding tank 44 in downstream holding tanks module E via means of pipelines 47 to each corresponding holding tank 15 in upstream holding tanks module A; wherein all kind of liquids retrieved as liquid streams collected in zone 20 for zone 24, and zone 21, zone 22, and zone 23 from each assigned holding tank 44 back to same zone in each holding tank 15 disposed in upstream holding tanks module A; except under aforesaid certain criterion that solution being collected in zone 22 retained as concentrated enzyme product, and 0.16 M and/or 1.0 M buffer solution being discarded in zone 21 and/or in zone 23.

Through implementation of single column test result via said new mass transfer equilibrium contact method together with said differential set-up between two phases onto disclosed apparatus operation procedures being covered from step 1 through step 5 is to accomplish a complete separation cycle during each spent of said minimal time interval, Δt. Again, via simultaneous transmitting of various liquid into respective zone during steady state operation in this disclosed apparatus, by which it transforms the traditional chromatographic separation path from parallel into vertical with mobile phase's flow direction. At any instance of steady state operation, a complete separation cycle is accomplished after every spent of minimal time interval to achieve major object of said Parametric Differential Moving Bed (PDMB) briefly illustrated in FIG. 1 of this disclosure.

### Example 8

This schematic drawing FIG. 17 is to demonstrate said Parametric Differential Moving bed (PDMB) operated in batch mode to achieve expected separation proceeded through each of plurality mobile phase with particular parameter characteristic liquid solution being transmitted in sequential order into cell 95 in contact with installed resin/adsorbent via illustrating of single component isolated from mixtures of components. Depending upon target separation system, batch mode herein being illustrated and be employed to carry out is for any typical adsorption and desorption mass transfer mechanism. Yet, other mass transfer mechanism such as aforesaid glucose and fructose separation illustrated in FIG. 12 through FIG. 14 that is slow mass transfer mechanism and each cell contains plurality of columns disposed within and single column is initially used to generate such characteristic profile in batch mode and converted with disclosed apparatus. Again, this Example 8 is exemplified to focus on fast and instant mass transfer mechanism that new mass transfer is instant despite of tedious sequential procedures like chromatographic operation. That saying, batch mode hereinafter been illustrated is via general procedures of new mass transfer equilibrium contact method to explore option using single cell as column itself to carry out sequential procedures like chromatography to obtain acceptable separation results via aforesaid new mass transfer equilibrium contact method, differential set up, single stage operation protocols, and employed onto disclosed apparatus, so that accumulated of total minimal time interval, Δt, is a complete separation cycle that can be accomplished in shortest possible time duration. As an example for elucidating this batch mode, FIG. 17 uses both elution characteristic results obtained in Examples 5 and Example 6 obtained by single cell 95 as column 23 itself construction shown in FIG. 6 proceeded in general procedures of new mass transfer equilibrium contact method and employed onto disposed apparatus to elucidate for such batch separation of partial purified alkaline phosphatase (enzyme) isolates from mixture of other protein impurity group B1 and B2.

With referring to FIG. 8 and FIG. 16 and as indicated on upper portion of this FIG. 17, such characteristic elution profile shown in Example 5 and Example 6 is same divided into five sections corresponding to the feeding zone 20, first impurity B1 stripping zone 21, enzyme recovery zone 22, B2 stripping regeneration zone 23, and washing zone 24, orderly carry out in sequence, through selected liquid input formats are as isocratic elution 85 input S-I for feeding 0.1 M buffer duration of one Δt, B1 impurity stripping 0.16 M buffer duration of two Δt, B2 impurity stripping 1.0 M buffer duration of one Δt, and washing zone 0.1 M buffer duration of one Δt; whereas enzyme recovery zone is discrete isocratic elution 85 input I-I in multiple liquid doses and mobile phase condition in said discrete format in predetermined slope in between 0.27 M and 0.29 M each in duration of one Δt to maximize enzyme recovery. Note that liquid delivering module of either input S-I or input I-I employed via said apparatus, such preset intermediate mobile phase's condition is separately delivered in sequence starting from zone 20 through zone 24 via its preset routing in a closed loop in such partial volume for the single cell 95 as column 23 that treated liquid being collected and then transmitted into selected holding tank 44 disposed in said downstream holding tanks module E.

On the contrary with Example 7, this schematic drawing FIG. 17 elucidates said apparatus illustrated in FIG. 2 comprising aforementioned upstream holding tanks module A, separation module C and downstream holding tanks module E, omitting said rotation and positioning together with seal mechanism of upstream rotary union module B and downstream rotary union module D, wherein said apparatus with following modification in cooperation with means of general procedures in said inert gas supply module illustrated in FIG. 3 that is sub-module integrated with said separation module C for mobile phase liquid streams transmitting mechanism, wherein comprising:
1) Upstream holding tanks module A, wherein containing a plurality of named holding tanks 15 corresponding to aforementioned particular zone orderly disposed inside a heat media circulation insulated jacket 11, each holding tank having an extended upward liquid conduct 16 outside of jacket 11 to receive liquid via each liquid line 47 including feed solution from its source, said conduct 16 equipped with flipper 1 disposed around bottom portion of conduct 16 that has gas pipe 7 disposed next to such conduct 16; each holding tank having an extended downward liquid conduct 17 outside of jacket 11 equipped with a preferred pressure activated check valve 189 to hold liquid within that is transmitted through opened flipper 1 amid stop supplying low pressure inert gas, then held liquid is released amid supplying low pressure inert gas through pipe 7 to close the flipper 1 to push transmitting through valve 189 and conduct 17 to following separation module C;
2) Separation module C, wherein single cell 95 as column 23 itself containing flipper 3 and flipper 4 disposed in top and bottom portion of liquid conduct 28, wherein amid stop supplying high pressure inert gas through pipe 9 and supplying another high pressure inert gas through pipe 30 to allow liquid transmitted from above holding tank 15 via liquid conduct 17 into temporary transit reservoir 28, such cell 95 being confined inside heat media circulation jacket 36 to maintain in predetermined temperature range. Such cell 95 as column 23 having top opening 24 to receive liquid and with bottom meshed filter 25 to hold particulate resin/adsorbent from being drained. Via alternative open and close between flipper 3 and flipper 4, wherein pipe 9 of top supplying of pressurized inert gas means to close said flipper 3 in a short time duration and through opened flipper 4 to transmit predetermined at least one drop dose in parts of delivered liquid out of reservoir 28, then stop transmitting such stored liquid amid another time period duration of supplying another inert gas via pipe 30 means to close flipper 4 to affiliate prompt liquid sipping through resin/adsorbent particulate to accomplish expected mass transfer equilibrium contact. Underneath said flipper 4 connected with a less than 180 degree baffle 163 to conduct the predetermined volume amount of transmitted fluid dose amid said short period time duration to splash over like a downward umbrella shape. Such splashed fluid hitting inner container wall, and swiftly sliding downward to partially up-lift and penetrate to stirring upward contained resin/adsorbent grains of resin/adsorbent suspended in liquid. This instantaneous partial mixing effect is for quick contact and dramatic reduction of required time for fast and instant adsorption and desorption of mass transfer mechanism between mobile and solid phase carried out by new mass transfer equilibrium contact method. To avoid reiterating such vacuum exerted via inert gas supply module to exit wet inert gas to vacuum that is illustrated in FIG. 3. Bottom portion of said cell 95 as column 23 itself is exposed to said vacuum environment 31 to maintain disposed resin/adsorbent in a semi-dry status and to affiliate liquid draining via funneled shape liquid conduct 32 through opened flipper 65, resulting from bottom exerted vacuum, into underneath temporary liquid reservoir 33, and such drained liquid being held by bottom installed preferred pressure activated check valve 190 means for holding collected liquids from various zones redistributed for further applications. Bottom of liquid reservoir 33 has a liquid conduct 34 and bottom installed valve 190 are extended outward said insulated jacket 36. There has manifold 49 means for supplying low range pressurized inert gas amid vacuum 31 being shut off to push transmitting liquid through opened valve 190 through conduct 34 into assigned holding tank disposed in downstream holding tanks module E;
3) Downstream Holding Tanks Module E, wherein containing a plurality of named holding tanks 44 corresponding to aforementioned particular zone orderly disposed inside a heat media circulation insulated jacket 41 to maintain predetermined temperature range, each holding tank having an extended upward liquid conduct 45 outside of jacket 41 to receive liquid transmitted from temporary reservoir 33 disposed in lower portion of said separation module C, and there has a preferred liquid level sensor 63 installed inside each holding tank 44 to monitor predetermined liquid level of stored liquid within, means such level sensor 63 is to control delivering sufficient volume of particular liquid solution via liquid conduct 64 disposed next to conduct 45 to maintaining a predetermined liquid level setting in respective holding tank 44; each named holding tank having an extended downward liquid conduct 46 outside of jacket 41 means for discharging particular held liquid distribution via liquid line 47 into respective holding tank disposed in above said upstream holding tanks module A.

As shown in upper right portion of FIG. 17, each stored liquid in assigned holding tank 15 in upstream holding tanks A and its output distribution route thereafter through general liquid distribution procedures for Parametric Differential Moving bed (PDMB) operated in batch mode; wherein
1. transmitting in sequential order via respective volumetric pump, not shown to simplify drawing, a predetermined volume amount of various type of liquid solution via each liquid line 47 including feed solution from its source and various kind of particular liquid solution during a time interval from respective hold liquid disposed in respective named holding tank 44 disposed in downstream holding tanks module E,
2. into respective holding tank 15 through liquid conduct 16 via opened said flipper 1 while low pressure inert gas via pipe 7 being shut off, meanwhile received liquid being held within via each bottom installed preferred pressure activated check valve 189, and then by means of opposite operation to turn on gas supply via pipe 7 to shut off said flipper 1 to push transmitting held liquid in respective holding tank 15 through valve 189 and liquid conduct 17 into,
3. temporary transit reservoir 28 disposed in upper portion of said separation module C via alternative open and close between flipper 3 and flipper 4,
   wherein pipe 9 of top supplying of pressurized inert gas means to close said flipper 3 in a short time duration and through opened flipper 4 to transmit predetermined at least one drop dose in parts of delivered liquid out of reservoir 28, then
   stop transmitting such stored liquid amid another time period duration of supplying another inert gas via pipe 30 means to close flipper 4 to affiliate prompt liquid sipping through resin/adsorbent particulate to accomplish expected mass transfer equilibrium contact, so that such batch separation being carried out via said new mass transfer equilibrium contact method in intermittent sequential liquid solution transmitting in contact with disposed resin/adsorbent in single cell 95 for enzyme isolation as following.

Via aforesaid step 1 through step 3 of general liquid distribution procedures for batch mode in this example, wherein
a. first to transmit through liquid line 175 of feed solution held in feed tank 15 out of said zone 20 via said step 1 through step 3 of predetermined at least one drop dose of liquid solution in input S-I mode of 0.1 M buffer in duration of total one Δt minimal time to complete liquid input in order to carry out mass transfer equilibrium contact to promote adsorption of components in feed solution onto disposed particulate resin/adsorbent material, meanwhile during same duration of time period exerting bottom vacuum environment 31 to drain and collect treated liquid in underneath temporary holding tank 33 to hold liquid within and maintain disposed resin/adsorbent material in semi-dry status; then transmitting collected buffer liquid via valve 190 and liquid conduct 34 through line 182 to named holding tank 44 disposed in said downstream holding tanks module E for further transmitting to washing zone 24 disposed in upstream holding tanks module A;
b. following after feed solution input is to transmit through liquid line 176 and then liquid 177 after done with line 176 in sequential order, each liquid line transmitting from 0.16 M buffer solution tank 15 out of said B1-impurity stripping zone 21 via said step 1 through step 3 of predetermined at least one drop dose of liquid solution in input S-I mode of 0.16 M buffer in duration of each one in sequence and total as two Δt minimal time to complete liquid input in order to carry out mass transfer equilibrium contact to promote maximum desorption of B1 impurity eluting from disposed particulate resin/adsorbent material, meanwhile during same duration of time period exerting bottom vacuum environment 31 to drain and collect treated liquid in underneath temporary holding tank 33 to hold liquid within and maintain disposed resin/adsorbent material in semi-dry status; then transmitting in sequence of collected buffer liquid via valve 190 and liquid conduct 34 through liquid line 183, and then following through liquid line 184 after done with liquid line 183 to named holding tank 44 disposed in said downstream holding tanks module E for further either recycling back through liquid line 47 to impurity stripping zone 21 disposed in upstream holding tanks module A for elevating concentration level of B1 impurity proteins; alternatively, by adding water to dilute/adjust each retained buffer concentration to 0.1 M back to feeding zone 20 to maximize recovery enzyme stream 1 shown in Table 5 of Example 6 until satisfactory result are obtained, or discarded if running condition of such parameter 0.16 M buffer is getting weak;
c. following after B1 elution solution input is to transmit through liquid line 178 from 0.27 M buffer solution tank 15 out of said enzyme recovery zone 22 via said step 1 through step 3 of predetermined at least one drop dose of liquid solution in input I-I mode of 0.27 M buffer in duration of one Δt minimal time to complete liquid input in order to carry out mass transfer equilibrium contact to promote maximum desorption of enzyme eluting from disposed particulate resin/adsorbent material, meanwhile during same duration of time period exerting bottom vacuum environment 31 to drain and collect treated liquid in underneath temporary holding tank 33 to hold liquid within and maintain disposed resin/adsorbent material in semi-dry status; then transmitting of collected buffer liquid via valve 190 and liquid conduct 34 through liquid line 185 into named holding tank 44 disposed in said downstream holding tanks module E for further either recycling back through liquid line 47 to enzyme recovery zone 0.27 M buffer solution holding tank 15 disposed in upstream holding tanks module A for elevating concentration level of isolated enzyme and to minimize consumption of respective buffer solution until satisfied enzyme concentration level is obtained;
d. following after enzyme elution solution 0.27 M buffer input is to transmit through liquid line 179 from 0.29 M buffer solution tank 15 out of said enzyme recovery zone 22 via said step 1 through step 3 of predetermined at least one drop dose of liquid solution in input I-I mode of 0.29 M buffer in duration of one Δt minimal time to complete liquid input in order to carry out mass transfer equilibrium contact to promote maximum desorption of enzyme eluting from disposed particulate resin/adsorbent material, meanwhile during same duration of time period exerting bottom vacuum environment 31 to drain and collect treated liquid in underneath temporary holding tank 33 to hold liquid within and maintain disposed resin/adsorbent material in semi-dry status; then transmitting of collected buffer liquid via valve 190 and liquid conduct 34 through liquid line 186 into named holding tank 44 disposed in said downstream holding tanks module E for further either recycling back through liquid line 47 to enzyme recovery zone 0.29 M buffer solution holding tank 15 disposed in upstream holding tanks module A for elevating concentration level of isolated enzyme and to minimize consumption of buffer solution until satisfied enzyme concentration level is obtained;
e. following after enzyme elution solution 0.29 M buffer input is to transmit through liquid line 180 from 1.0 M buffer solution tank 15 out of said B2-Regeneration zone 23 via said step 1 through step 3 of predetermined at least one drop dose of liquid solution in input S-I mode of 1.0 M buffer in duration of one Δt minimal time to complete liquid input in order to carry out mass transfer equilibrium contact to promote maximum desorption of B2 impurity eluting from disposed particulate resin/adsorbent material, meanwhile during same duration of time period exerting bottom vacuum environment 31 to drain and collect treated liquid in underneath temporary holding tank 33 to hold liquid within and maintain disposed resin/adsorbent material in semi-dry status; then transmitting of collected buffer liquid via valve 190 and liquid conduct 34 through liquid line 187 into named holding tank 44 disposed in said downstream holding tanks module E for further either recycling back through liquid line 47 to B2 regeneration zone 1.0 M buffer solution holding tank 15 disposed in upstream holding tanks module A for elevating concentration level of B2 impurity; alternatively, by adding water to dilute/adjust each retained buffer concentration to 0.1 M back to feeding zone 20 to maximize recovery enzyme stream 2 shown in Table 5 until satisfactory result are obtained, or discarded if running condition of such parameter 1.0 M buffer is getting weak;
f. following after B2 impurity elution solution 1.0 M buffer input is to transmit through liquid line 181 from 0.1 M buffer solution tank 15 out of said washing zone 24 via said step 1 through step 3 of predetermined at least one drop dose of liquid solution in input S-I mode of 0.1 M buffer in duration of one Δt minimal time to complete liquid input in order to carry out washing off disposed particulate resin/adsorbent material, meanwhile during same duration of time period exerting bottom vacuum environment 31 to drain and collect treated liquid in underneath temporary holding tank 33 to hold liquid within and maintain disposed resin/adsorbent material back to original semi-dry status; then transmitting of collected buffer liquid via valve 191 and liquid conduct 34 through liquid line 188 into named holding tank 44 disposed in said downstream holding tanks module E for further recycling back through liquid line 47 to blend with fresh protein mixture to save for 0.1 M buffer consumption for feed solution delivered into holding tank 15 disposed in upstream holding tanks module A for feeding zone 20 liquid input to start new batch mode enzyme isolation cycle.

So that, this example using enzyme isolation illustrated through batch mode accomplishes through transmitting all kind of buffer solution for recycling from each assigned holding tank 44 disposed in downstream holding tanks module E via means of pipelines 47 to each corresponding holding tank 15 in upstream holding tanks module A; wherein all kind of liquids retrieved as liquid streams collected in zone 20 recycled for zone 24, and for zone 21, zone 22, and zone 23 respectively from each assigned holding tank 44 back to same zone in each holding tank 15 disposed in upstream holding tanks module A; except under aforesaid certain criterion that solution being collected in zone 22 retained as concentrated enzyme product, and 0.16 M and/or 1.0 M buffer solution being discarded in zone 21 and/or in zone 23.

Through implementation of single column test result illustrated in Table 5 of example 6 and via said new mass transfer equilibrium contact method together with differential set-up between two phases onto modified disclosed apparatus operation procedures being covered from step 1 through step 3 of general liquid distribution procedures for batch mode is to accomplish a complete separation cycle during sum of each sequential spent of said minimal time interval, Δt. Via above said step (a) through step (f) of this example elucidates batch mode can be more suitable for fast and instant adsorption and desorption mass transfer mechanism that fluid dynamic drawbacks observed and illustrated in FIG. 15 of Example 2 is irrelevant with process design, such mechanism is solely depending upon iso-point equilibrium state, at which each adsorbed component has its unique equilibrium parameter between selected mobile and solid phase, so that, adsorbed component cannot be eluted unless surrounding mobile phase triggered to or behind such iso-point to allow such component eluted back to mobile phase to flow with. Again, via transmitting of various liquid into respective zone during batch mode operation employed with modified disclosed apparatus, by which it also eliminates the displacement zone in traditional chromatography and maximizes installed resin/adsorbent in cell 95 as column 23 to its full bonding capacity for predetermined feed throughput; yet proceed mas transfer equilibrium in minimal possible time duration and maintaining all kind of mobile phase traveling in same direction as solid phase disposed in traditional chromatography operation.

### Example 9

This example is extended to illustrate elution characteristic result with an affinity resin/adsorbent that has specific adsorption for target protein and not specific for other impurities. Feed solution comprises binary protein mixture of Concanavalin (Con A) as target component and Hemoglobin (Hm) as impurity.
a) Feed solution: 0.03 wt. % of Con A and 0.01 wt. % of Hm in pH 7.4 0.05 M Sodium Phosphate buffer solution;
b) Resin/adsorbent: Sephadex G-150 with dried particle size 40-160 μm.
c) Eluent solution: 0.15 M D-glucose in 0.05 M pH 7.4 Phosphate buffer.
   Feed solution 200 cc was first mixed with resin/adsorbent resulting separation between Con A being adsorbed onto resin/adsorbent and Hm being stayed in treated and drained feed solution via vacuum and such solution being kept as product 1. Then, retained resin/adsorbent with adsorbed Con A in contact 100 cc of said eluent solution to regenerate resin/adsorbent to desorb Con A back to mobile phase solution as product 2, subsequently with same 100 cc of eluent solution and drained solution as product 3, and resin/adsorbent further treated with same 100 cc of eluent solution as drained product 4. There has separated Hm in solution of product 1 with 92.4% recovery and eluted Con A in products 2, 3, and 4 with recovery of 84.2%. The separation factor obtained between two protein components is 45 as compared with initial ratio of one. Purity of Con A is 98% and results are tabulated in following Table 6.

TABLE 6

| | Feed, protein wt. % | Con A only | Buffer only | Prod. 1 | Prod.2 | Prod.3 | Prod.4 |
|---|---|---|---|---|---|---|---|
| | 0.03 wt. % Con A + 0.01% wt. Hm | 0.03 wt % | 0.00% | Hm | Con A | Con A | Con A |
| r403 | 0.556 | 0.010 | 0.00 | 0.451 | 0.125 | 0.010 | 0.006 |
| r595 | 0.642 | 0.486 | 0.4035 | 0.542 | 0.428 | 0.469 | 0.4115 |
| Vol. | 200 cc | | | 196 cc | 100 cc | 100 cc | 100 cc |

| | | |
|---|---|---|
| Recovery | 92.4% | 84.2% |

Note that 403 is the wave length set in spectrophotometer for Con A concentration measurement; 595 is the wave length for total protein concentration measurement.

As being taught from single component enzyme isolation from multiple components feed solution and binary glucose and fructose separation, again, for specific throughput requirement in large scale purification design, such resin/adsorbent amount 94 can be proportionally increased and because this enzyme mass transfer phenomena is a very swift ion exchange process and each spent of said minimal time interval, Δt, is quite small in seconds during two phase contact. This type of mass transfer phenomena is thoroughly illustrated in FIG. 6 and FIG. 7 that cell 95 is column 23 itself to suit for this particular system. Other instant on/off adsorption mass transfer mechanism like aforesaid two exemplified protein systems, affinity chromatography is quite adopted in pharmaceutical purification like antibody, antigen or enzyme that target system is particularly designed for dissolved protein having specific adsorption site being capable of swift interacting of adsorption and elution between combination of feed solution and resin/adsorbent solid phase. Those systems can be evaluated and studied for employing disclosed hybrid PDMB process for mass separation purpose to carry out a complete separation cycle amid each spent of minimal time interval, Δt.

### Example 10

For sake of process design for industrial scale separation usually need to consider handling massive operation capacity throughput including feed solution and other various kind of liquid stream transmitting within said apparatus to operate as whole device. In order to elevate weight load upon moving components disposed in said upstream rotary union module B and downstream rotary union module D may consider breaking down or dividing said modules illustrated in FIG. 2 into equal portions in parts as whole imposed unit upon single rotary union module, so that there has more surface area can be available for sub-module in said horizontal circular plate 102 in FIG. 4 and said horizontal circular plate 134 to install proportionally increased in size for said transit reservoir 21 in module B and transit reservoir 38 in module D. Moreover, other selected shape of said horizontal plate and yet not limited to circular plate impending illustration in this FIG. 18 related to aforesaid FIG. 4 and FIG. 5, such as installing square shaped column to maximize temporary liquid holding capacity along circular rotating step. FIG. 18 exemplifies such as installing six of transit reservoirs in ¼ of total twenty-four count illustrated in FIG. 4 and FIG. 5 disposed in a sub-rotary module and integration four of such sub-module functions as one module containing sum of twenty-four transit reservoirs. Accordingly, each of sub-module disposed in upstream and downstream rotary union module providing predetermined liquid streams for corresponding equal portion of following separation module C and downstream holding tanks module E liquid distribution within apparatus thereinafter.

Again, glucose and fructose binary purification system is explicated as real system onto disclosed apparatus in connection with methods illustrated in FIG. 12 through FIG. 14 for such demonstration via this FIG. 18 comprising similar arrangement and to avoid reiterate details; briefly illustrate said apparatus contain following modules, wherein
a) upstream holding tanks module A contains a plurality of holding tank 15 orderly arranged in sequential format exemplified as twenty-four units; installed in a water circulating jacket 11 having a manifold inlet 13 and manifold outlet 14 for water circulation to maintain in predetermined temperature range, each tank holding particular received liquid including feed solution and eluent water from its source, and via respective liquid line 47 from corresponding holding tank 44 sequentially disposed in downstream holding tanks module E orderly named as zone 0, 1, 3, 4, 5, 6, 7, feed, 8, 9, 10, 11, 12, 13, 14, 16, 17, 18, 19, eluent water, and water that is collected and recycled from bottom portion of separation module C; followed with inert gas after water input to flush liquid residue to maximize fructose recovery as zone 19 recycled liquid, note that drawing shown as z 0 through z 19 to save drawing space;
b) upstream rotary union module B comprising sub-module 191, 192, 193, and 194 that each sub-module rotates in a predetermined direction 20 and indexed with sixty degree as one rotation step to complete six steps per revolution; each sub-module has six paired “circular shaped column” reservoirs disposed along circular path as an example and again not limited to other aforesaid design preference, to receive liquid from corresponding liquid transferred from predetermined holding tank via liquid line 18 disposed in upstream holding tanks module A and transmitted via liquid line 61 into top portion of following separation module C for each of six cells aligned corresponding to a particular sub-cell and sum of four sub-modules having twenty-four components matched with each holding tank 15 disposed in above module A,
c) separation module C with a plurality of cells comprising a plurality of columns with top opening and bottom meshed filter installed in each cell; all cells being named from left side drawing as cell 1, 2, . . . through cell 24, not shown sequential name to simplify drawing, and arranged to align with corresponding sub-module disposed in said upstream rotary union module B and following downstream rotary union module D in an orderly sequential format disposed in an preferred insulated water circulation jacket 36; such jacket having plurality of baffle plates vertically installed to confine each cell inside a predetermined compartment, such plate alternatively arranged as indicated to allow water freely enter from one inlet and exit next outlet into next compartment; so that warm water entered via liquid conduct 26, freely circulating through first cell in each module, then continue entering 2^{nd} cell, 3^{rd} cell until water stream pass through all confined cell compartments, then exit said jacket 36 via liquid conduct 27 as indicated to maintain all installed cells in an predetermined temperature range of separation module C;

Aforesaid integrated inert gas supply module F integrated with separation module C being operated in an closed loop exerted onto entire bottom portion of separation module C, such vacuum environment being evenly exerted via a central vacuum pump 51 through at least one gas pipe 48 connected to bottom portion of separation module C to affiliate liquid draining and to extract water moisture enriched wet inert gas; first through mist separator 50 to convert wet to dry inert gas and meanwhile to collect water liquid in reservoir 52 for recycle; such vacuum evenly exerted around each cell bottom means to maintaining said resin/adsorbent in a semi-dry status to meet criterion of new mass transfer equilibrium contact method; means to create a heterogeneous contact as liquid promptly sipping through stationary resin/adsorbent particles to reach mass transfer equilibrium contact. Such dry inert gas exiting mist separator 50 is combined with pressurized dry air and deployed through an inert gas generator 54 to obtain fresh dry inert gas and to store in a steel tank vessel 55 maintaining at preferred broad range of pressure level ready for deploying back to said top portion of separation module C via inline gas temperature adjuster 56 through gas line 199 connected to manifold 200 disposed above each cell top portion of separation module to promptly force out dropped dose of all kind of liquid to carry out mass transfer equilibrium contact through solid phase resin/adsorbent material and gathering collected liquid in each bottom cell liquid reservoir as preferred operation,
d) downstream rotary union module D comprising sub-module 195, 196, 197, 198 that each module rotates in a predetermined direction 20 and indexed sixty degree as one rotation step to complete six steps per revolution; each sub-module has six paired “circular shaped column” reservoirs disposed along circular path as an example and again not limited to other aforesaid design preference to receive liquid via respective liquid line 59 from corresponding lower portion of separation module C and transmitted via respective liquid line 60 into corresponding assigned holding tank 44 disposed in downstream holding tanks module E,
e) downstream holding tanks module E contain a plurality of holding tank 44 arranged in said endless format inside said insulated warm water circulation jacket 41 having a manifold inlet 42 and manifold outlet 43 for water circulation to maintain whole plurality of holding tanks in a selected temperature range; each tank holding particular recycled liquid via respective liquid line 47 from corresponding holding tank 44 disposed in module E that orderly named in sequential order as water that is collected from bottom portion of separation module C, zone 0, 1, 3, 4, 5, 6, 7, 8, 9, 10, 11, 12, 13, 14, 16, 17, 18, 19, orderly transferred into each assigned holding tank 15 disposed in above module A, except water with low D.S.-glucose solution, solution collected from zone 2 as glucose Raffinate and solution from zone 15 as fructose product.

To avoid reiterate methods illustrated in FIG. 12 through FIG. 14, this FIG. 18 mainly focus on said general procedures of new mass transfer equilibrium contact method starting from carrying out a start-up state operation then followed with steady-state operation means for generating fresh semi-dry status resin/adsorbent installed in separation module C as fresh status in order to reach initial equilibrium status throughout disclosed apparatus via each incoming sugar mixture, wherein start-up and steady state operation comprise following:
1. Via aforesaid respect liquid pipeline 47 out of downstream holding tanks E transmitting all kind of named recycle mixtures in predetermined volume amount as zone 0, 1, 3, 4, 5, 6, 7, 8, 9, 10, 11, 12, 13, 14, 16, 17, 18, 19, recycled water followed with pressurized inert gas to flush liquid residue to maximize fructose recovery, and including feed solution and eluent water from its source to corresponding assigned holding tank 15 disposed in upstream holding tanks module A;
2. through means of aforesaid various liquid delivery route illustrated in FIG. 2 through FIG. 5, a predetermined volume amount of various liquids from respective holding tanks 15, similar to protocol illustrated in FIG. 14, starting internally from zone 0, then, expand simultaneous liquid input covering next zone in sequence among zones, wherein
   1) zone 0, 1, 3, 4, 5, 6 been grouped corresponding with sub-module 191, then, expanded simultaneous liquid input covering next zone in sequence among zone 0, 1, 3, 4, 5, 6 been covered with liquid input via means of liquid pipelines 18 into transit reservoir 21 disposed in said upstream rotary union sub-module 191; advance one rotation step through means of rotation and positioning together with seal mechanism in predetermined rotating direction, then via of pipelines 61 as indicated into each assigned top-inlet of cell 1 through cell 6, covering corresponding range of liquid input, for carrying out following mass transfer equilibrium contact process, then,
   2) within predetermined time spent for each zone, intermittently deliver through means of alternated supplying of pressurized inert gas between pipe 30 and pipe 9 following each sequential delivery of various liquids in dose of predetermined volume amount during predetermined time duration to force draining of dropped liquid promptly sipping through said resin/adsorbent to complete expected mass transfer equilibrium contact between two phases;
   3) meanwhile, maintain a vacuum 31 to continuous drain the individual liquid solution into respective underneath temporary reservoir 33 and to maintain resin/adsorbent in a semi-dry status;
   4) intermittently collect of all kind of treated and drained liquids in each temporary reservoir 33; transmitting by means of liquid pipelines 59 into transit reservoir 38 disposed in said downstream rotary union sub-module 195; advance one rotation step through means of rotation and positioning together with seal mechanism in predetermined rotating direction, then, through liquid pipeline 60 shown in FIG. 2 through FIG. 5 into each assigned holding tanks 44 in downstream holding tanks module E, transmitting predetermined volume amount out of holding tank 44 via means of pipelines 47 to assigned holding tank 15 in upstream holding tanks module A;
   5) repeating repeatedly step 1) through step 4) of step 2, initially for zone 0, then “zone 0 together with zone 1” until transit reservoir 21 in upstream rotary union sub-module 191 and transit reservoir 38 in downstream rotary union sub-module 195 return to each initial position to complete one revolution, so that, start-up operation for this portion of separation C can be concluded;
3. through means of aforesaid various liquid delivery route illustrated in FIG. 2 through FIG. 5, a predetermined volume amount of various liquids from respective holding tanks 15, similar to protocol illustrated in FIG. 14, starting internally from zone 7, then, expand simultaneous liquid input covering next zone in sequence among zones, wherein
   1) zone 7, feed solution, zone 8, 9, 10 been grouped corresponding with sub-module 192, then, expanded simultaneous liquid input covering next zone in sequence among zone 7, feed solution, 8, 9, 10 been covered with liquid input via means of liquid pipelines 18 into transit reservoir 21 disposed in said upstream rotary union sub-module 192; advance one rotation step through means of rotation and positioning together with seal mechanism in predetermined rotating direction, then via of pipelines 61 as indicated into each assigned top-inlet of cell 7 through cell 12, covering corresponding range of liquid input, for carrying out following mass transfer equilibrium contact process, then,
   2) within predetermined time spent for each zone, intermittently deliver through means of alternated supplying of pressurized inert gas between pipe 30 and pipe 9 following each sequential delivery of various liquids in dose of predetermined volume amount during predetermined time duration to force draining of dropped liquid promptly sipping through said resin/adsorbent to complete expected mass transfer equilibrium contact between two phases;
   3) meanwhile, maintain a vacuum 31 to continuous drain the individual liquid solution into respective underneath temporary reservoir 33 and to maintain resin/adsorbent in a semi-dry status;
   4) intermittently collect of all kind of treated and drained liquids in each temporary reservoir 33; transmitting by means of liquid pipelines 59 into transit reservoir 38 disposed in said downstream rotary union sub-module 196; advance one rotation step through means of rotation and positioning together with seal mechanism in predetermined rotating direction, then, through liquid pipeline 60 shown in FIG. 2 through FIG. 5 into each assigned holding tanks 44 in downstream holding tanks module E, transmitting predetermined volume amount out of holding tank 44 via means of pipelines 47 to assigned holding tank 15 in upstream holding tanks module A;
   5) repeating repeatedly step 1) through step 4) of step 3, initially for zone 7, then “zone 7 together with feed solution” until transit reservoir 21 in upstream rotary union sub-module 192 and transit reservoir 38 in downstream rotary union sub-module 196 return to each initial position to complete one revolution, so that, start-up operation for this portion of separation C can be concluded;
4. through means of aforesaid various liquid delivery route illustrated in FIG. 2 through FIG. 5, a predetermined volume amount of various liquids from respective holding tanks 15, similar to protocol illustrated in FIG. 14, starting internally from zone 11, then, expand simultaneous liquid input covering next zone in sequence among zones, wherein
   1) zone 11, 12, 13, 14, 16, 17 been grouped corresponding with sub-module 193, then, expanded simultaneous liquid input covering next zone in sequence among zone 11, 12, 13, 14, 16, 17 been covered with liquid input via means of liquid pipelines 18 into transit reservoir 21 disposed in said upstream rotary union sub-module 193; advance one rotation step through means of rotation and positioning together with seal mechanism in predetermined rotating direction, then via of liquid pipelines 61 as indicated into each assigned top-inlet of cell 13 through cell 18, covering corresponding range of liquid input, for carrying out following mass transfer equilibrium contact process, then,
   2) within predetermined time spent for each zone, intermittently deliver through means of alternated supplying of pressurized inert gas between pipe 30 and pipe 9 following each sequential delivery of various liquids in dose of predetermined volume amount during predetermined time duration to force draining of dropped liquid promptly sipping through said resin/adsorbent to complete expected mass transfer equilibrium contact between two phases;
   3) meanwhile, maintain a vacuum 31 to continuous drain the individual liquid solution into respective underneath temporary reservoir 33 and to maintain resin/adsorbent in a semi-dry status;
   4) intermittently collect of all kind of treated and drained liquids in each temporary reservoir 33; transmitting by means of liquid pipelines 59 into transit reservoir 38 disposed in said downstream rotary union sub-module 197; advance one rotation step through means of rotation and positioning together with seal mechanism in predetermined rotating direction, then, through liquid pipeline 60 shown in FIG. 2 through FIG. 5 into each assigned holding tanks 44 in downstream holding tanks module E, transmitting predetermined volume amount out of holding tank 44 via means of pipelines 47 to assigned holding tank 15 in upstream holding tanks module A;
   5) repeating repeatedly step 1) through step 4) of step 4, initially for zone 11, then “zone 11 together with zone 12” until transit reservoir 21 in upstream rotary union sub-module 193 and transit reservoir 38 in downstream rotary union sub-module 197 return to each initial position to complete one revolution, so that, start-up operation for this portion of separation C can be concluded;
5. through means of aforesaid various liquid delivery route illustrated in FIG. 2 through FIG. 5, a predetermined volume amount of various liquids from respective holding tanks 15, similar to protocol illustrated in FIG. 14, starting internally from zone 18, then, expand simultaneous liquid input covering next zone in sequence among zones, wherein
   1) zone 18, 19, eluent water, recycled water as shown been grouped corresponding with sub-module 194 and lastly followed inert gas to flush liquid residue to maximize fructose recovery, being transmitting entire available liquid volume simultaneously covering next zone in sequence among 18, 19, eluent water, recycled water been covered with liquid input via means of liquid pipelines 18 into transit reservoir 21 disposed in said upstream rotary union sub-module 194; advance one rotation step through means of rotation and positioning together with seal mechanism in predetermined rotating direction, then via of pipelines 61 as indicated into each assigned top-inlet of cell 19 through cell 24, covering corresponding range of liquid input, for carrying out following mass transfer equilibrium contact process,
   2) within predetermined time spent for each zone, intermittently deliver through means of alternated supplying of pressurized inert gas between pipe 30 and pipe 9 following each sequential delivery of various liquids in dose of predetermined volume amount during predetermined time duration to force draining of dropped liquid promptly sipping through said resin/adsorbent to complete expected mass transfer equilibrium contact between two phases;
   3) meanwhile, maintain a vacuum 31 to continuous drain the individual liquid solution into respective underneath temporary reservoir 33 and to maintain resin/adsorbent in a semi-dry status;
   4) intermittently collect of all kind of treated and drained liquids in each temporary reservoir 33; transmitting by means of liquid pipelines 59 into transit reservoir 38 disposed in said downstream rotary union sub-module 198; advance one rotation step through means of rotation and positioning together with seal mechanism in predetermined rotating direction, then, through liquid pipeline 60 shown in FIG. 2 through FIG. 5 into each assigned holding tanks 44 in downstream holding tanks module E, transmitting predetermined volume amount out of holding tank 44 via means of pipelines 47 to assigned holding tank 15 in upstream holding tanks module A;
   5) repeating repeatedly step 1) through step 4) of step 5, initially for zone 18, then “zone 18 together with zone 19” until transit reservoir 21 in upstream rotary union sub-module 194 and transit reservoir 38 in downstream rotary union sub-module 198 return to each initial position to complete one revolution, so that, start-up operation for this portion of separation C can be concluded.

Via aforesaid step 1 through step 5 initially in sequential order for liquid input of zone 0 through recycled water followed with pressurized inert gas to flush liquid residue to maximize fructose recovery to complete one revolution, so that, start-up operation can be concluded, wherein retrieved all kinds of liquids during start-up operation as “water” for predetermined recycle usage, water with low D.S. glucose solution for other usage, recycle streams of zone 0, 1, 2, 3, 4, 5, 6, 7, 8, 9, 10, 11, 12, 13, 14, 15, 16, 17, 18, and 19; except the solution collected from zone 2 is glucose Raffinate and solution from zone 15 is fructose product as illustrated in FIG. 13; further transmitting all kind of sugar mixtures for recycling as illustrated in aforesaid step 1 through step 5 except water with low D.S. glucose solution for other usage, raffinate and product, from each assigned holding tank 44 in downstream holding tanks module E via means of pipelines 47 to each corresponding holding tank 15 in upstream holding tanks module A.

Soon, start-up operation is concluded, thereafter disclosed apparatus can shift into steady state operation. Through all kind of liquids set for all zones arranged in FIG. 18 through means of liquid delivery described in FIG. 2 through FIG. 5 that is related with satisfied sugar mixture separation as illustrated in FIG. 12. Within predetermined time spent for each zone, such plurality of transit reservoirs 21 simultaneously receive entire available predetermined amount of various kinds of liquid delivery and simultaneously transmitted into respective cell proceeding said new mass transfer equilibrium contact method carried out in separation module C to obtain each treated sugar mixtures from respective cell bottom as steady state operation. The same procedures repeat repeatedly as following steady state operation; wherein
1. through means of aforesaid various liquid delivery route illustrated in FIG. 2 through FIG. 5, a predetermined volume amount of various liquids from respective holding tanks 15 of zone 0, 1, 3, 4, 5, 6, 7, feed solution, 8, 9, 10, 11, 12, 13, 14, 16, 17, 18, 19, eluent water, recycled water followed with inert gas to flush liquid residue to maximize fructose recovery, are simultaneously transmitting entire available liquid volume via means of pipelines 18 into assigned transit reservoir 21 disposed in upstream rotary union sub-module 191, 192, 193, and 194; simultaneously advance one rotation step through means of rotation and positioning together with seal mechanism in predetermined rotating direction of above said 191, 192, 193, and 194 sub-modules, then via of pipelines 61 as indicated into each underneath assigned cell's top-inlet for carrying out following mass transfer equilibrium contact process;
2. within predetermined time spent for each zone, intermittently deliver through means of alternated supplying of pressurized inert gas between pipe 30 and pipe 9 following each sequential delivery of various liquids in dose of predetermined volume amount during predetermined time duration to force draining of dropped liquid promptly sipping through said resin/adsorbent to complete expected mass transfer equilibrium contact between two phases;
3. meanwhile, maintain a vacuum 31 to continuous drain the individual liquid solution into respective underneath temporary reservoir 33 and to maintain resin/adsorbent in a semi-dry status;
4. intermittently collect of all kind of treated and drained liquids in each temporary reservoir 33; simultaneously transmitting by means of pipelines 59 into assigned transit reservoir 38 disposed in downstream rotary union sub-module 195, 196, 197, and 198; simultaneously advance one rotation step through means of rotation and positioning together with seal mechanism in predetermined rotating direction of above said 195, 196, 197, and 198 sub-modules, then, through 60 shown in FIG. 2 into each assigned holding tanks 44 disposed in downstream holding tanks module E; wherein all kind of liquids retrieved as “water” for predetermined recycle usage, water with low D.S.-glucose solution for other usage, recycle streams of zone 0, 1, 2, 3, 4, 5, 6, 7, 8, 9, 10, 11, 12, 13, 14, 15, 16, 17, 18, and 19; wherein the solution collected from zone 2 is glucose raffinate and solution from zone 15 is fructose product;
5. as illustrated in FIG. 2, further transmitting all kind of sugar mixtures for recycling from each assigned holding tank 44 in downstream holding tanks module E via means of pipelines 47 to each corresponding holding tank 15 in upstream holding tanks module A, except raffinate and product held and water with low D.S. glucose solution for other usage via its distributing route.

### Example 11

On the contrary, above illustrated binary glucose and fructose separation system is an extreme case in ion exchange process employed with ligand exchange mass transfer mechanism in which high polarity water is being used as the eluent liquid; nevertheless, both sugar components are dissolved in de-ionized water and such water is the eluent; both sugars are very water soluble with small difference in interaction with resin/adsorbent. Therefore dissolved sugar components in contact with Calcium base strongly acidic cation exchanger is slow and bonding is thus weak, resulting this binary sugar elution profile takes much longer 4 minutes time per minimal time interval, Δt, and is a quite difficult separation system to handle due to high viscosity and hygiene environment is required.

Other combination of mobile phase and resin/adsorbent performing similar purification mechanism like said reverse phase chromatography and normal phase chromatography that dissolved solute in mobile phase and installed resin/adsorbent relevant with polarity or solubility, through which adsorbed components onto resin/adsorbent can be eluted one after another component via modifying combination of polarity strength resulting adsorbed components having small difference in solubility with mobile phase eluent to accomplish expected separation in a slow and weak bonding with resin/adsorbent. On the contrary with examples 4 through 9, said cell 95 comprise multiple column 23 as bundle disposed in a single cell 95, wherein general procedures of said single column test is single column 23 that is thoroughly illustrated in FIG. 2 through FIG. 5. As discussed in FIG. 8 through FIG. 11, input I-I in combining with input-S-I, selected liquid input format in elution zone as simulation of elution gradient in fact can be suit for this type of polarity/solubility mass transfer mechanism that can chemically and selectively modify the polarity/solubility of eluent to interact with dissolved components original in mobile phase being adsorbed onto solid phase resin/adsorbent bed can be eluted in sequence. Those mass transfer equilibrium contact mechanisms through contacting between mobile phases with resin/adsorbent is somehow very similar to glucose and fructose ligand exchange mass transfer mechanism thoroughly illustrated in this disclosure. Yet, either reversed phase chromatography or normal phase chromatography is resemble to ion exchange chromatography being fact related to illustrated iso-point equilibrium state, at which each adsorbed component has its unique equilibrium parameter between selected mobile and solid phase, so that, adsorbed component cannot be eluted unless surrounding mobile phase triggered to or behind such iso-point to allow such component eluted back to mobile phase to flow with. Thus separation can be achieved and these type of elution chromatographic profile (chromatogram) generated from HPLC or benchtop scale apparatus is good reference for such initial evaluation. Therefore to avoid reiterate protocols for hybrid PDMB, the target system first requires through single column test via said selected input S-I and input I-I by modifying composition of respective input eluent liquid, so that, adsorbed components onto solid phase resin/adsorbent can be eluted in sequence with such liquid in order to generate an acceptable separation result of characteristic elution profile. Then, further apply general procedures of said new mass transfer equilibrium contact method and differential set up between mobile and solid phase employed onto disclosed apparatus for PDMB conversation and hybrid PDMB can be summarized as following:

A method for separating components, from a feed solution containing components in a particular composition dissolved in an eluent in contact with above said resin/adsorbent, by sorption and sequential elution of various modified eluent composition into one particular enriched component of at least one product, and one other enriched component at least one by-product; and to avoid reiterating of illustrated protocols in FIG. 1 through FIG. 11, wherein amid said steady state operation of PDMB, the method comprising following illustration:
A. at least one of column as bundle, each column having an inlet on one side and an outlet on another side with bottom meshed filter to contain said resin/adsorbent in each said column from being drained; such bundled group of at least one column perform as partially fluidized bed and named as cell hereinafter; wherein each cell having an top inlet on one side of the solid phase packing material and an bottom outlet on another side of the solid phase packing material;
B. providing said upstream holding tanks module containing, as illustrated in FIG. 2 and FIG. 3 related with hybrid PMBD,
   1. at least one feed tank containing said feed solution as feeding zone,
   2. and at least one eluent tank containing said eluent with modified eluent composition having selected discrete increment of polarity strength for respective composition of eluent, thus, resulting each adsorbed components having discrete mass transfer equilibrium contact status of small difference in polarity/solubility with mobile phase eluent and integration within of all cells for respective modified eluent liquid that is a plurality of recycled mixtures orderly contained in each of a plurality of holding tanks as respective defined zone,
   3. and at least one eluent tank containing said eluent liquid itself to regenerate disposed resin/adsorbent in respective cell as regenerating zone;
   4. so that, each tank disposed in said module contains feed solution, one particular recycled mixture that has a specific composition in order to orderly elute in sequence said adsorbed components in treated and drained solution, and eluent liquid for simultaneously transmitting to following module;
C. providing said upstream rotary union module for simultaneous orderly receiving and holding the liquid while forwarding one rotational step then orderly transmitting various kind of liquid flow from respective holding tank in upstream holding tanks module to top portion of said separation module via rotation positioning and seal mechanism related to illustrated FIG. 2 through FIG. 5;
D. simultaneously delivering all liquids in selected format of input S-I and input I-I for duration a time period into top portion of said separation module,
   1. wherein simultaneous transmitting all liquids include said recycled mixtures and feed solution and at least one eluent liquid contained in respective holding tank disposed in respective zone in a specified order, onto the inlet of respective cell, said liquid is delivered during said time period in a plurality of intermittent amounts, so that, said components in a specific composition contained in the delivered intermittent amount can attain an equilibrium through carrying out the sorption of said components onto said solid phase packing material and then eluted by said modified eluent composition and eluent itself contained in the recycled mixture following delivered intermittent amount;
   2. as said eluent from the following delivered intermittent amount is treated and drained hence further carrying out sorption of said one particular component and one other components among said components onto said solid phase packing at further apart locations along draining passage; as after said liquid has completed delivering in said intermittent amounts thus drained through the solid phase packing material to allow said components contained in the delivered liquid to be separated;
   3. supplying broad range of pressurized inert gas following each sequential delivered intermittent liquid amount at the cell top to affiliate prompt liquid draining and meanwhile maintaining a vacuum at the outlet of the cell disposed in said separation module so as to maintain the packing material in semi-dry condition, wherein semi-dry condition is defined as the packing material having wet surfaces but with no liquid filling interstices of the material;
   4. therefore, after completing delivering in sequence in said order of feed solution and recycled mixtures and eluent, said components contained in the feed solution can be migrated and separated through carrying out the sorption onto the solid phase packing material, and then through sequential elution by delivering said plurality of recycled mixtures and at least one eluent contained in respective holding tank in said sequential order, into said one particular enriched component at least one product and one other enriched component at least one by-product and said plurality of recycled mixtures that one particular recycled mixture has said specific composition of said components dissolved in treated and drained solution and eluent for recycling;
E. providing said downstream rotary union module for simultaneous orderly receiving and holding the liquid while forwarding one rotational step then orderly transmitting various kind of liquid flow from respective bottom portion in said separation module to respective disposed holding tank in said downstream holding tanks module via rotation positioning and seal mechanism related to FIG. 2 through FIG. 5;
F. further providing said downstream holding tanks module containing as illustrated in FIG. 2 and FIG. 3 related with hybrid PMBD containing at least one product holding tank for respectively holding said one particular enriched component product, containing at least one by-product holding tank for respectively holding one other enriched component by-product, and containing a plurality of recycled mixtures orderly contained in each of a plurality of holding tanks, so that, each tank contains one particular recycled mixture that has a specific composition of said components dissolved in treated and drained solution and eluent collected from bottom portion of said separation module for recycling back to said respective holding tanks orderly disposed in said upstream holding tanks module;
G. and distributing during the duration of said time period the treated and drained liquid to a corresponding one of the holding tanks disposed in said upstream holding tanks module containing
   1. a liquid that has a specific composition of said components dissolved in treated and drained solution and eluent, which is the composition of said components contained in the treated and drained liquid for recycling;
   2. so that, while delivering, in said sequential order during the duration of a particular time period, a liquid from among said all kind of liquids that include said feed solution and recycled mixtures the treated and drained liquid collected during same time period and eluent, is respectively distributed to a corresponding one holding tank disposed specific zone defined in upstream holding tanks module, all of which are the specific composition of said components dissolved in treated and drained solution and eluent that is the composition of said components contained in the treated and drained liquid disposed in respective zone in a specified order, feeding zone, regeneration zone, and washing zone;
   3, wherein said each holding tanks disposed in said downstream holding tanks contains one particular recycled mixture that has a specific composition of said components dissolved in treated and drained solution and eluent for recycling, at least one product holding tank for respectively holding said one particular enriched component product and by-product holding tank for respectively holding at least one other enriched component by-product.

For a single cell disposed in said separation module, with integration of all zones of all liquids disposed in respective holding tanks in upstream holding tanks module and all liquids contained in respective holding tanks disposed orderly in respective zone representing a differential liquid format to proceed an expected mass transfer equilibrium contact task in sequence for this single cell, wherein all liquids simultaneously transmitting to respective cell top of said separation module to preform and achieve such expected mass transfer equilibrium contact proceed in multiple stages, wherein with integration of all composition of liquids, means for all cells disposed in separation module, collected from bottom portion of the separation module representing a complete characteristic elution profile obtained from single column test via said new mass transfer equilibrium contact method transformed into a differential format in horizontal orientation in contact vertically with mobile phase liquid to achieve separation result during each spent of said minimal time interval.

### Example 12

As illustrated in Example 8 is single cell via sequential procedures explicated for fast and instant mass transfer mechanism that new mass transfer is instant despite of tedious sequential procedures resemble to chromatographic operation. Yet, impending FIG. 19 is schematic diagram explicated for slow adsorption and desorption mass transfer mechanism proceeded in batch mode via multiple cells disposed in modified apparatus. Again, this example utilize binary system glucose and fructose illustrated in Example 1 for sugar components dissolved in eluent liquid to achieve a complete separation cycle through twenty-three cells disposed in following modified apparatus amid every spent of said minimal time interval. This type of batch mode multiple cells organized in sequential order yet simultaneous operation is particular for separation system that already has an acceptable elution characteristic profile and can be operated in batch mode employed with combination of mobile phase in contact with selected resin/adsorbent through which like reverse phase and normal phase chromatography illustrated in Example 11; wherein such batch operation built for pilot scale or mass production process, depending again on design preference, to omit or modify at least one from selected modules among upstream holding tanks module A and upstream rotary union module B and downstream rotary union module D.

In order to employ said modified general method of differential set-up procedure for this exemplified binary glucose and fructose enrichment onto said apparatus operated in batch mode comprises following generalized modules as shown in FIG. 19, to further avoid reiterating details, wherein
A. providing said separation module C contain a plurality of twenty-three cells 95 arranged in sequential order and each cell 95 comprise a plurality of each columns 23 has a top side opening 24 means for liquid input and bottom screen filter 25 means for retaining equal amount of said resin/adsorbent from been drained; all cells 95 disposed in sequential order set inside an insulated selected heat media circulation jacket 36 and water can be preferred heat media, wherein said circulation jacket 36 comprise a heat media inlet via a manifold 26 and heat media outlet via another manifold 27 to maintain whole plurality of cells 95 in a selected temperature range; as shown on left upper portion exploded C-top diagram, each cell 95 top has temporary transit reservoir 28 extended out of the jacket 36 via liquid line 47 to receive particular delivered liquid; through reservoir 28 top selected check valve named as flipper 3 via a preferred showerhead 29 down below comprising a between bottom side of reservoir 28 and top side of showerhead 29 selected check valve named as flipper 4; thus via alternate on and or off supplying high range pressurized inert gas to intermittently drop in parts of delivered liquid out of reservoir 28 or stop transmitting such stored liquid to force draining dropped dose of liquid promptly sipping through resin/adsorbent as aforementioned selected input S-I to proceed said new mass transfer equilibrium contact between two phases, wherein gas pipe 9 disposed in between said flipper 3 and flipper 4 and gas pipe 30 disposed next to reservoir 28 as shown means for simultaneous alternate supplying of such pressurized dry inert gas for each cell 95;
B. each cell 95 bottom portion shown in left lower portion of this FIG. 19 noted as C-bottom is exposed to vacuum environment 31, having an exit for mobile phase liquid enriched inert gas via conduct 48 to maintain said resin/adsorbent on in a semi-dry status, thus to affiliate treated liquid draining through funneled shape liquid conduct 32 via opened selected check valve named as flipper 65 into each underneath temporary liquid reservoir 33 and collected liquid been hold via a selected pressure activated check valve 201 disposed around bottom side of liquid conduct 34. There has manifold 49 means for supplying low range pressurized inert gas while vacuum 31 being shut off, thus to press opened check valve 201 to discharge entire collected liquid via liquid line 59 to each assigned holding tank 44 disposed in following downstream holding tanks module and wherein both check valve 201 and conduct 34 are extended downward said insulated jacket 36;
C. providing said downstream holding tanks module having a plurality of holding tanks in same size for simplicity of drawing or different in size of exemplified example show in FIG. 12 contain twenty-four holding tanks and denoted as E; wherein each holding tank is assigned for receiving particular liquid via each liquid conduct 59 from aforementioned bottom portion of separation module C for holding such liquid transmitted back to assigned cell top; wherein such group of holding tanks arranged in sequential order as preferential set up placed inside an insulated selected heat media circulation jacket 41 and water can be preferred heat media wherein such circulation jacket 41 comprising a heat media inlet via a manifold 42 and heat media outlet via another manifold 43 to maintain whole plurality of holding tanks in a selected temperature range, wherein each holding tank representing by a single holding tank 44 shown on right portion in FIG. 19 as whole plurality each has an liquid conduct 45 installed top with selected check valve named as flipper 6; such liquid conduct 45 extended upward of said jacket 41 means for freely receiving particular liquid via opened flipper 6 and has a liquid conduct 46 extended downward of said jacket 41 means for discharging stored liquid via liquid line 47 as at least one isolated product into respective assigned storage tank; means for discharging components in particular solution as by product via another line 47 into respective assigned storage tank; and means for transmitting in part of available predetermined recycle solution stored in respective holding tank 44 via 47 in predetermined volume amount back via each volumetric pump or other means for liquid transmitting, not shown for drawing simplicity, into each assigned top portion of cell disposed in said separation module C. There has a gas pipe 62 installed next to conduct 45 means for supplying high range pressurized inert gas. There has a preferred liquid level sensor 63 installed inside each holding tank 44 to monitor predetermined liquid level of stored liquid within, means such level sensor 63 is to control delivering sufficient volume of particular solution via liquid conduct 64 to maintaining a predetermined liquid level setting in respective holding tank 44. For simplicity of drawing by each liquid line 47 for particular liquid distribution to respective assigned top portion of cell disposed in said separation module C; except to aforementioned at least one by product liquid and to at least one isolated product liquid, water with low D.S. glucose solution for other usage; moreover providing
D. said inert gas supply module F illustrated in FIG. 3 further denoted as F in this FIG. 19, wherein mainly focuses on routing for supplying broad range pressurized inert gas to incorporate with said separation module C and downstream holding tanks module E; wherein each module is briefly illustrated on right side of this figure and are all detailed in FIG. 2 and FIG. 3, wherein generalized portions relevant with batch mode operation employed by disclosed apparatus comprise following closed vacuum environment loop, upstream broad range inert gas supplying loop, and downstream broad range inert gas supplying loop:
   1. closed vacuum environment loop, wherein as aforementioned of each cell 95 bottom of separation module C is exposed to said vacuum environment 31; such closed loop shown on left portion of this figure comprising manifold conduct 48, mist separator 50, central vacuum pump 51, means for simultaneously prompt liquid draining into each said plurality of temporary liquid reservoirs 33 and meanwhile extracting mobile phase liquid enriched mist inert gas to maintaining said resin/adsorbent in a semi-dry status to meet criterion of new mass transfer equilibrium contact method; means to create a heterogeneous contact as dropped liquid dose promptly sipping through stationary resin/adsorbent particles; and means for converting mobile phase liquid enriched inert gas to dry inert gas. The whole time, mist enriched inert gas exiting said manifold 48 begin passing through mist separator 50 to extract mobile phase liquid moisture/vapor, prefer using cold water condenser to condense mobile phase liquid moisture/vapor or passing through other means to recover water soluble mobile phase liquid to store collected liquid in reservoir 52 via liquid conduct 53 to recycle such mobile phase liquid. Such dry inert gas exiting mist separator 50 being combined with pressurized dry air and deployed through an inert gas generator 54 to obtain fresh dry inert gas and to store in a steel tank vessel 55 maintaining at preferred broad range of pressure level inert gas ready for deploying back to following modules;
   2. upstream broad range inert gas supplying loop means for cell 95 top in said separation module C, wherein various particular liquid being transmitted via said each volume metric pump from respective holding tank disposed in downstream holding tanks module E, along with feed solution and eluent being delivered from its source, simultaneously via opened each flipper 3 into respective reservoir 28 placed at top of said separation module C; soon aforesaid operation is completed, high pressure inert gas via pipe 9 is promptly turned on in a predetermined short time duration to close flipper 3; whereas inert gas via pipe 30 being meantime shut off, resulting liquid stored inside reservoir 28 to promptly pass freely through bottom disposed flipper 4 to drop in parts of stored liquid during said very short time period to wet top portion of installed solid resin/adsorbent; then, immediately soon high-pressure inert gas supply via pipe 30 is turned on and whereas via pipe 9 being meanwhile shut off, such operation means for pushing back flipper 4 to stop liquid from dropping; means for pushing liquid sipping through said resin/adsorbent contained in each cell to complete expected aforesaid mass transfer equilibrium contact between two phases. Alternatively repeating operation between on and or off supplying inert gas between pipe 9 and pipe 30 with dividing stored liquid in reservoir 28 in predetermined liquid doses volume amount means to proceed differential set up between solid and liquid phase which is governed under current disclosure;
   3. downstream broad range inert gas supplying loop means for all cells 95 bottom in said separation module C and downstream holding tanks module E, wherein as aforementioned, bottom portion of separation C being exposed to said vacuum environment 31 contain entire bottom part of separation module in order to continuously and simultaneously drain dropped doses of liquid solution transmitted from respective cell 95 top thus to store in respective transit liquid reservoir 33, wherein such reservoir having widely opened top liquid conduct 32 to hold within treated and drained liquid stored in respective holding tank 33 through means of said pressure activated check valve 201; promptly after liquid draining is completed, whereas vacuum environment 31 being shut off; meanwhile low range pressurized inert gas supplied via manifold 49 being promptly turned on to push entire stored liquid in respective reservoir 33 simultaneously freely transferring through pressurized said opened valve 201 via liquid conduct 34 and through respective liquid line 59 into each assigned holding tank in said downstream holding tanks module E.

Note that “selected check valve name as flipper” is an option of pneumatic check valve that is related with supplying broad range of pressurized inert gas; again, depending on target system requirement like throughput capacity, hygiene operation environment and so on; options can be electric controlled solenoid valve, hydraulic check valve or other selections based on design preference. Thus, it is clear that all drawings illustrated in batch mode operation is mainly for illustration and possible extent of alternation or configurations of mechanical device onto preferred apparatus may be explored. Yet, fundamental concept of this disclosure should set above such possible modification and be governed within the scope of this invention is a hybrid of methods, “Parametric Simulated Moving Bed”, PSMB that is fundamentally differentiated with chromatographic operations.

As illustrated in FIG. 12, a preferable elution profile for complete separation cycle obtained from single column 23 is derived via said new mass transfer equilibrium contact method employed for differential set-up procedures resulting as one minute per minimal time interval, Δt; 4 minutes as a major minimal time interval per zone thus converted to total twenty-four zones arranged in sequential order to reflect such profile in sum of ninety-six minute time. In fact, one minute per Δt is randomly chosen and it can be in multiple as another predetermined minimal intervals, which is interpreted as a predetermined major zone to proportionally reduce number of zones with modification of procedures; wherein method for modified general method of differential set-up procedure for this exemplified binary glucose and fructose enrichment onto modified apparatus operated in batch mode comprises aresemble procedures shown in FIG. 19 to carry out batch mode separation through twenty-three cells disposed in said separation module C and twenty-four holding tanks disposed in downstream holding tanks module E as following:
1. determining optimal full-strength bonding capacity of said resin/adsorbent with a prefixed feed throughput and filling such resin/adsorbent amount into a said cell 95 contain multiple column 23 disposed within;
2. sequentially breaking down the elution profile obtained by said new mass transfer equilibrium contact method as shown in FIG. 12 is the partial time required to spend for respective predetermined mobile phase solution input for each zone, this including feed solution, eluent water, and multiple recycle streams including recycled water into last cell followed with pressurized inert gas to flushing disposed resin/adsorbent to maximize liquid draining, except retained glucose raffinate and fructose product and water with low D.S. glucose solution for other usage;
3. divide each partial time by said minimal time interval to obtain the range cumulated Δt as major minimal time interval of each cell 95 disposed for feeding zone and other zones following same major time interval of most time-consuming feeding zone; then
4. divide total input volume amount of such liquid by the number of cells to obtain the partial volume amount required for each cell in respective zone; then, divides such said partial volume by a preselected number to further differentiate for multiple liquid doses to reflect general procedures of said new mass transfer equilibrium contact method sipping in sequence through resin/adsorbent disposed in each cell 95;
5. further divides said resin/adsorbent amount in step 1, which derived from complete saturation with feed solution throughput, by a pre-selected number that corresponds to further differentiate resin/adsorbent in equal amount disposed in at least one column 23 bundled in a single cell 95 disposed in each zone to simultaneously receive the partial volume of respective liquid for each cell in said group of cells 95;
6. sequentially allocate all cells with respective mobile phase solution as the range of respective zone and allocate all zones into an endless format; wherein integrating all zones orderly arranged in sequential format representing a complete elution profile separation cycle via transmitting all kind of mobile phase with finite parameter solution into underneath stationary separation module C is to simulate all cells 95 in horizon moving direction whereas mobile phase is simultaneously traveling in vertical direction;
7. prepare predetermined volume amount of respective predetermined mobile phase solution to store in respective holding tank in said downstream holding tanks module E shown in bottom left portion of this FIG. 19 and named in sequence as recycled water, various recycle solution disposed in finite sugar concentration and composition named as zone 0, 1, 3, 4, 5, 6, 7, 8, 9, 10, 11, 12, 13, 14, 16, 17, 18, 19, whereas feed solution and eluent water being supplied from its source for simultaneous liquid distribution throughout said apparatus into separation module C to achieve expected separation.

For sake of large scale glucose and fructose binary separation process in connection with differential set-up exemplifies via modified apparatus for simultaneously and intermittently inputting in said input S-I format for various liquids; through means of aforesaid various liquid delivery route illustrated in step D of inert gas supply module F, wherein said general procedures for said batch mode operation comprise following, wherein
1. predetermined volume amount of various liquids transmitted from respective holding tanks 44 simultaneously from zone 0, 1, 3, 4, 5, 6, 7 via respective liquid line 47, feed solution delivered from its source via two of respective liquid line 202, zone 8, 9, 10, 11, 12, 13, 14, 16, 17, 18, 19, eluent water delivered from its source via three of respective liquid line 203, and ending with recycled water via liquid line 47 followed with pressurized inert gas to flush maximum liquid draining in last zone; as indicated in upper portion of FIG. 19 into each assigned underneath cell top reservoir 28 disposed in said separation module C to carry out following mass transfer equilibrium contact process;
2. intermittently deliver through means of alternated supplying of high range pressurized inert gas amid predetermined first time period between gas pipe 9 and gas pipe 30 following delivery of various liquids out from said each reservoir 28 disposed on respective cell top in dose of predetermined volume amount to force draining of dropped liquid promptly sipping through said resin/adsorbent to complete expected mass transfer equilibrium contact between two phases;
3. simultaneously meanwhile amid spent time of step 2 maintain a vacuum environment 31 to continuously drain off individual liquid solution into respective underneath temporary reservoir 33 thus to maintain resin/adsorbent in a semi-dry status;
4. meanwhile intermittently collect all kind of treated and drained liquids in each temporary reservoir 33; transmitting by means of each liquid transmitting route via low range pressurized inert gas supplied via manifold 49 to push entire stored liquid in respective reservoir 33 simultaneously freely transferring through opened valve 201 via liquid conduct 34 through respective liquid line 59 into each assigned holding tank in said downstream holding tanks module E;
5. Repeating step 1 through step 4 to accomplish a repeated manner of complete separation cycle amid each spent of said major time interval four minutes per zone to achieve glucose and fructose enrichment, wherein retrieved all kinds of liquids holding in respective holding tank 44 including recycled water for predetermined usage, water with low D.S. glucose solution for other usage, recycle streams of zone 0, 1, 2, 3, 4, 5, 6, 7, 8, 9, 10, 11, 12, 13, 14, 15, 16, 17, 18, and 19; except sugar solution with finite concentration and composition collected in zone 2 is glucose raffinate and solution in zone 15 is fructose product; as illustrated in this FIG. 19 further transmitting all kind of sugar mixtures for recycling except said raffinate and product and water with low D.S. glucose solution for other usage, from each assigned holding tank 44 in downstream holding tanks module E via means of each liquid line 47 to each assigned cell top reservoir 28 disposed in said separation module C.

In conclusion, those chromatographic operations when scale up for mass production in general suffer deteriorating separation efficiency due to aforesaid native deficiencies of chromatographic process and optimal balance between product purity and productivity is hard to select resulting issue like high production cost. Via controlling said mobile phase parameter and bypassing mobile phase transport dynamics issues toward employing said new mass transfer equilibrium contact method and differential set-up between two phases onto disclosed apparatus can be deemed as alternative process design. Mainly, this disclosure elucidates two extreme systems one is instant adsorption and desorption mechanism whereas other one is very slow mass transfer mechanism; somehow, other mechanism falls in between can be feasible to investigate. Again, each target purification system prior employing said hybrid PDMV process requires thoroughly evaluation, investigation, and testing through above illustrated methods in order to derive proper procedures suit for particular large scale separation.

1. A generalized separation process named as Parametric Differential Moving Bed, hereinafter abbreviated as PDMB, is to transform chromatography mass transfer mechanism of disposed solid phase from parallel into vertical path along with mobile phase's flow direction for continuous and simultaneous separating at least one desired component from a liquid solution mixture containing one component and at least other component named as mobile phase feed solution via beginning to obtain a characteristic separation profile by carrying out a new mass transfer equilibrium contact method for separating such plurality of components contained in said liquid phase feed solution by transmitting liquid feed solution mobile phase in contacting with a solid phase resin/adsorbent packing material, so that at least one of component contained in said liquid feed solution can be adsorbed onto resin/adsorbent, subsequently via said new mass transfer equilibrium contact method to transmit at least of second and third mobile phases of various kind of liquid solutions comprising predetermined composition in contact with said resin/adsorbent, so that, at least two of components are desorbed one after thereof; and wherein first is to determine optimal full-strength bonding capacity of resin/adsorbent with a prefixed feed solution throughput and such solid phase amount is equivalent to mass transfer zone in chromatography to carry out same above said mass transfer mechanism; wherein said Parametric Differential Moving Bed (PDMB) herein comprising following hybrid embodiments as general procedures of new mass transfer equilibrium contact method between solid and mobile phase employed by an apparatus operating via differential set-up and through single stage recycle protocol; and wherein:
A. proceeding by said new mass transfer equilibrium contact method containing at least one of following step, wherein
(i) retaining predetermined solid phase resin/adsorbent amount distributed equally in a bundled group of predetermined quantity of columns, each column having an inlet on top side and an outlet on another side with bottom meshed filter to contain equal amount of said resin/adsorbent from being drained; such bundled group of columns performing like partially fluidized beds as a whole unit being named as cell hereinafter; wherein each column retaining equal amount of resin/adsorbent solid material as plurality of columns installed in a said cell and sum amount of each disposed resin/adsorbent being corresponding to resin/adsorbent installed as mass transfer zone in chromatography to fully saturated with prefixed feed solution throughput; the liquid inlet of cell is from top and liquid outlet of cell is from bottom;
(ii) intermittently delivering predetermined amounts of mobile phase liquid material through predetermined type of liquid dispenser in portion as predetermined input format dose dropping amid predetermined first time period including mobile phase feed solution, at least of second and third mobile phases of various kind of liquid solutions comprising predetermined composition in contact with said resin/adsorbent to promote predetermined new mass transfer equilibrium contact method either promoting adsorption of dissolved components onto said resin/adsorbent or eluting adsorbed components from said resin/adsorbent;
(iii) intermittently supplying broad range pressurized inert gas to a cell top side following each delivery of said mobile phase dose means amid predetermined second time period for maintaining sufficient pressure to force prompt draining such mobile phase liquid percolate through said solid phase material to complete expected new mass transfer equilibrium contact method;
(iv) maintaining a vacuum environment on the other side of said solid phase material installed in said cell meanwhile amid spent time during step (iii) to maintain resin/adsorbent material in a semi-dry status; wherein said broad range pressurized inert gas being supplied from cell top whereas vacuum being exerted from cell bottom;
(v) collecting most of treated mobile phase liquid material meanwhile amid spent time during step (iii) from the outlet of cell bottom;
(vi) defining total spent time of step (ii) through step (v) being minimal time interval; said generalized separation process further proceed
B. via aforesaid new mass transfer equilibrium contact method to obtain a characteristic separation profile for particular separation system via a resin/adsorbent solid phase amount being maintained in said semi-dry status as full-strength adsorption capacity in contact of a mobile phase feed solution volume thus such predetermined resin/adsorbent solid phase amount being disposed in a cell, wherein a method for separating said plurality of components contained in at least one of first mobile phase stream comprising a liquid solution containing said components by contacting a solid phase resin/adsorbent with the at least one mobile phase stream in sequence, so that at least one of component being adsorbed by the resin/adsorbent, and wherein mobile phase being delivered through predetermined type of liquid dispenser as following defined selection of liquid input format, wherein input S-I mode is defined along duration in time domain as that predetermined amounts of same mobile phase parametric condition solution being delivered through predetermined type of liquid dispenser amid each spent of said said minimal time interval into said cell, whereas input I-I is defined as that predetermined amounts of “discrete increment” of mobile phase parametric condition solutions being delivered in sequence along duration in time domain through predetermined type of liquid dispenser into said cell amid each spent of said minimal time interval; wherein obtaining such characteristic separation profile being proceeded via following procedures as option of said input S-I, wherein
(a) intermittently delivering predetermined multiple amount of at least one of said first mobile phase stream amid predetermined first time period to the inlet of said cell;
(b) intermittently supplying pressurized inert gas to the cell top following each delivery of said first mobile phase amid predetermined second time period for promptly pushing transmitted first mobile phase through disposed said disposed resin/adsorbent in the cell;
(c) meanwhile amid spent time during step (b) maintaining a vacuum environment on the other side of said solid phase material installed in said cell to maintain resin/adsorbent material in a semi-dry status;
(d) collecting most of treated mobile phase liquid material meanwhile amid spent time during step (b) from the outlet of cell bottom;
(e) defining total spent time of step (a) through step (d) being minimal time interval; and
(f) repeating step (e) until all of said at least one of first mobile phase stream amount being delivered in sequence and total cumulated minimal time interval is defined as first mobile phase zone; and subsequently after predetermined amounts of first mobile phase streams are intermittently delivered; further contacting said resin/adsorbent with at least one of second mobile phase stream in sequence, each second stream comprising liquid eluent of predetermined composition to reach expected new mass transfer equilibrium contact method such that at least one of component is individually desorbed from the resin/adsorbent in sequence, wherein (g) intermittently delivering predetermined multiple amount of at least one of said second mobile phase stream amid predetermined first time period to the inlet of said cell;
(h) intermittently supplying pressurized inert gas to the cell top following each delivery of said second mobile phase amid predetermined second time period for promptly pushing transmitted second mobile phase through disposed said disposed resin/adsorbent in the cell;
(i) meanwhile amid spent time during step (h) maintaining a vacuum environment on the other side of said solid phase material installed in said cell to maintain resin/adsorbent material in a semi-dry status;
(j) collecting most of treated mobile phase liquid material meanwhile amid spent time during step (h) from the outlet of cell bottom;
(k) defining total spent time of step (g) through step (j) being minimal time interval; and
(l) repeating step (k) until all of said at least one of second mobile phase stream amount being delivered in sequence and total cumulated minimal time interval is defined as second mobile phase zone; and subsequently after predetermined amounts of second mobile phase streams are intermittently delivered; further contacting said resin/adsorbent with at least one of third mobile phase stream in sequence, each third stream comprising liquid eluent of predetermined composition to reach expected new mass transfer equilibrium contact method such that at least one of component is individually desorbed from the resin/adsorbent in sequence, and
(m) intermittently delivering predetermined multiple amount of at least one of said third mobile phase stream amid predetermined first time period to the inlet of said cell;
(n) intermittently supplying pressurized inert gas to the cell top following each delivery of said third mobile phase amid predetermined second time period for promptly pushing transmitted third mobile phase through disposed said disposed resin/adsorbent in the cell;
(o) meanwhile amid spent time during step (n) maintaining a vacuum environment on the other side of said solid phase material installed in said cell to maintain resin/adsorbent material in a semi-dry status;
(p) collecting most of treated mobile phase liquid material meanwhile amid spent time during step (n) from the outlet of cell bottom;
(q) defining total spent time of step (m) through step (p) being minimal time interval; and
(r) repeating step (q) until all of said at least one of third mobile phase stream amount being delivered in sequence and total cumulated minimal time interval is defined as third mobile phase zone; and repeating step (r) by adding at least one of fourth mobile phase stream if remaining components still remained been adsorbed with said resin/adsorbent, such that components can be eluted by predetermined composition to reach expected new mass transfer equilibrium contact method such that remaining components are individually desorbed from the resin/adsorbent in sequence; otherwise further(s)
intermittently delivering predetermined amounts of at least one of said drained and collected first mobile phase liquid stream in step (d) amid predetermined first time period to the inlet of said cell;
(t) intermittently supplying pressurized inert gas to the cell top following each delivery of said collected first mobile phase amid predetermined second time period for promptly pushing transmitted first mobile phase through disposed said disposed resin/adsorbent in the cell;
(u) meanwhile amid spent time during step (t) maintaining a vacuum environment on the other side of said solid phase material installed in said cell to maintain resin/adsorbent material in a semi-dry status;
(v) collecting most of treated mobile phase liquid material meanwhile amid spent time during step (t) from the outlet of cell bottom;
(w) defining total spent time of step(s) through step (v) being minimal time interval; and
(x) repeating step (w) until all of said at least one of first mobile phase stream being delivered in sequence and total cumulated minimal time interval is defined as last mobile phase zone; and
(y) wherein lastly to integrate all defined zones in sequential prevail with respect to mobile phase parametric condition in time domain to conclude obtaining characteristic separation profile for particular separation system via input S-I; and
further through options of said input format between input S-I and input I-I, wherein said input I-I being proceeded as following procedures,
(a) intermittently delivering predetermined multiple amount of at least one of said first mobile phase stream amid predetermined first time period to the inlet of said cell;
(b) intermittently supplying pressurized inert gas to the cell top following each delivery of said first mobile phase amid predetermined second time period for promptly pushing transmitted first mobile phase through disposed said disposed resin/adsorbent in the cell;
(c) meanwhile amid spent time during step (b) maintaining a vacuum environment on the other side of said solid phase material installed in said cell to maintain resin/adsorbent material in a semi-dry status;
(d) collecting most of treated mobile phase liquid material meanwhile amid spent time during step (b) from the outlet of cell bottom;
(e) defining total spent time of step (a) through step (d) being minimal time interval and define such zone as first discrete mobile phase zone;
(f) repeating step (e) by increasing a discrete increment of mobile phase parametric conditions until all of said at least one of first mobile phase stream being adjusted with preset incremental discrete delivered in sequence and total cumulated minimal time interval is defined as multiple first discrete mobile phase zone named in sequential order corresponding to respective delivered mobile phase parametric condition; and subsequently after predetermined amounts of discrete increment parametric condition of first mobile phase streams are intermittently delivered; further contacting said resin/adsorbent with at least one of second mobile phase stream in sequence, each second stream comprising liquid eluent of predetermined composition in discrete increment of parametric condition to reach expected new mass transfer equilibrium contact method such that at least one of component is individually desorbed from the resin/adsorbent in sequence, wherein
(g) intermittently delivering predetermined multiple amount of at least one of said second mobile phase stream amid predetermined first time period to the inlet of said cell;
(h) intermittently supplying pressurized inert gas to the cell top following each delivery of said second mobile phase amid predetermined second time period for promptly pushing transmitted second mobile phase through disposed said disposed resin/adsorbent in the cell;
(i) meanwhile amid spent time during step (h) maintaining a vacuum environment on the other side of said solid phase material installed in said cell to maintain resin/adsorbent material in a semi-dry status;
(j) collecting most of treated mobile phase liquid material meanwhile amid spent time during step (h) from the outlet of cell bottom;
(k) defining total spent time of step (g) through step (j) being minimal time interval and define such time interval as second discrete mobile phase zone;
(l) repeating step (k) by increasing a discrete increment of mobile phase parametric conditions until all of said at least one of second mobile phase stream being adjusted with preset incremental discrete delivered in sequence and total cumulated minimal time interval is defined as multiple second discrete mobile phase zone named in sequential order corresponding to respective delivered mobile phase parametric condition; and subsequently after predetermined multiple amount of second mobile phase streams are intermittently delivered; further contacting said resin/adsorbent with at least one of third mobile phase stream in sequence, each third stream comprising liquid eluent of predetermined increment of mobile phase parametric composition to reach expected new mass transfer equilibrium contact method such that at least one of component is individually desorbed from the resin/adsorbent in sequence, wherein
(m) intermittently delivering predetermined multiple amount of at least one of said third mobile phase stream amid predetermined first time period to the inlet of said cell;
(n) intermittently supplying pressurized inert gas to the cell top following each delivery of said third mobile phase amid predetermined second time period for promptly pushing transmitted third mobile phase through disposed said disposed resin/adsorbent in the cell;
(o) meanwhile amid spent time during step (n) maintaining a vacuum environment on the other side of said solid phase material installed in said cell to maintain resin/adsorbent material in a semi-dry status;
(p) collecting most of treated mobile phase liquid material meanwhile amid spent time during step (n) from the outlet of cell bottom;
(q) defining total spent time of step (m) through step (p) being minimal time interval and define such time interval as third discrete mobile phase zone;
(r) repeating step (q) by increasing a discrete increment of mobile phase parametric conditions until all of said at least one of third mobile phase stream being adjusted with preset incremental discrete delivered in sequence and total cumulated minimal time interval is defined as multiple third discrete mobile phase zone named in sequential order corresponding to respective delivered mobile phase parametric condition;
(s) subsequently adding at least one of fourth mobile phase stream if remaining components still been adsorbed with said resin/adsorbent, such that components can be eluted by predetermined composition with discrete increment of mobile phase parametric condition to reach expected new mass transfer equilibrium contact method such that remaining components are individually desorbed from the resin/adsorbent in sequence; otherwise
(t) intermittently delivering predetermined multiple amount of at least one of said drained and collected first mobile phase liquid stream in step (d) amid predetermined first time period to the inlet of said cell;
(u) intermittently supplying pressurized inert gas to the cell top following each delivery of said first mobile phase amid predetermined second time period for promptly pushing transmitted first mobile phase through disposed said disposed resin/adsorbent in the cell;
(v) meanwhile amid spent time during step (u) maintaining a vacuum environment on the other side of said solid phase material installed in said cell to maintain resin/adsorbent material in a semi-dry status;
(w) collecting most of treated mobile phase liquid material meanwhile amid spent time during step (u) from the outlet of cell bottom;
(x) defining total spent time of step (t) through step (w) being minimal time interval; and
(y) repeating step (x) until all of said at least one of first mobile phase stream being delivered in sequence and total cumulated minimal time interval is defined as last mobile phase zone; and
(z) wherein lastly to integrate all defined zones in sequential prevail with respect to mobile phase parametric condition in time domain to conclude obtaining characteristic separation profile for particular separation system via input I-I;
C. said generalized separation process further constructing an apparatus to integrate multiple modules contained in a closed loop yet single module functioning independently, wherein each among multiple modules connected in sequence further coordinated as a whole unit and such apparatus comprising at least one of following:
1) providing upstream holding tanks module; wherein
a. having a plurality of holding tanks disposed in an organized order setting inside an insulated heat media circulation jacket to maintain whole plurality in a selected temperature range;
b. each said holding tank of whole plurality having an inlet liquid conduct extended outside upward of said jacket to receive liquid via an preferred mechanical device opened flipper, named as flipper 1 hereinafter disposed about bottom inside of said liquid conduct;
c. each of said whole plurality holding tanks having an outlet liquid conduct extended outside downward of said jacket installed with another flipper, named as flipper 2 hereinafter disposed about top inside of said liquid conduct to hold the received liquid when flipper 2 being closed or to discharge liquid into following module when said flipper 2 being opened whereas said flipper 1 being closed;
d. wherein driven force utilized for opening or closing a flipper via supplying broad pressure range of inert gas via its respective gas pipe disposed around each said holding tank top and bottom side;
2) providing upstream rotary union module having a rotational circular multiple valves body driven by a Servo-motor rotate to intermittently stopped and stepped forward a predetermined equal angle in a run around selected direction via rotation and positioning together with seal mechanism and employed as part of upstream rotary union module for bridging to transmitting various kind of liquids simultaneously; wherein
a. such valve body contains a plurality of transit reservoirs being evenly mounted in each predetermined location of bored hole along predetermined equal angles of multiple angle lines and circumference of a horizontal circular plate and each reservoir having a wide enough top opening to receive liquid and having a bottom liquid conduct equipped with a valve body disposed near top vicinity of this bottom liquid conduct to hold received liquid, wherein valve body and bottom liquid conduct are disposed downward through said horizontal circular plate;
b. whole group of evenly spaced transit reservoirs being disposed inside an endless flattop reversed “U” shape stationary annular channel to cover plurality of components including said plurality of transit reservoirs which are disposed on upper surface of horizontal circular plate, wherein outer top surface of stationary annular channel installed matching plurality of paired nipple connected to extended liquid conduct out from corresponding bottom of each said holding tank disposed in upstream holding tanks module and wherein each bottom side of nipple connected to an extended downward liquid conduct disposed inside of said stationary annular channel in line vertically within vicinity above top inlet wide enough opening of said transit reservoir to receive transmitted liquid;
c. having a U shape stationary compartment matching “U” shape stationary annular channel being securely supported via other structure means and disposed beneath said horizontal rotating plate with gap between rim of U shape compartment and horizontal plate small enough to minimize pressurized inert gas leak and to allow horizontal circular plate to rotate intermittently, there has matching quantity of wide opened funnel being disposed evenly on floor of said U shape stationary compartment in line vertically with above disposed transit reservoir and outlet of such funnel being connect with a nipple disposed through outside of such stationary compartment connected with a liquid conduct of respective reservoir as transit vehicle for such transmitted liquid into following assigned top portion of separation module;
d. soon simultaneous receiving of all kind liquid in each corresponding liquid transit reservoirs being satisfied via delivering respective liquid through predetermined type of liquid dispenser, said valve body promptly stepping forward one rotation angle step and stop at predetermined rotation angle via said rotation and positioning together with seal mechanism, wherein vertically in line of liquid conduct disposed above said transit reservoir and with corresponding beneath wide open funnel means for simultaneous transmitting of all kind of liquids being out from respective holding tank of said upstream holding tanks module via this bridging module amid said horizontal rotating plate being in immobile status into assigned top portion of said separation module via supplying pressurized inert gas for mobile phase liquid streams transmitting mechanism to discharge liquid transmitted and waiting for another round of liquid throughput;
3) providing separation module having a plurality of aforesaid cells organized in a similar order like said upstream holding tanks module being preferential set up; wherein;
(a) each cell comprising predetermined quantity of columns orderly disposed inside each cell; each column having an top side inlet and a bottom side outlet with meshed filter to contain equal amount of resin/adsorbent material from being drained;
(b) such plurality of cells disposed in an organized order setting inside an insulated heat media circulation jacket to maintain whole plurality of cells in a selected temperature range;
(c) each cell top having an inlet liquid conduct as temporary transit reservoir extended outside upward of said heat media circulation jacket assigned to receive particular liquid delivered from corresponding holding tank in said upstream holding tanks module through an opened flipper, named as flipper 3 hereinafter disposed around top inside of said liquid transit storage reservoir, through said upstream rotary union module and via delivering respective liquid through predetermined type of liquid dispenser down below; such dispenser comprising of another preferred mechanical device flipper, named as flipper 4 hereinafter disposed inside in between bottom side of said temporary transit reservoir and top side of the liquid dispenser;
(d) via means of alternatively and simultaneously supplying of broad range pressurized inert gas through gas pipe connected in between said flipper 3 and flipper 4 of said temporary transit reservoir and another gas pipe disposed next to said temporary transit reservoir to intermittently dose dropping in parts of received liquid out of temporary transit reservoir resulting as predetermined said liquid input format to promptly wet top portion and promptly sipping through resin/adsorbent bed to carry out expected new mass transfer equilibrium contact method;
(e) each said cell bottom side being exposed to said vacuum environment containing all said transit reservoirs with its widely open top means to withdrawing mist enriched inert gas via its gas exit pipe through manifold alike to maintaining said resin/adsorbent in a semi-dry status, and meanwhile to affiliating liquid draining via disposed funneled shape liquid conduct;
(f) via another opened mechanical flipper, names as flipper 65 hereinafter disposed inside bottom of said funnel conduct, into each underneath temporary liquid reservoir; having a gas pipe connected with same manifold next to said mist enriched inert gas exit pipe means for supplying broad range pressurized inert gas via this manifold to shut off said flipper 65 soon said vacuum environment being shut off, so that pushing entire drained liquid into following module via another opened flipper, named as flipper 5 hereinafter disposed around top inside of said bottom liquid conduct, wherein said inert gas manifold being disposed underneath said vacuum environment and being extended outside downward of said insulated heat media circulation jacket;
4) providing downstream rotary union module having a rotational circular multiple valves body driven by a Servo-motor rotate to intermittently stopped and stepped forward a predetermined equal angle in a run around selected direction via rotation and positioning together with seal mechanism and employed as part of downstream rotary union module for bridging to transmitting various kind of liquids simultaneously, wherein;
a. such valve body contains plurality of transit reservoirs being evenly mounted in each predetermined location of bored hole along predetermined equal angles of multiple angle lines and circumference of a horizontal circular plate and each reservoir having a wide enough top opening to receive liquid and having a bottom liquid conduct equipped with a valve body disposed near top vicinity of this bottom liquid conduct to hold received liquid, wherein valve body and bottom liquid conduct are disposed downward through said horizontal circular plate;
b. whole group of evenly spaced transit reservoirs being disposed inside an endless flattop reversed “U” shape stationary annular channel to cover plurality of components including said plurality of transit reservoirs which are disposed on upper surface of horizontal circular plate, wherein outer top surface of stationary annular channel installed matching plurality of paired nipple connected to extended liquid conduct out from corresponding bottom portion of particular temporary liquid reservoir of aforesaid separation module and wherein each bottom side of nipple connected to an extended downward liquid conduct disposed inside of said stationary annular channel in line vertically within vicinity above top inlet wide enough opening of said transit reservoir to receive transmitted liquid;
c. having a U shape stationary compartment matching “U” shape stationary annular channel being securely supported via other structure means and disposed beneath said horizontal rotating plate with gap between rims of the U shape compartment and horizontal plate small enough to minimize pressurized inert gas leak and to allow horizontal circular plate to rotate intermittently, there has matching quantity of wide opened funnel being disposed evenly on floor of said U shape stationary compartment in line vertically with above disposed transit reservoir and outlet of such funnel being connect with a nipple disposed through outside of such stationary compartment connected with a liquid conduct of respective reservoir as transit vehicle for such transmitted liquid into assigned holding tank disposed in following downstream holding tanks module;
d. soon simultaneous receiving of all kind liquid in each corresponding liquid transit reservoirs being satisfied via delivering respective liquid through predetermined type of liquid dispenser, said valve body promptly stepping forward one rotational angle step and stop at predetermined rotational angle via said rotation and positioning together with seal mechanism, wherein vertically in line of liquid conduct disposed above said transit reservoir and with corresponding beneath wide open funnel means for simultaneous transmitting of all kind of liquids being out from particular temporary liquid reservoir of aforesaid separation module via this bridging module amid said horizontal rotating plate being in immobile status into assigned holding tank disposed in following downstream holding tanks module via supplying pressurized inert gas for mobile phase liquid streams transmitting mechanism to discharge liquid transmitted and waiting for another round of liquid throughput;
5) providing downstream holding tanks module, wherein
a. having a plurality of holding tank disposed in an organized order setting inside an insulated heat media circulation jacket to maintain whole plurality of holding tanks in a selected temperature range and each tank having an inlet liquid conduct extended outside upward of the insulated heat media circulation jacket;
b. each of said liquid conduct via an preferred mechanical device flipper, named as flipper 6 hereinafter disposed about top inside of said liquid conduct; wherein driven force utilized for closing the flipper 6 via supplying broad pressure range of inert gas via its respective gas pipe disposed around each said holding tank top side;
c. each of said whole plurality holding tanks comprising an outlet liquid conduct extended outside downward of said jacket means for discharging stored liquid via each means of liquid distribution;
d. having a liquid level sensor installed inside each of said whole plurality holding tanks to monitor predetermined liquid level of stored liquid within, means such level sensor is to control delivering sufficient volume amount of particular solution via liquid conduct disposed on top of such holding tank to maintaining a predetermined liquid level setting in respective holding tank;
(i) means for at least one isolated product into respective assigned storage tank;
(ii) means for discharging components in particular solution mixture as by product into respective assigned storage tank;
(iii) and means for transmitting in part of separated component stored in respective holding tank in predetermined volume recycling back into each assigned holding tank in aforesaid upstream holding tanks module; and further wherein;
6) providing inert gas supply module means for mobile phase liquid streams transmitting mechanism by focusing on setting up closed loop routing for supplying broad range pressurized inert gas inasmuch as incorporating with liquid fluid transmitting among said upstream holding tanks module, upstream rotary union module, separation module, downstream rotary union module, and downstream holding tanks module, wherein such inert gas module comprising closed vacuum environment loop, upstream broad range inert gas supplying loop, and downstream broad range inert gas supplying loop;
D. said generalized separation process further proceed a differential set-up protocols employed via said general procedures of new mass transfer equilibrium contact method with predetermined said cell construction and carry out by predetermined matching mobile phase in-put format selected in between said input S-I and input I-I to obtain a characteristic separation profile for particular separation system related between selected resin/adsorbent solid phase and in conjunction with various kinds of mobile phase liquid solution into said apparatus for continuous and simultaneous separating at least one desired component from a liquid solution mixture amid each spent of minimal time interval, wherein including setting up at least one zone corresponding to at least one of first mobile phase stream; including setting up at least one zone corresponding to at least one of second mobile phase stream, and including setting up at least one zone corresponding to at least one of third mobile phase stream, and a predetermined plurality of alternative recycled mobile phase streams back to predetermined zone, thus, integrating all zones in sequence representing such obtained characteristic separation profile being to transform chromatography mass transfer mechanism of disposed solid phase from parallel into vertical path along with mobile phase's flow direction; further organizing such differential set-up protocols onto said apparatus, and wherein
E. said generalized separation process proceeding a single stage recycle protocol employed onto said apparatus via said new mass transfer equilibrium contact method to carry out along with modules disposed in said apparatus through said mobile phase liquid streams transmitting mechanism to simultaneously and intermittently delivering each mobile phase liquid stream originally stored in respective holding tank disposed in said upstream holding tanks module into following separation module to proceed expect new mass transfer equilibrium contact method; wherein multiple mobile phase liquid streams being retrieved through said separation module including at least one product, at least one by-product, and a plurality of recycled streams being delivered into assigned respect holding tank disposed in downstream holding tanks module; further delivering such plurality of recycled streams with steady characteristics of composition and concentration, back to predetermined zone disposed in said upstream holding tanks module together with other each mobile phase liquid stream, and then being repeated through said separation module delivering retrieved liquid streams back to assigned respective holding tank disposed in said downstream holding tanks module as single stage recycle protocol.

2. The process of claim 1 wherein differential set-up protocols employed between said resin/adsorbent and various kinds of mobile phase liquid material including a predetermined plurality of alternative recycled mobile phase streams for intermittently delivering into said apparatus,
(a) wherein such recycled mobile phase streams is to replace predetermined of at least one of first mobile phase stream stored in respective holding tank disposed in said upstream holding tanks module;
(b) wherein such recycled mobile phase streams is to replace corresponding at least one of second mobile phase stream stored in respective holding tank disposed in said upstream holding tanks module; and
(c) wherein such recycled mobile phase streams is to replace corresponding at least one of third mobile phase stream stored in respective holding tank disposed in said upstream holding tanks module.

3. The process of claim 1 wherein said resin/adsorbent contained in said cell is a particulate material to interact with plurality of dissolved components in mobile phase stream to promote adsorption new mass transfer equilibrium contact method between two phases is feed solution.

4. The process of claim 3 wherein feed solution is the first mobile phase stream and such consumed said minimal time interval is defined as feeding zone.

5. The process of claim 3 wherein feed solution is being introduced in between two consecutive zones and such consumed said minimal time interval is defined as feeding zone.

6. The process of claim 3 wherein feed solution interact with disposed resin/adsorbent disposed orderly contained in at least one cell of the apparatus is a particulate ion exchange resin/adsorbent.

7. The process of claim 3 wherein feed solution interact with disposed resin/adsorbent disposed orderly contained in at least one cell of the apparatus is a particulate affinity resin/adsorbent.

8. The process of claim 3 wherein feed solution interact with disposed resin/adsorbent disposed orderly contained in at least one cell of the apparatus is a particulate reverse phase resin/adsorbent.

9. The process of claim 3 wherein feed solution interact with disposed resin/adsorbent disposed orderly contained in at least one cell of the apparatus is a particulate normal phase resin/adsorbent.

10. The process of claim 3 wherein particular solution interact with disposed resin/adsorbent disposed orderly contained in at least one cell of the apparatus is a particulate activated carbon.

11. The process of claim 3 wherein particular solution interact with disposed resin/adsorbent disposed orderly contained in at least one cell of the apparatus is a particulate catalyst.

12. The process of claim 5 wherein feed solution being introduced in between two consecutive zones is defined as feeding zone, such feed solution comprising oligosaccharide, glucose and fructose sugar mixtures with finite component percentage composition and finite dry solid concentration homogeneously dissolved in finite volume amount of de-ionized dirt free water and eluent is same de-ionized dirt free water to separate glucose and fructose sugar component, wherein resin/adsorbent disposed orderly contained in at least one cell of the apparatus is a particulate one type of the alkaline-earth metals base strongly acidic Cation exchanger.

13. The process of claim 12 wherein said resin/adsorbent filled in each cell of the apparatus is calcium base strongly acidic cation exchanger to attain pure glucose as raffinate with finite dry solid concentration over 35%, and to attain 99.99% fructose purity as product with over 51% of finite dry solid concentration, and to attain a plurality of each recycling stream having finite characteristics in sugar composition and finite concentration.

14. The process of claim 1 wherein said cell defined in new mass transfer equilibrium contact method containing predetermined solid phase resin/adsorbent amount is distributed in single column as cell itself, such column having an inlet on top side and an outlet on another side with bottom meshed filter to contain equal amount of said resin/adsorbent from being drained, wherein such column retaining defined amount of resin/adsorbent solid material being corresponding to resin/adsorbent installed as mass transfer zone in chromatography to fully saturated with prefixed feed solution throughput; the liquid inlet of cell is from top and liquid outlet of cell is from bottom.

15. The process of claim 1 wherein said cell defined in new mass transfer equilibrium contact method containing predetermined solid phase resin/adsorbent amount is distributed in single column as cell itself, wherein such column comprising
(a) a plurality of stacked rings, each layer of ring with a bottom meshed filter providing a separated space in between two of adjacent rings and each meshed filter supporting a particulate resin/adsorbent material from being drained, open space above disposed said resin/adsorbent amount is top inlet of this ring layer; and wherein
(b) such layer of ring retaining defined amount of resin/adsorbent solid material being corresponding to resin/adsorbent installed as mass transfer zone in chromatography to fully saturated with prefixed feed solution throughput; the liquid inlet of each layer of ring is from top and liquid outlet of such ring is from bottom.

16. The process of claim 15 wherein said resin/adsorbent amount being contained in one layer of ring is different from the resin/adsorbent contained in another layer of ring.

17. The process of claim 15 wherein said different types of resin/adsorbent packing material disposed in specific layer is combination of named anion exchanger, cation exchanger, reverse phase, normal phase, activated carbon, and catalyst, all of which can chemically interact with mobile phase to have adsorption and de-sorption capabilities.

18. The process of claim 1 wherein said general procedures to carry out said new mass transfer equilibrium contact method wherein mobile phase liquid material being transmitted in portion through predetermined type of liquid dispenser is showerhead to conduct the predetermined volume of transmitted fluid amid short period time duration to sprinkle a wetted region of retained resin/adsorbent to sipping through and achieving expected new mass transfer equilibrium contact method between two phases.

19. The process of claim 1 wherein said general procedures to carry out said new mass transfer equilibrium contact method wherein mobile phase liquid material being transmitted in portion through predetermined type of liquid dispenser is a less than 180 degree baffle to conduct predetermined volume amount of transmitted fluid amid short period time duration to splash over like downward umbrella shape; such splashed fluid hitting inner container wall, and swiftly sliding downward to partially up-lift and penetrate to stirring upward contained resin/adsorbent grains, wherein this instantaneous partial mixing effect is for quick contact to dramatic reduction of required time for expected new mass transfer equilibrium contact method between two phases.

20. The process of claim 1 wherein said generalized hybrid Parametric Differential Moving Bed, PDMB is produced first via said new mass transfer equilibrium contact method to obtain a characteristic elution profile carried out in between selected input S-I and input I-I format through elected combination of mobile phase and solid phase resin/adsorbent, and such profile been utilized for establishing differential set-up protocols employed via said general procedures of new mass transfer equilibrium contact method via single stage recycle to implement said differential set-up protocols onto said apparatus, again via said new mass transfer equilibrium contact method to carry out together with said mobile phase liquid streams transmitting mechanism; wherein the generalized hybrid PDMB is employed for a method separating components from a feed solution containing one component with at least one other component in defined composition mixed in an eluent in contact with solid phase particulate resin/adsorbent by sorption and sequential elution of various modified eluent composition, each said component having a different iso-point equilibrium state, wherein such iso-point is defined as an equilibrium state at which particular adsorbed component starting to desorb from the solid phase packing material so that desorption of individual components occurs sequentially into one particular enriched component of at least one product, and one other enriched component at least one by-product; and a plurality of recycled mixtures that one particular recycled mixture has a specific composition of said components dissolved in drained solution and eluent for recycling, the method comprising following, wherein
A. providing said upstream holding tanks module containing plurality of holding tanks disposed in an organized order setting inside an insulated heat media circulation jacket to maintain whole plurality in a selected temperature range; wherein:
1. at least one feed tank each containing said entire throughput of feed solution been evenly divided in portion and integrated all tanks as feeding zone; and
2. at least one eluent tank each containing said eluent with modified eluent composition having selected discrete increment of parametric condition for respective composition of eluent, thus, resulting individual adsorbed components having discrete iso-point equilibrium state of difference in parametric condition to elute in sequence with surrounding modified mobile phase eluent in contact with disposed resin/adsorbent in cell and integration within of all cells for respective modified eluent liquid that is a plurality of recycled mixtures orderly contained in each of a plurality of holding tanks as respective defined zone; wherein
a) at least one of different modified eluent orderly arranged in at least one modified eluent, each having a preset iso-point composition prior to the iso-point of said one component that can desorb said at least one of first other component in sequence and not to elute adsorbed said one component and remaining of at least one other component, such plurality of recycled mixtures orderly contained in each of a plurality of holding tanks as at least one first elution zone;
b) at least one of modified eluent orderly arranged in at least one incremental of parametric condition, each having a preset iso-point composition is the minimal iso-point for said one component that can desorb in part of said one component and not to elute remaining at least of one other adsorbed component; such plurality of recycled mixtures orderly contained in each of a plurality of holding tanks as at least one component recovery zone is named for at least one product recovery zone;
c) at least one of modified eluent orderly arranged in at least one incremental of parametric condition, each having a preset iso-point composition is above the iso-point for said one component and remaining said one other component that can desorb all of said at least of one other component; such plurality of recycled mixtures orderly contained in each of a plurality of holding tanks as at least second elution zone is named for regeneration zone;
d) and at least one eluent tank containing said eluent itself to wash off disposed resin/adsorbent in respective cell preparing for in contact with feed solution in said feeding zone as washing zone;
3. so that, each tank disposed in said upstream holding tanks module contains at least one portion of feed solution, one particular recycled mixture that has a specific composition in order to orderly elute said adsorbed components in drained solution, and eluent for simultaneously transmitting to said separation module and representing obtained characteristic elution profile produced via selected between input S-I and input I-I format of a particular target separation system; further
B. providing said upstream rotary union module as bridging between said upstream holding tanks module and said separation module for simultaneous orderly receiving and holding the liquid while forwarding one rotational step then, amid rotary union module being in immobile status, simultaneous orderly transmitting various kind of liquid flow from respective holding tank in upstream holding tanks module to assigned top portion of said separation module via rotation and positioning together with seal mechanism; further
C. providing said separation module to simultaneously delivering all liquids in selected format of input S-I and input I-I for duration a time period into assigned top portion of said separation module, wherein
1. having a plurality of cells organized in an approximate order like said upstream holding tanks module being preferential set up; wherein each cell comprising at least one of each column having an inlet on one side and an outlet on another side with bottom meshed filter to contain said resin/adsorbent in each said column from being drained and orderly disposed inside each cell; wherein each cell retaining defined amount of resin/adsorbent solid material being corresponding to resin/adsorbent installed as mass transfer zone in chromatography to fully saturated with prefixed feed solution throughput; such a plurality of cells disposed in an organized order setting inside an insulated heat media circulation jacket to maintain whole plurality of cells in a selected temperature range;
2, wherein simultaneous transmitting all liquids from corresponding holding tank via said upstream rotary union module into assigned inlet of respective cell including said a plurality of recycled mixtures and feed solution and at least one eluent contained in respective holding tank disposed in respective zone in a specified order, wherein said liquid being delivered during a time period in a plurality of intermittent multiple amount in sequence, so that, said components in a specific composition contained in each delivered intermittent amount can attain an particular equilibrium contact through carrying out the sorption of said components onto said solid phase packing material and then eluted by said modified eluent composition and eluent itself contained in the recycled mixture following each sequential delivered intermittent amount;
3. as said eluent from the following delivered intermittent amount being treated and drained, hence further carrying out sorption of said one particular component and one other components among said components onto said solid phase packing at further apart locations along each draining passage; as after said liquid has completed delivering in said intermittent amounts and drained through said solid phase packing material to allow said components contained in the delivered liquid to be separated;
4. supplying broad range of pressurized inert gas following each delivered intermittent liquid amount at the cell top to affiliate prompt liquid draining and while maintaining a vacuum at the outlet of the cell disposed in said separation module so as to maintain the packing material in semi-dry condition, wherein semi-dry condition is defined as the packing material having wet surfaces but with no liquid filling interstices of the material;
5. therefore, after completing delivering in sequence in said order of said feed solution and recycled mixtures and eluent, said one component and at least one other component contained in the feed solution can be migrated and separated through carrying out the sorption onto the solid phase packing material, and then through sequential elution by delivering said plurality of recycled mixtures and at least one eluent contained in respective holding tank in said sequential order, into said one particular enriched component at least one product and one other enriched component at least one by-product and said plurality of recycled mixtures that one particular recycled mixture has said specific composition of said components dissolved in drained solution and eluent for recycling; and further wherein
D. providing said downstream rotary union module as bridging between bottom portion of said separation module and downstream holding tanks module and for simultaneous orderly receiving and holding the liquid while forwarding one rotational step then, amid rotary union module being in immobile status, simultaneous orderly transmitting various kind of liquid flow from respective bottom portion in said separation module to said respective disposed holding tank in said downstream holding tanks module via rotation and positioning together with seal mechanism;
E. further providing said downstream holding tanks module containing at least one product holding tank for respectively holding said one particular enriched component product, containing at least one by-product holding tank for respectively holding at least one other enriched component by-product, and containing a plurality of recycled mixtures orderly contained in each of a plurality of holding tanks, so that, each tank contains one particular recycled mixture that has a specific composition of said components dissolved in drained solution and eluent collected from bottom portion of said separation module for recycling back to said respective holding tank orderly disposed in said upstream holding tanks module; and
F. distributing during each duration of said time period the drained liquid to a corresponding one of the holding tanks disposed in said upstream holding tanks module containing
1. a liquid that has a specific composition of said components dissolved in drained solution and eluent, which is the composition of said components contained in the drained liquid for recycling;
2. so that, while delivering, in said sequential order during the duration of a particular time period, a liquid from among said all kind of liquids that include said feed solution and recycled mixtures the drained liquid collected during same time period and eluent, is respectively distributed to a corresponding one holding tank disposed in specific zone defined in upstream holding tanks module that is a specific composition of said components dissolved in drained solution and eluent; all of which are the composition of said components contained in the drained liquid disposed in respective zone in a specified order, feeding zone, regeneration zone, and washing zone;
3, wherein said each holding tanks disposed in said downstream holding tanks contains one particular recycled mixture that has a specific composition of said components dissolved in drained solution and eluent for recycling, at least one product holding tank for respectively holding said one particular enriched component product and by-product holding tank for respectively holding at least one other enriched component by-product.

21. The process of claim 20 wherein said cell defined in new mass transfer equilibrium contact method containing predetermined solid phase resin/adsorbent amount is distributed in single column as cell itself, such column having an inlet on top side and an outlet on another side with bottom meshed filter to contain equal amount of said resin/adsorbent from being drained; wherein such column retaining defined amount of resin/adsorbent solid material being corresponding to resin/adsorbent installed as mass transfer zone in chromatography to fully saturated with prefixed feed solution throughput; the liquid inlet of cell is from top and liquid outlet of cell is from bottom.

22. The process of claim 20 wherein said feed solution containing one component with at least one other component in defined composition mixed in an eluent in contact with solid phase particulate resin/adsorbent by sorption and sequential elution of various modified eluent composition is a particulate ion exchange resin/adsorbent.

23. The process of claim 20 wherein said feed solution containing one component with at least one other component in defined composition mixed in an eluent in contact with solid phase particulate resin/adsorbent by sorption and sequential elution of various modified eluent composition is a particulate reverse phase resin/adsorbent and eluent is de-ionized pure water.

24. The process of claim 20 wherein said liquid input S-I format is defined as a plurality of predetermined input volume amount of same mobile phase parametric condition are simultaneously and intermittently delivered from holding tanks disposed in same zone in said upstream holding tanks within said minimal time interval defined in general procedures to carry out said new mass transfer equilibrium contact method into each corresponding cell located in said separation module.

25. The process of claim 20 wherein said input I-I mode is defined as that a plurality of predetermined volume of “discrete increments” of mobile phase parametric conditions are simultaneously and intermittently delivered from holding tanks disposed in same zone in said upstream holding tanks into each corresponding cell located in said separation module within the minimal time interval defined in general procedures to carry out said new mass transfer equilibrium contact method, and wherein said differential increments of mobile phase conditions are predetermined between two designate levels of parametric condition that are orderly grouped with each corresponding cell in such zone.

26. The process of claim 20 wherein said modified eluent composition having selected discrete increment of parametric condition for respective composition of eluent, thus, resulting individual adsorbed components having discrete iso-point equilibrium state of difference in parametric condition is to mix eluent with less polar solvent to lowering polarity of modified eluent water thus to increase solubility of adsorbed component to desorb and elute with surrounding modified eluent.

27. The process of claim 26 wherein said mixing eluent water with less polar organic solvent to lowering polarity of eluent is mixing with increasing volume percentage of less polar organic solvent like methanol or acetonitrile in range between 5% to 95% in predetermined discrete increment in volume percentage of selected organic solvent.

28. The process of claim 20 wherein said feed solution containing one component with at least one other component in defined composition mixed in an eluent in contact with solid phase particulate resin/adsorbent by sorption and sequential elution of various modified eluent composition is a particulate normal phase resin/adsorbent and eluent is non-polar solvent.

29. The process of claim 28 wherein said modified eluent composition having selected discrete increment of parametric condition for respective composition of eluent, thus, resulting individual adsorbed components having discrete iso-point equilibrium state of difference in parametric condition is to mix eluent with greater polar solvent to increasing polarity of modified eluent thus to increase solubility of adsorbed component to desorb and elute with surrounding modified eluent.

30. The process of claim 1 wherein said preferred mechanical flipper device for providing control of liquid and inert gas distribution, such device flipper disposed in liquid conduct comprising following, wherein
a. a circular rigid material wrapping around with rigid seal gasket means for top and bottom sealing purpose depending upon either upward or downward movement of such flipper;
b. said device flipper having a circular rigid centered stick piercing through a big enough sealed top centered circular channel supported by rigid wires means for holding such flipper setting in upright position disposed inside of said sealed top circular channel and confined within a shaped circular compartment aligned with internal wall of the liquid conduct; and
c. such said shaped circular compartment comprising following, wherein
a) a side conduct having a circular opening next to another circular opening means for providing such wide opening space to trap within, and such flipper freely moving upward to block fluid from passing through to hold the liquid amid exerted pressurized inert gas from bottom being turned on;
b) on the contrary, such flipper switches in downward position to allow fluid swiftly passing through said circular opening then through next opening amid exerted pressurized inert gas supplied from top being turning on whereas meanwhile exerted pressurized inert gas supplied from bottom being turning off.

31. The process of claim 1 wherein said a plurality of transit reservoir disposed in upstream rotary union module is in corresponding finite quantity with each disposed holding tanks in upstream holding tanks module, wherein such plurality transit reservoir being shaped like jar with wide enough top inlet opening to receive transmitted liquid via splashing over a less than 180 degree baffle disposed inside of said liquid reservoir that is underneath liquid conduct connected to said nipple disposed outside of said stationary annular channel, like an umbrella shape smoothly sliding down along inner wall into liquid reservoir, and wherein such liquid amount being held in said transit reservoir disposed in upstream rotary union module is by preferential pressure activated spring valve.

32. The process of claim 1 wherein said plurality of transit reservoir disposed in downstream rotary union module is in corresponding finite quantity with each disposed holding tanks in downstream holding tanks module, and such plurality transit reservoir being shaped like jar with wide enough top inlet opening to receive transmitted liquid via splashing over a less than 180 degree baffle disposed inside of said liquid reservoir that is underneath liquid conduct connected to said nipple disposed outside of said stationary annular channel, like an umbrella shape smoothly sliding down along inner wall into liquid reservoir, wherein such liquid amount being held in said transit reservoir disposed in downstream rotary union module is by preferential pressure activated spring valve.

33. The process of claim 1 wherein said rotation and positioning together with seal mechanism disposed in upstream rotary union module and downstream rotary union module via selected servo-motor to rotate said horizontal plate contained with plurality of equally mounted transit reservoirs via stretch bars in predetermined rotational stepwise direction and the direction of rotation and the range of one rotational step being preset; wherein such mechanism comprising;
a. said endless flattop reversed “U” shape stationary annular channel been secured and supported with curved inner rim and curved outer rim; wherein said curved inner rim being secured on inner-top railing having a center down-face half-oval shaped groove to match with inner-bottom railing having a center up-face half-oval shaped groove, combining both half-oval shaped groove to become an concentric inner oval-shaped circular tunnel; and wherein
b. curved outer rim being secured on outer-top railing having a center down-face half-oval shaped groove to match with outer-bottom railing having a center up-face half-oval shaped groove, combining both half-oval shaped groove to become an concentric outer oval-shaped circular tunnel matching; and wherein
c. predetermined quantity of circular balls with its diameter slightly larger than vertical height of said concentric inner and outer oval-shaped circular tunnel being laid within, resulting a gap small enough is formed for free mobilization of said horizontal circular plate driven via said centered mounted servo-motor;
d. there have selected circular shape O-ring type of seals in predetermined quantity being disposed inside a paired face-up and face-down half-circular concentric grooves becoming shaped as concentric circular tunnels to accommodate such seal with its diameter just big enough to seal said gaps in concentric outer oval-shaped circular tunnel and concentric inner oval-shaped circular tunnel, and wherein configuration of railings, steel balls, and predetermined quantity of O-ring seals furnishing both sufficient frictionless rotation and positioning together with seal mechanism for horizontal circular plate and providing minimal pressurized inert gas leakage for this rotation and positioning together with seal mechanism.

34. The process of claim 33 wherein said rotation and positioning together with seal mechanism disposed in upstream rotary union module and downstream rotary union module via selected servo-motor to rotate said horizontal plate contained with plurality of equally mounted transit reservoirs in predetermined rotational stepwise direction and the direction of rotation and the range of one rotational step; wherein driven force to achieve intermittent rotational mechanism can be in options by selective utilization of hydraulic actuator, pneumatic actuator, electric actuator, and optical sensor system to control such intermittent motion.

35. The process of claim 1 wherein said heat media circulation for maintaining modules disposed in said apparatus in a selected temperature range comprising at least one of following module, wherein
(a) plurality of holding tanks disposed in said upstream holding tanks having a manifold alike inlet and manifold alike outlet for the heat media circulation to maintain whole plurality of holding tanks in the selected temperature range, wherein each holding tank having a top liquid inlet extended outside upward of said heat media circulation jacket and bottom liquid outlet extended outside downward of said jacket;
(b) plurality of holding tanks disposed in said downstream holding tanks having a manifold alike inlet and manifold alike outlet for the heat media circulation to maintain whole plurality of holding tanks in the selected temperature range, wherein each holding tank having a top liquid inlet extended outside upward of said heat media circulation jacket and bottom liquid outlet extended outside downward of said jacket;
(c) plurality of cells disposed in said separation module in a particular pattern inside insulated heat media circulation jacket, such jacket has plurality of baffle plates vertically installed to confine each cell inside a predetermined compartment, such plate alternatively arranged to allow the heat media freely entering from one top inlet and exiting next top outlet into next cell compartment; so that heat media enters via a manifold alike of said insulated heat media circulation jacket, freely circulating through first cell confined in said separation module, then continue entering 2^{nd} cell, 3^{rd} cell until heat media stream passing through all confined cell compartments, then exits said jacket through a manifold alike to maintain all disposed cells in an predetermined temperature range.

36. The process of claim 35 wherein said heat media for maintaining modules disposed in said apparatus in a selected temperature range is water ranging in between 0 and 100-degree C., wherein brine or water with anti-freeze mixture is for lower temperatures below 0-degree C., and wherein selected mineral oil and other synthetic heat carrier is for higher temperatures than 100-degree C.

37. The process of claim 1 wherein via means of liquid distribution for discharging liquid stored in each holding tank disposed in downstream holding tanks module is volumetric pump.

38. The process of claim 1 said inert gas supply module means for mobile phase liquid streams transmitting mechanism comprising following:
A. providing closed vacuum environment loop is for aforesaid each cell bottom containing a transit liquid reservoir orderly disposed within said separation module being exposed to said vacuum environment to affiliate receiving dropped dose of treated liquid draining,
a. meanwhile to extracting mobile phase liquid enriched mist inert gas to maintaining said resin/adsorbent installed in each cell of separation module in a semi-dry status through means extracting mist enriched inert gas to dry inert gas via central vacuum pump exerted through its manifold alike via a preferential mist separator to recover such mist from enriched inert gas; meanwhile to create a heterogeneous contact as following dropped dose of liquid promptly sipping through stationary resin/adsorbent particles to meet criterion of said new mass transfer equilibrium contact method as treated liquid;
b. amid duration of whole time, such dry inert gas exiting mist separator being combined with pressurized dry air and deployed through an inert gas generator to obtain fresh dry inert gas stored in a steel tank vessel maintaining preferred broad range pressure level inert gas ready for deploying back to following modules;
B. providing upstream broad range inert gas supplying loop is for upstream holding tanks module and multiple cells top region in separation module;
a. via supplying said medium range pressurized inert gas out of said tank vessel via its gas line routing wherein through manifold alike disposed below said upstream holding tanks module to simultaneously deploying via respective gas pipe connected to bottom side liquid conduct of each holding tank, whereas low range pressurized inert gas supplying via its gas line routing wherein through manifold alike disposed above said upstream holding tanks module to simultaneously deploying via each gas pipe disposed next to liquid conduct on top side of each holding tank being shut off;
b. so that mechanical device said flipper 1 disposed around bottom side of said top side liquid conduct being opened to allow predetermined liquid volume transferred from assigned holding tank in said downstream holding tanks module via each said volumetric pump freely passing through top side liquid conduct, whereas mechanical device said flipper 2 disposed around bottom side of each holding tank being pushed upward to block liquid from flowing downward to temporarily store delivered liquid into each said holding tank disposed in said upstream holding tanks module;
c. further wherein as aforesaid operation being concluded, said medium range pressurized inert gas routing being promptly shut off; meanwhile simultaneously supplying said low range pressurized inert gas routing being turned on, together yet separately supplying high range pressurized inert gas via its gas line routing being turned on, wherein such high range pressurized inert gas routing through its gas line out of said vessel tank through manifold alike disposed above said separation module to simultaneously deploying via each gas pipe disposed around next to liquid conduct having a mechanical device said flipper 3 disposed around top inside, wherein both gas pipe and liquid conduct being disposed on top side of separation module;
d. via such operation resulting said flipper 1 disposed around bottom side of liquid conduct of each upstream holding tank and said flipper 3 disposed on top inside of liquid conduct disposed on top of separation module being both closed, whereas said flipper 2 disposed around bottom side of each holding tank being opened allowing entire liquid been stored within freely transferring from each said upstream holding tank via its bottom side liquid conduct into respective said transit reservoir orderly disposed in aforesaid upstream rotary union module;
e. said rotary valve body disposed in said upstream rotary union module promptly advancing one rotational step; wherein soon said upstream rotary union module valve body being stopped, said low pressure inert gas routing disposed top side of holding tanks module and high pressure inert gas routing disposed on top side of separation module both being promptly shut off; meanwhile simultaneously out of tank vessel to resume supplying said medium range pressurized inert gas routing together with yet separately supplying said high range pressurized inert gas, named as high range pressurized inert gas routing hereinafter out of said vessel tank through said inline gas temperature adjuster via its gas line routing through manifold alike disposed below aforesaid high range pressurized inert gas via each pipe disposed next to said liquid conduct disposed on top of separation module to supply of high pressurized inert gas, so that such operation resulting to simultaneously close said flipper 2 and said flipper 4, resulting simultaneously to transmit via said rotation and positioning together with seal mechanism entire liquid stored in respective transit reservoir of said valve body through opened flipper 3 into respective temporary transit reservoir located at top of said separation module;
f. further wherein soon aforesaid operation is completed, said high pressure inert gas routing is promptly turned on in a predetermined short time duration to close said flipper 3; whereas said warm high range pressurized inert gas routing meantime being shut off, resulting liquid stored inside respective temporary transit reservoir located at top of said separation module to simultaneously promptly passing freely through said flipper 4 to drop in parts of stored liquid during said very short time period to wet top portion of installed solid resin/adsorbent;
g. then, immediately soon high pressure inert gas supply through said temperature adjuster routing being turned on and whereas high range pressurized inert gas routing meanwhile being shut off, such operation means for pushing back said flipper 4 to stop liquid from dropping; means for pushing dropped dose of all kind of liquids through said resin/adsorbent contained in each cell to complete expected aforesaid new mass transfer equilibrium contact method between two phases;
h. alternatively repeating operation between on and or off supplying said two supplies of high range pressurized inert gas routing thus dividing stored liquid in temporary transit reservoir located at top of said separation module in predetermined liquid doses as means to proceed differential set-up between solid and liquid phase;
C. providing downstream broad range inert gas supplying loop is for multiple cells bottom region in separation module and downstream holding tanks module;
a. during duration of exerted vacuum environment via said vacuum exit pipe onto bottom region of said separation module in order to continuously and simultaneously drain treated doses of liquid into respective underneath liquid reservoir;
b. meanwhile, medium range pressurized inert gas routing deployed out of said tank vessel being turned on, via its gas line through manifold alike disposed underneath said separation module via each gas pipe connected to each liquid conduct disposed at bottom of said holding tank, such liquid conduct having preferred mechanical device said flipper 5 disposed around top inside; such operation resulting to push upward said flipper 5 via supplying medium pressure range inert gas to hold drained liquid stored in respective said liquid reservoir; wherein soon as liquid draining of entire liquid stored in respective transit reservoir through opened flipper 3 into respective temporary transit reservoir located at top of said separation module being completed, both vacuum environment and said medium range pressurized inert gas are promptly shut off;
c. then, low range pressurized inert gas routing supplied via its pipe disposed next to said vacuum exit pipe in same manifold and high range pressurized inert gas routing supplied via its pipeline through manifold alike disposed above said downstream holding tanks module being promptly turned on, such operation resulting both said flipper 65 disposed inside of said funneled liquid conduct and said flipper 6 disposed inside liquid conduct located on top of each liquid transit holding tank in said downstream holding tanks module being closed, whereas said flipper 5 disposed inside bottom liquid conduct of respective liquid reservoir being opened to allow entire stored liquid simultaneously freely pushing into each underneath liquid transit storage reservoir in said downstream rotatory union module;
d. said valve body in downstream rotary union module promptly advancing one rotational step; soon after multiple valve body being stopped, said medium pressure range inert gas via its routing promptly resume supplying; such operation resulting to close flipper 5 to push stored liquid in each liquid reservoir via said rotation and positioning together with seal mechanism through opened said flipper 6 into each assigned holding tank in said downstream holding tanks module.

39. The process of claim 38 wherein said driven force utilized for closing said flipper 2 disposed around top inside of said liquid conduct disposed underneath each holding tank in upstream holding tank module via supplying broad pressure range of inert gas via its respective gas pipe is preferred medium range pressurized inert gas, wherein is set in between 55 psi and 70 psi to hold entire liquid weight.

40. The process of claim 38 wherein said driven force utilized for closing said flipper 1 disposed bottom inside of said liquid conduct of each holding tank in upstream holding tank module via supplying broad pressure range of inert gas via its respective gas pipe is preferred low range pressurized inert gas, wherein is set in between 40 psi and 55 psi.

41. The process of claim 38 wherein said driven force utilized for alternatively closing said flipper 3 and either closing or opening of said flipper 4 via supplying preferred broad pressure range of inert gas through respective gas pipe to affiliate liquid draining thus removing mobile phase liquid filled among resin/adsorbent matrix and meanwhile to carry out expected new mass transfer equilibrium contact method is preferred high range pressurized inert gas, wherein is set in between 70 psi and 90 psi.

42. The process of claim 38 wherein said driven force utilized for closing said flipper 65 disposed around bottom inside of said funneled liquid conduct of bottom portion of separation module via supplying broad pressure range of inert gas via its respective gas pipe is preferred low range pressurized inert gas, wherein is set in between 40 psi and 55 psi.

43. The process of claim 38 wherein said driven force utilized for closing said flipper 5 disposed around bottom inside of said liquid conduct underneath separation module via supplying broad pressure range of inert gas via its respective gas pipe is preferred medium range pressurized inert gas, wherein is set in between 55 psi and 70 psi.

44. The process of claim 38 wherein said closed vacuum environment loop for maintaining solid resin/adsorbent material in semi-dry status, wherein preferred vacuum level is set in between 15 in-Hg to 27 in-Hg and wherein exerting such vacuum from cell bottom is to remove mobile phase liquid filled among resin/adsorbent matrix within short possible time duration period.

45. The process of claim 38 wherein said driven force utilized for closing said flipper 6 disposed around top inside of said liquid conduct of each holding tank in downstream holding tank module via supplying broad pressure range of inert gas via its respective gas pipe is preferred high range pressurized inert gas, wherein is between 70 psi and 90 psi.

46. The process of claim 38 said broad range pressurized inert gas, wherein preferred inert gas used for this disclosed apparatus is nitrogen, carbon dioxide, argon, and mixtures of gas in portions thus to reduce oxygen oxidation with resin/adsorbent from hindering long term separation efficiency.

47. The process of claim 38 said broad range pressurized inert gas, wherein preferred inert gas used for this disclosed apparatus is air.

48. The process of claim 38 wherein said inert gas supply module means for mobile phase liquid streams transmitting mechanism is the sub-module integrated with said separation module to incorporate with aforesaid other modules through which during duration of each spent time interval in steady state operation, all kind of liquid solutions simultaneously distributed entire available liquid solution from respective holding tank disposed orderly in upstream holding tanks module through each transit reservoir disposed orderly in upstream rotary union module, and simultaneously intermittently transmitted into respective cell body in separation module to carry out new mass transfer equilibrium contact method; treated and collected liquid in each transit reservoir transferred via each transit reservoir disposed orderly in downstream rotary union module into each holding tank disposed orderly in downstream holding tanks module; through such organized liquid transmitting in a repeated manner via inert gas supplying module incorporated with disclosed apparatus comprising multiple modules connected in sequence in a close loop to achieve repeated separation cycle of target system.

49. The process of claim 1 wherein operation of multiple modules in parallel being deemed as part of said apparatus, wherein means for disposing multiple separation modules organized in parallel simultaneous operation during duration of each spent time interval amid steady state operation; whereas predetermined volume amount of all kind of liquids being transported via other single module connected in sequence from each holding tank in upstream holding tanks module via upstream rotary union module to satisfied designated throughput of multiple separation modules organized in parallel simultaneous operation disposed in said apparatus.

50. The process of claim 20 wherein said differential set-up protocol employed onto said apparatus comprise the following methods:
(a) determining optimal full-strength bonding capacity of said resin/adsorbent with a prefixed feed throughput and divide such amount by a preselected number that is to differentiate resin/adsorbent in equal sub-amount disposed in at least one column bundled in a single cell and preselected said number is equal to quantity of column disposed in said single cell disposed in each zone to simultaneously receive partial volume amount of said multiple liquid dropped doses for each cell in said group of cells disposed in particular zone;
(b) to produce a characteristic elution profile denoted in time domain through predetermined type of said liquid dispenser in general procedures of selected input format between said input S-I and input I-I via said new mass transfer equilibrium contact method by intermittently delivering a predetermined volume amount of the feed solution containing one component and at least one other component into said cell, then following through said new mass transfer equilibrium contact method after feed solution introduction by intermittently delivering been arranged in a particular order a predetermined volume amount of said a plurality of recycled streams and an eluent liquid to sequentially elute adsorbed components to obtain one particular enriched component of at least one product, to obtain one other enriched component at least one by-product; and to obtain a plurality of recycled mixtures that one particular recycled mixture has a specific composition of said components dissolved in drained solution and eluent for recycling; and
(c) sequentially breaking down the elution profile along total accumulated time domain in sub-time required to spend for respective mobile phase solution input for respective zone including most time-consuming zone and less time consuming zone for various type of input liquid;
(d) divide each sub-time by said minimal time interval to obtain the range as quantity of cells disposed for respective zone;
(e) then, divide total input volume amount of such liquid by the quantity of cells to obtain the partial volume amount required for each cell in respective zone; further divide such said partial volume amount by a preselected number means for said multiple liquid doses to further differentiate as multiple sequential liquid dropped doses to simultaneously proceed general procedures of said new mass transfer equilibrium contact method orderly sipping in sequence through disposed resin/adsorbent in each cell disposed in said separation module;
(f) allocating all cells with each respective liquid as the range of a particular zone;
(g) sequentially arranging all zones in the same order for all kinds of delivered liquids in an endless circular format in said apparatus; wherein integrating all zones orderly arranged in such endless format representing a complete elution profile separation cycle amid each spent of said minimal time interval via said upstream rotary union module and downstream rotary module to transmitting all kind of mobile phase parameter solution into underneath stationary separation module is to simulate all cells disposed in a simulated horizontal moving direction whereas mobile phase is simultaneously traveling in vertical direction, and further
(h) sequentially preparing predetermined volume amount of whole spectrum of recycled liquids of step (b) into respective holding tank in said downstream holding tanks module for supporting liquid distribution as said closed loop via said upstream holding tanks module, upstream rotary union module, separation module, downstream rotary union module, then back to downstream holding tanks module via driving force provided from said mobile phase liquid streams transmitting mechanism.

51. The method of claim 50 wherein said preselected number in step (a) and step (e) is a finite whole number greater than one; including one.

52. The process of claim 1 wherein said single stage recycle protocol employed onto said apparatus through general procedures of said new mass transfer equilibrium contact method and differential set-up protocols between two phases to simultaneously transmitting all kind of liquid including feeding feed solution containing one component and at least one other component and a plurality of each recycled mixture containing specific composition of said components dissolved in drained solution and eluent liquid for simultaneously retrieving multiple streams including one particular enriched component of at least one product, one other enriched component of at least one by-product, and a plurality of each recycled mixture containing specific composition of said components dissolved in drained solution and eluent for recycling, via said single stage recycle protocol comprising following methods, wherein
A. through means of said close loop of liquid delivery beginning via downstream holding tanks module through upstream holding tanks module affiliated with pressurized inert gas supply module, and means of rotation and positioning together with seal mechanism in said upstream rotary union module, completing new mass transfer equilibrium contact method in separation module then through means of rotation and positioning together with seal mechanism in said downstream rotary union module back to downstream holding tanks module, said apparatus completing start-up operation procedures containing following procedures;
(i) a cell containing plurality of orderly disposed columns initially located at first position among all cells of said separation module receiving a predetermined volume amount of liquid delivery and remaining cells receiving no liquid; wherein delivering a predetermined volume amount of said various kinds of liquids having been arranged in a particular sequential order among all kinds of recycling streams, a feed solution from its source, and another plurality of recycling stream arranged in a particular order, then an eluent liquid from its source, and lastly inert gas to flush thus drain remaining liquid; wherein all above said liquids being transmitting, affiliating with supply of broad range of pressurized inert gas, in orderly sequence simultaneously from particular holding tank disposed in said downstream holding tanks module into assigned holding tank in said upstream holding tanks module and through corresponding transit reservoir in said upstream rotary union module; and further wherein valve body in said upstream rotary union module advance one rotational step through means of said rotation and positioning together with seal mechanism, then amid said module being in immobile status, transmitting received liquid into assigned respective cell top portion in said separation module;
(ii) intermittently deliver through means of alternated supplying between two separated broad range of pressurized inert gas routings following each simultaneous delivery of various liquids in sequential dose of predetermined volume amount to force draining of each dose dropped liquid promptly sipping through said resin/adsorbent to complete expected new mass transfer equilibrium contact method between two phases;
(iii) meanwhile maintaining a vacuum environment to drain treated liquid solution into respective underneath temporary reservoir thus to maintain resin/adsorbent installed in said multiple columns disposed in each cell in a semi-dry status;
(iv) intermittently collecting of all kind of drained liquids in each temporary reservoir and transmitting collected each liquid into said downstream rotary union via means of said broad range of pressurized inert gas supply routing; valve body disposed in said downstream rotary union advance one rotational step through means of said rotation and positioning together with seal mechanism in predetermined rotating direction, then, via means of broad range of pressurized inert gas supply routing amid said module being in immobile status to push entire liquid simultaneously into each assigned holding tank disposed in said downstream holding tanks module;
(v) repeating repeatedly step (i) through step (iv) for initially located at first position of said separation module, then covering first and second cell in separation module simultaneously receiving liquid until transit reservoir disposed first receiving liquid disposed in said upstream rotary union module and first receiving liquid of transit reservoir disposed in said downstream rotary union module return to its initial position to complete one revolution, so that, start-up operation can be concluded, wherein retrieved all kinds of liquids during start-up operation as one particular enriched component of at least one product holding in product holding tank, and one other enriched component at least one by-product holding in each by-product holding tank; and a plurality of recycled mixtures that one particular recycled mixture has a specific composition of said components dissolved in drained solution and eluent holding in particular order of each holding tank for recycling via means of transmitting into each corresponding holding tank in said upstream holding tanks module; and further proceeding
B. steady state operation containing following simultaneous and repeatedly repeated procedures during duration of each spent time interval; wherein
(i) through means of aforesaid liquid delivery mode affiliating with broad range of pressurized inert gas, a predetermined volume of various kinds of liquids having been arranged in a particular order among all kinds of recycling streams, feed solution from its source, and another plurality of recycling stream arranged in a particular order, an eluent liquid from its source, and a pressurized inert gas to flush thus drain remaining liquid; all above said liquids being transmitted simultaneously entire available liquid volume from respective holding tank disposed in said upstream holding tanks module via means of broad range of pressurized inert gas supply routing forcing into respective transit reservoir in said upstream rotary union module; said valve body advance one rotational step through means of said rotation and positioning together with seal mechanism in predetermined rotating direction, then amid said module being in immobile status via said liquid delivery mode transmitting affiliated with broad range of pressurized inert gas routing into each assigned underneath cell's top-inlet of said separation module;
(ii) intermittently deliver through means of alternated supplying between two separated broad range of pressurized inert gas routings following each simultaneous delivery of various liquids in sequential dose of predetermined volume to force draining of each dose dropped liquid promptly sipping through said resin/adsorbent to complete expected new mass transfer equilibrium contact method between two phases;
(iii) meanwhile maintaining a vacuum environment to drain treated liquid solution into respective underneath temporary reservoir thus to maintain resin/adsorbent installed in said multiple columns disposed in each cell in a semi-dry status;
(iv) collecting all kind of drained liquids in each temporary reservoir and transmitting collected liquid into said downstream rotary union via means of broad range of pressurized inert gas supply routing; valve body disposed in said downstream rotary union advance one rotational step through means of rotation and positioning together with seal mechanism in predetermined rotating direction, then amid said module being in immobile status via means of broad range of pressurized inert gas supply routing to push entire liquid simultaneously into each assigned holding tanks in said downstream holding tanks module; wherein each liquid as one particular enriched component of at least one product holding in each product holding tank, and one other enriched component at least one by-product holding in each by-product holding tank; and transmitting all kind of a plurality of recycled mixtures that one particular recycled mixture has a specific composition of said components dissolved in drained solution and eluent holding in particular order of each holding tank for recycling via each assigned holding tank in said downstream holding tanks module via means of respective liquid routing back to each corresponding holding tank in said upstream holding tanks module;
C. termination operation is the reverse procedures of start-up operation for generating resin/adsorbent installed in the separation module back to fresh semi-dry throughout disclosed apparatus comprises following; wherein
(i) a cell containing plurality of orderly disposed columns initially located at first position among all cells of said separation module stop receiving a predetermined volume of liquid delivery and remaining cells simultaneously continue receiving liquid; wherein delivering a predetermined volume amount of said various kinds of liquids having been arranged in a particular sequential order among all kinds of recycling streams, a feed solution from its source, and another plurality of recycling stream arranged in a particular order, then an eluent liquid from its source, and lastly inert gas to flush thus drain remaining liquid; wherein all above said liquids being transmitting, affiliating with supply of broad range of pressurized inert gas, in orderly sequence simultaneously from particular holding tank from said downstream holding tanks module into particular holding tank in said upstream holding tanks module and through particular transit reservoir in said upstream rotary union module; and further wherein valve body in said upstream rotary union module advance one rotational step through means of said rotation and positioning together with seal mechanism, then amid said module being in immobile status transmitting received liquid into assigned respective cell top portion in said separation module;
(ii) intermittently deliver through means of alternated supplying between two separated broad range of pressurized inert gas routings following each delivery of various liquids in dose of predetermined volume to force draining of dose dropped liquid promptly sipping through said resin/adsorbent to complete expected new mass transfer equilibrium contact method between two phases;
(iii) meanwhile maintaining a vacuum environment to drain treated liquid solution into respective underneath temporary reservoir thus to maintain resin/adsorbent installed in said multiple columns disposed in each cell in a semi-dry status;
(iv) intermittently collecting of all kind of drained liquids in each temporary reservoir and transmitting collected liquid into said downstream rotary union via means of said broad range of pressurized inert gas supply routing; valve body disposed in said downstream rotary union advance one rotational step through means of said rotation and positioning together with seal mechanism in predetermined rotating direction, then amid said module being in immobile status via means of broad range of pressurized inert gas supply routing to push entire liquid simultaneously into each assigned holding tank disposed in said downstream holding tanks module;
(v) repeating repeatedly step (i) through step (iv) for initially located at first position of said separation module, then covering first and second cell in separation module simultaneously stop receiving liquid until transit reservoir disposed first receiving liquid disposed in said upstream rotary union module and first receiving liquid of transit reservoir disposed in said downstream rotary union module return to its initial position to complete one revolution, so that, termination operation is concluded to producing installed resin/adsorbent back to initial fresh semi-dry status disposed in said apparatus.

53. The method of claim 52 wherein said providing broad range of pressurized inert gas via its routing having pressure rage in between 40 psi and 90 psi, and wherein preferred low range inert gas pressure is set in between 40 psi and 55 psi, wherein preferred medium range inert gas pressure is set in between 55 psi and 70 psi, and further wherein preferred high range inert gas pressure is set in between 75 psi and 90 psi.

54. The process of claim 1 wherein for elevating weight load upon moving components disposed in said upstream rotary union module and downstream rotary union module by breaking down said modules into equal portions in parts as multiple sub-modules, so that there has more available surface area in said horizontal circular plate to install proportionally increased in size of said transit reservoir disposed in respective sub-rotary module; further wherein for maximizing holding capacity for said temporary liquid transit reservoir is not limited to cylindrical column, but other selected column shape to maximize fitting predetermined space for said transit reservoirs being evenly mounted in each predetermined location.

55. A generalized separation process is operated to eliminate displacement zone in chromatographic sequential operation via single cell for separating at least one desired component from a liquid solution mixture containing one component and at least other component named as mobile phase feed solution via beginning to obtain a characteristic separation profile by carrying out a new mass transfer equilibrium contact method transmitting liquid feed solution mobile phase in contacting with a solid phase resin/adsorbent packing material, so that at least one of component contained in said liquid feed solution can be adsorbed onto resin/adsorbent, subsequently via said new mass transfer equilibrium contact method to transmit at least of second and third mobile phases of various kind liquid solutions comprising predetermined composition in sequential contact with said resin/adsorbent, so that, at least two of components are desorbed one after thereof; and wherein generalized separation process comprise following hybrid embodiments as general procedures of new mass transfer equilibrium contact method between solid and liquid mobile phase employed by an apparatus operating via differential set up and through single stage recycle protocol; thus
A. starting with determining optimal full-strength bonding capacity of resin/adsorbent with a prefixed feed solution throughput and such solid phase amount is equivalent to mass transfer zone in chromatography to carry out above said mass transfer mechanism; wherein retaining predetermined solid phase resin/adsorbent amount distributed equally in a bundled group of predetermined quantity of columns, each column having an inlet on top side and an outlet on another side with bottom meshed filter to contain equal amount of said resin/adsorbent from being drained; such bundled group of columns performing like partially fluidized beds as a whole unit being named as aforesaid single cell hereinafter; wherein each column retaining equal amount of resin/adsorbent solid material as plurality of columns installed in said single cell and sum amount of each disposed resin/adsorbent being corresponding to resin/adsorbent installed as mass transfer zone in chromatography to fully saturated with prefixed feed solution throughput; the liquid inlet of cell is from top and liquid outlet of cell is from bottom;
1. intermittently delivering predetermined amounts of mobile phase liquid material through predetermined type of liquid dispenser in portion as predetermined input format dose dropping amid predetermined first time period including mobile phase feed solution, at least of second and third mobile phases of various kind of liquid solutions comprising predetermined composition in sequential contact with said resin/adsorbent to promote predetermined new mass transfer equilibrium contact method either promoting adsorption of dissolved components onto said resin/adsorbent or eluting adsorbed components from said resin/adsorbent;
2. intermittently supplying broad range pressurized inert gas to a cell top side following each delivery of said mobile phase dose means amid predetermined second time period for maintaining sufficient pressure to force prompt draining such mobile phase liquid percolate through said solid phase material to complete expected new mass transfer equilibrium contact method;
3. maintaining a vacuum environment on the other side of said solid phase material installed in said cell meanwhile amid spent time during step (2) to maintain resin/adsorbent material in a semi-dry status; wherein said broad range pressurized inert gas being supplied from cell top and whereas vacuum meanwhile being exerted from cell bottom;
4. collecting most of treated mobile phase liquid material meanwhile amid spent time during step (2) from the outlet of cell bottom;
5. defining in sum of spent time amid step (1) through step (4) as minimal time interval; wherein said generalized separation process further proceed
B. via aforesaid new mass transfer equilibrium contact method to obtain a characteristic separation profile for particular separation system wherein amount of said resin/adsorbent is predetermined and being maintained in said semi-dry status as full-strength bonding capacity with a predetermined solution amount comprising a plurality of components and disposed in equal sub-amount in a plurality of column in said single cell, wherein a method for separating said plurality of components contained in at least one of first mobile phase stream comprising a liquid solution of said components by contacting a solid phase resin/adsorbent with the at least one mobile phase stream in sequence, so that at least one of component being adsorbed by the resin/adsorbent, and wherein mobile phase being delivered through predetermined type of liquid dispenser and combination of selected liquid input format, wherein input S-I mode is defined as that predetermined amounts of same mobile phase parametric condition solution is delivered within the said minimal time interval into said cell, and wherein mobile phase being delivered through predetermined type of liquid dispenser and selected liquid input format, wherein input I-I is defined as that predetermined amounts of “discrete increments” of mobile phase parametric condition solutions are delivered into said cell within said minimal time interval, by options of said input S-I, wherein
a. contacting said resin/adsorbent with at least one amount of first mobile phase stream illustrated in step (1) through step (5) of step A and define total cumulated minimal time interval as first mobile phase zone; subsequently
b. contacting said resin/adsorbent with at least one amount of second mobile phase stream in sequence, each second stream comprising liquid eluent of predetermined composition to reach expected new mass transfer equilibrium contact method such that at least one of component is individually desorbed from the resin/adsorbent in sequence illustrated in step (1) through step (5) of step A and total cumulated minimal time interval is defined as second mobile phase zone; subsequently;
c. contacting said resin/adsorbent with at least one of third mobile phase stream in sequence, each third stream comprising liquid eluent of predetermined composition to reach expected new mass transfer equilibrium contact method such that at least one of component is individually desorbed from the resin/adsorbent in sequence illustrated in step (1) through step (5) of step A and total cumulated minimal time interval is defined as third mobile phase zone;
d. repeating step (c) of step B by contacting said resin/adsorbent with at least one amount of fourth mobile phase stream if remaining components still remained been adsorbed with said resin/adsorbent, such that components can be eluted by predetermined composition to reach expected new mass transfer equilibrium contact method such that remaining components is individually desorbed from the resin/adsorbent in sequence; otherwise,
e. contacting said resin/adsorbent with at least one amount of at least one of said drained and collected first mobile phase liquid stream in step (a) of step B to the inlet of the cell in sequence illustrated in in step (1) through step (5) of step A and total cumulated minimal time interval is defined as last mobile phase zone; and
f, wherein lastly to integrate all defined zones in sequential prevail with respect to mobile phase parametric condition in time domain to conclude obtaining characteristic separation profile for particular separation system via input S-I;
C. further wherein said new mass transfer equilibrium contact method is to deliver mobile phase in format by options of said input I-I as following;
1) contacting said resin/adsorbent with at least one amount of first mobile phase stream illustrated in step (1) through step (5) of step A and define total cumulated minimal time interval as first discrete mobile phase zone; subsequently repeating this step by increasing a discrete increment of mobile phase parametric conditions until all of said at least one amount of first mobile phase stream being adjusted with preset incremental discrete delivered in sequence and total cumulated minimal time interval is defined as multiple first discrete mobile phase zone named in sequential order corresponding to respective delivered mobile phase parametric condition; subsequently
2) contacting said resin/adsorbent with at least one amount of second mobile phase stream in sequence, each second stream comprising liquid eluent of predetermined composition in discrete increment of parametric condition to reach expected new mass transfer equilibrium contact method such that at least one of component is individually desorbed from the resin/adsorbent in sequence illustrated in step (1) through step (5) of step A and total cumulated minimal time interval is defined as second discrete mobile phase zone; repeating this step by increasing a discrete increment of mobile phase parametric conditions until all of said at least one amount of second mobile phase stream being adjusted with preset incremental discrete delivered in sequence and total cumulated minimal time interval is defined as multiple second discrete mobile phase zone named in sequential order corresponding to respective delivered mobile phase parametric condition; subsequently
3) contacting said resin/adsorbent with at least one amount of third mobile phase stream in sequence, each third stream comprising liquid eluent of predetermined increment of mobile phase parametric composition to reach expected new mass transfer equilibrium contact method such that at least one of component is individually desorbed from the resin/adsorbent in sequence illustrated in step (1) through step (5) of step A and total cumulated minimal time interval is defined as third discrete mobile phase zone; repeating this step by increasing a discrete increment of mobile phase parametric conditions until all of said at least one amount of third mobile phase stream being adjusted with preset incremental discrete delivered in sequence and total cumulated minimal time interval is defined as multiple third discrete mobile phase zone named in sequential order corresponding to respective delivered mobile phase parametric condition; subsequently
4) contacting said resin/adsorbent with at least one amount of fourth mobile phase stream if remaining components still been adsorbed with said resin/adsorbent, such that components can be eluted by predetermined composition with discrete increment of mobile phase parametric condition to reach expected new mass transfer equilibrium contact method such that remaining components is individually desorbed from the resin/adsorbent in sequence;
5) otherwise, contacting said resin/adsorbent with at least one amount of said drained and collected first mobile phase liquid stream in step (1) of this input format I-I amid predetermined first time period to the inlet of said cell in sequence illustrated in step (1) through step (5) of step A and total cumulated minimal time interval is defined as last mobile phase zone; and
6) wherein lastly to integrate all defined zones in sequential prevail with respect to mobile phase parametric condition in time domain to conclude obtaining characteristic separation profile for particular separation system via input I-I; further wherein
D. an apparatus employed for integrating multiple modules contained in a closed loop connected in sequence yet functioning independently as a whole unit, such apparatus comprising at least one of following module, wherein
1) providing upstream holding tanks module, wherein
a. having a plurality of holding tanks disposed in an organized order setting inside an insulated heat media circulation jacket to maintain whole plurality in a selected temperature range;
b. each said holding tank of whole plurality having an inlet liquid conduct extended outside upward of said jacket to receive liquid via an preferred mechanical device opened flipper, named as flipper 1 hereinafter disposed about bottom inside of said liquid conduct;
c. each of said whole plurality holding tanks having an outlet liquid conduct extended outside downward of said jacket installed with a preferred pressure activated check valve disposed about top inside of said liquid conduct to hold the received liquid or to discharge liquid into following module amid exerted pressure;
2) providing separation module, wherein
(a) single cell comprising predetermined quantity of columns orderly disposed inside said cell; each column having an top side inlet and a bottom side outlet with meshed filter to contain equal amount of resin/adsorbent material from being drained;
(b) said single cell disposed inside an insulated heat media circulation jacket to maintain said cell in a selected temperature range;
(c) said single cell top having an inlet liquid conduct as temporary transit reservoir extended outside upward of said heat media circulation jacket to receive particular liquid delivered from corresponding holding tank in said upstream holding tanks module through an opened flipper, named as flipper 3 hereinafter disposed around top inside of said liquid transit storage reservoir, through liquid pipe delivering respective liquid through predetermined type of liquid dispenser down below; such dispenser comprising of another preferred mechanical device flipper, named as flipper 4 hereinafter disposed inside in between bottom side of said temporary transit reservoir and top side of the liquid dispenser;
(d) said single cell bottom being exposed to said vacuum environment containing a transit reservoir with its widely open top means to withdraw mist enriched inert gas via its gas exit pipe connect to a manifold to maintain said resin/adsorbent in a semi-dry status, meanwhile to affiliating liquid draining via disposed funneled shape liquid conduct through;
(e) another opened mechanical flipper, names as flipper 65 hereinafter disposed inside bottom of said funnel conduct, into underneath temporary liquid reservoir; having a gas pipe connected with same manifold next to said mist enriched inert gas exit pipe means for supplying broad range pressurized inert gas via this manifold to shut off said flipper 65 soon said vacuum environment being turned off, so that pushing entire drained liquid into following module via a preferred pressurize activated check valve disposed around top inside of said bottom liquid conduct, wherein said inert gas manifold being disposed underneath said vacuum environment and being extended outside downward of said insulated heat media circulation jacket;
3) providing downstream holding tanks module, wherein
(a) having a plurality of holding tank disposed in an organized order setting inside an insulated heat media circulation jacket to maintain whole plurality of holding tanks in a selected temperature range and each tank having an inlet liquid conduct extended outside upward of the insulated heat media circulation jacket;
(b) each of said whole plurality holding tanks comprising an outlet liquid conduct installed with said preferred pressure activated check valve extended outside downward of said jacket means for discharging stored liquid via each means of liquid distribution;
(c) having a liquid level sensor installed inside each of said whole plurality holding tanks to monitor predetermined liquid level of stored liquid within for following;
(i) means such level sensor is to control delivering sufficient volume amount of particular solution via liquid conduct disposed on top of such holding tank to maintain a predetermined liquid level setting in respective holding tank and holding received respective liquid;
(ii) means for at least one isolated product into respective assigned storage tank;
(iii) means for discharging components in particular solution mixture as by product into respective assigned storage tank; and
(iv) means for transmitting in part of separated component stored in respective holding tank in predetermined volume recycling back into each assigned holding tank in aforesaid upstream holding tanks module; further wherein;
4) providing inert gas supply module means for mobile phase liquid streams transmitting mechanism for close loop routing supplying broad range pressurized inert gas inasmuch as incorporating with liquid fluid transmitting among said upstream holding tanks module, separation module, and downstream holding tanks module, wherein such module contain closed vacuum environment loop, upstream broad range inert gas supplying loop, and downstream broad range inert gas supplying loop;
(a) proceeding closed vacuum environment loop comprising following procedures,
(i) said single cell bottom been exposed to said vacuum environment to affiliate dropped dose liquid draining, meanwhile to extracting mobile phase liquid enriched mist inert gas to maintain said resin/adsorbent in semi-dry status through means extracting mist enriched inert gas to dry inert gas via driving force exerted from central vacuum pump through gas pipe via a selected mist separator to recover such mist from enriched inert gas;
(ii) meanwhile to create a heterogeneous contact as following dropped dose of liquid promptly sipping through stationary resin/adsorbent particles to meet criterion of said new mass transfer equilibrium contact method;
(iii) amid whole time, dry inert gas exiting mist separator being combined with pressurized dry air and deployed through an inert gas generator to obtain fresh dry inert gas and stored in a steel tank vessel maintaining preferred broad range of pressure level inert gas ready deploying back to following modules;
(b) proceeding upstream broad range inert gas supplying loop means for upstream holding tanks module and said single cell top region in separation module wherein comprising following procedures,
(i) stop supplying broad pressure range of inert gas through its respective gas pipe disposed around each said holding tank top side to allow predetermined liquid volume transferred from assigned holding tank in said downstream holding tanks module via each said volumetric pump freely passing through top side liquid conduct; soon is completed; subsequently
(ii) closing such flipper 1 via supplying broad pressure range of inert gas to push opening said pressure activated check valve to discharge received liquid into said cell top temporary transit reservoir located at top of said separation module; soon is completed; subsequently
(iii) via means of alternatively and simultaneously supplying of broad range pressurized inert gas through gas pipe connected in between said flipper 3 and flipper 4 of said temporary transit reservoir and another gas pipe disposed next to said temporary transit reservoir to intermittently dose dropping in parts of received liquid out of temporary transit reservoir resulting as predetermined said liquid input format to promptly wet top portion and promptly sipping through resin/adsorbent bed to carry out expected new mass transfer equilibrium contact method;
(c) proceeding downstream broad range inert gas supplying loop means for said single bottom region in separation module and downstream holding tanks module wherein comprising following procedures
(i) during duration of exerted vacuum environment to continuously drain treated doses of liquid into underneath liquid reservoir and said preferred pressure activated check valve holding drained liquid within; soon as liquid draining of entire transmitted liquid being completed; subsequently;
(ii) shutting off vacuum environment, supplying low range pressurized inert gas routing via its pipe disposed next to said vacuum exit pipe in same manifold to close said flipper 65 to allow entire collected liquid freely pushing through opened said pressure activated check valve through liquid line connected to assigned holding tank in said downstream holding tanks module;
E. as illustrated wherein differential set-up protocols employed via illustrated in step (1) through step (5) of step A for general procedures of new mass transfer equilibrium contact method onto aforesaid predetermined cell construction of step A to carry out by predetermined combination of selected mobile phase between in-put S-I and in-put I-I format to obtain a characteristic separation profile for particular separation system between selected resin/adsorbent related with various kinds of mobile phase liquid material illustrated in step B and step C into aforesaid apparatus comprising said single cell to separate at least one desired component from a liquid solution amid in sum of accumulated multiple minimal time interval in time domain, wherein following is said differential set-up protocol employed onto said apparatus, wherein
1. determining optimal full-strength bonding capacity of said resin/adsorbent with a prefixed feed throughput and filling such resin/adsorbent amount into a said cell contain multiple column disposed within;
2. sequentially breaking down characteristic elution profile of each partial time required to spend for respective predetermined mobile phase solution, this including feed solution mobile phase, at least one of recycle liquid stream organized in sequential order each with particular solute composition dissolved in particular modified characteristic parameter eluent solution mixture capable of eluting specific adsorbed solute mixture component, and eluent liquid followed with pressurized inert gas;
3. divide each said partial time in step (2) by said minimal time interval to obtain the range cumulated minimal time interval as major minimal time interval disposed for feeding zone and other zones following same major time interval of most time-consuming zone; then
4. divide total input volume of such liquid by the number of cumulated minimal time interval to obtain the partial volume required for each spent of minimal time interval in respective zone; then, divides such said partial volume by a preselected number to further differentiate for multiple liquid doses to reflect general procedures of said new mass transfer equilibrium contact method sipping through resin/adsorbent in said single cell;
5. further divides said resin/adsorbent amount in step 1, which being derived from complete saturation with feed solution throughput, by a preselected number that corresponds to differential resin/adsorbent amount disposed in at least one column bundled in said single cell to receive in sequence the partial volume of such liquid;
6. sequentially allocate each said major time interval with respective mobile phase solution as the range of respective zone and allocate all zones into an endless format in time domain; wherein integrating all zones orderly arranged in sequential format representing a complete elution separation cycle via transmitting all kind of mobile phase with finite parameter solution into underneath stationary separation module via predetermined combination of selected mobile phase between in-put S-I between I-I format, wherein
(a) including setting up at least one zone between selection of introducing at least one amount of first mobile phase stream and multiple first discrete mobile phase stream in contact with disposed resin/adsorbent packing material in time domain to proceed expected mass transfer contact as first mobile phase zone;
(b) including setting up at least one zone between selection of introducing at least one amount of second mobile phase stream and multiple second discrete mobile phase stream in contact with disposed resin/adsorbent packing material in time domain to proceed expected mass transfer contact as second mobile phase zone;
(c) including setting up at least one zone between selection of introducing at least one amount of third mobile phase stream and multiple third discrete mobile phase stream in contact with disposed resin/adsorbent packing material in time domain to proceed expected mass transfer contact as third mobile phase zone;
(d) including setting up at least one zone between selection of introducing at least one amount of fourth, fifth, and so forth mobile phase stream and multiple fourth, fifth, and so forth discrete mobile phase stream in contact with disposed resin/adsorbent packing material in time domain to proceed expected mass transfer contact as corresponding fourth, fifth, and so forth mobile phase zone until all adsorbed being eluted in sequence;
(e) including setting up at least one zone corresponding to introducing at least one of last mobile phase stream in contact with disposed resin/adsorbent packing material in time domain to proceed expected mass transfer contact as last mobile phase zone;
(f) and a predetermined plurality of alternative recycled mobile phase streams back to predetermined abovementioned zone to replace solution disposed in aforesaid corresponding zone to enhance concentration of separated component and save consumption of respective solution;
(g) thus, integrating whole spectrum of above said zones organized in sequential order representing such obtained characteristic separation profile being for eliminating chromatography displacement zone and further arranging such differential protocols; wherein
F. single stage recycle protocol employed onto said apparatus to complete separation procedures containing following:
1) providing said upstream holding tanks module containing plurality of holding tanks disposed in an organized order setting inside an insulated heat media circulation jacket to maintain whole plurality in a selected temperature range; wherein:
(i) at least one holding tank disposed in first mobile phase zone, each containing said at least one of predetermined between selection of first mobile phase stream and multiple first discrete mobile phase stream; and
(ii) at least one holding tank disposed in second mobile phase zone, each containing said at least one of predetermined between selection of second mobile phase stream and multiple second discrete mobile phase stream; and
(iii) at least one holding tank disposed in third mobile phase zone, each containing said at least one of predetermined between selection of third mobile phase stream and multiple third discrete mobile phase stream; and
(iv) at least one holding tank disposed in fourth, fifth, and so forth mobile phase zone, each containing said at least one of predetermined between selection of fourth mobile phase stream and multiple fourth, fifth, and so forth discrete mobile phase stream; and
(v) at least one holding tank disposed in last mobile phase zone, each containing said at least one of predetermined last mobile phase stream; and further
2) providing said downstream holding tanks module containing a plurality of holding tanks disposed in same organized order as corresponding each holding tank disposed in said upstream holding tanks module to receive drained corresponding liquid transmitted from; such plurality holding tanks setting inside an insulated heat media circulation jacket to maintain whole plurality in a selected temperature range; wherein
(i) at least one holding tank assigned for receiving in corresponding with liquid transmitted from particular holding tank disposed in said first mobile phase zone of upstream holding tanks module of said at least one of predetermined between selection of first mobile phase stream and multiple first discrete mobile phase stream in contact with resin/adsorbent solid phase packing material to attain new mass transfer equilibrium contact method; and
(ii) at least one holding tank assigned for receiving in corresponding with liquid transmitted from particular tank disposed in said second mobile phase zone of upstream holding tanks module of said at least one of predetermined between selection of second mobile phase stream and multiple second discrete mobile phase stream in contact with resin/adsorbent solid phase packing material to attain new mass transfer equilibrium contact method; and
(iii) at least one holding tank assigned for receiving in corresponding with liquid transmitted from particular tank disposed in said third mobile phase zone of upstream holding tanks module of said at least one of predetermined between selection of third mobile phase stream and multiple third discrete mobile phase stream in contact with resin/adsorbent solid phase packing material to attain new mass transfer equilibrium contact method; and
(iv) at least one holding tank assigned for receiving in corresponding with liquid transmitted from particular tank disposed in said fourth, fifth, and so forth mobile phase zone of upstream holding tanks module of said at least one of predetermined between corresponding selection of fourth, fifth, and so forth mobile phase stream and multiple fourth, fifth, and so forth discrete mobile phase stream in contact with resin/adsorbent solid phase packing material to attain new mass transfer equilibrium contact method; and
(v) at least one holding tank assigned for receiving in corresponding with liquid transmitted from particular tank disposed in said last mobile phase zone of upstream holding tanks module of said at least one of predetermined last mobile phase stream in contact with resin/adsorbent solid phase packing material to wash off retained resin/adsorbent solid packing material; further
3) providing said separation module comprising said single cell to retain predetermined solid phase resin/adsorbent as sum amount to fully saturated with prefixed feed solution throughput as mass transfer zone in chromatography and to distribute equal sub-portion amount in a plurality of each column having an inlet on top side and an outlet on bottom meshed filter to contain disposed resin/adsorbent from being drained; said single cell is disposed in an insulated heat media circulation jacket to maintain in a selected temperature range; said single cell further proceeding via said new mass transfer equilibrium contact method to carry out together with said mobile phase liquid streams transmitting mechanism to orderly deliver in sequence of aforesaid each mobile phase liquid stored in respective holding tank disposed corresponding zone in said upstream holding tanks module in a format of predetermined volume amount in sequential dose drop into said separation module to produce expected new mass transfer equilibrium contact method, and after each drop dose of sequential liquid delivery following repeated procedures soon predetermined amount of liquid solution being transmitted into said temporary transit reservoir disposed top portion of assigned single cell being completed, wherein
(a) intermittently deliver through means of alternated supplying between two separated broad range of pressurized inert gas routings from said single cell top portion to force draining of dose dropped liquid promptly sipping through said resin/adsorbent to complete said new mass transfer equilibrium contact method between two phases to promote adsorption of components onto said resin/adsorbent or eluting adsorbed component from said resin/adsorbent;
(b) meanwhile maintaining a vacuum environment of cell bottom portion to drain treated liquid solution into underneath temporary reservoir and to maintain resin/adsorbent in a semi-dry status;
(c) intermittently collecting drained liquids in temporary reservoir and transmitting collected liquid into each assigned holding tanks in said downstream holding tanks module;
(d) repeating repeatedly step (a) through step (c) to complete all liquid disposed at least one holding tank holding disposed in first mobile phase zone, liquid collected from cell bottom portion through which is transmitted as recycled stream to assigned holding tank in said last mobile phase zone to enhance concentration level of eluted component to save solution consumption or other usage; sequentially
(e) repeating repeatedly step (a) through step (c) to complete all liquid disposed at least one holding tank holding disposed in second mobile phase zone, liquid collected from cell bottom portion through which is transmitted as recycled stream back to assigned holding tank in said second mobile phase zone to enhance concentration level of eluted component to save solution consumption or other usage; sequentially
(f) repeating repeatedly step (a) through step (c) to complete all liquid disposed at least one holding tank holding disposed in third mobile phase zone, liquid collected from cell bottom portion through which is transmitted as recycled stream back to assigned holding tank in said third mobile phase zone to enhance concentration level of eluted component to save solution consumption or other usage; sequentially
(g) repeating repeatedly step (a) through step (c) to complete all liquid disposed at least one holding tank holding disposed in fourth, fifth, and so forth mobile phase zone, liquid collected from cell bottom portion through which is transmitted as recycled stream back to assigned holding tank in corresponding said fourth, fifth, and so forth mobile phase zone to enhance concentration level of eluted component to save solution consumption or other usage; sequentially
(h) repeating repeatedly step (a) through step (c) to complete all liquid disposed at least one holding tank holding disposed in last mobile phase zone, liquid collected from cell bottom portion through which is transmitted as recycled stream back to assigned holding tank in said first mobile phase zone to adjust and blend with components in feed solution to save solution consumption or other usage.

56. The process of claim 55 wherein said single cell defined in new mass transfer equilibrium contact method for introducing various kind of liquid solution in sequential operation containing predetermined solid phase resin/adsorbent amount is distributed in single column as cell itself, such column having an inlet on top side and an outlet on another side with bottom meshed filter to contain equal amount of said resin/adsorbent from being drained; wherein mobile phase liquid material through predetermined type of liquid dispenser in portion is a less than 180 degree baffle to conduct the predetermined volume of dropped dose fluid amid short period time duration to splash over like an downward umbrella shape; such splashed fluid hitting inner container wall, and swiftly sliding downward to partially up-lift and penetrate to stirring upward contained resin/adsorbent grains for quick and expected new mass transfer equilibrium contact method between two phases.

57. The process of claim 55 wherein said resin/adsorbent contained in said single cell is a particulate material to interact with plurality of dissolved components in mobile phase stream, wherein
a. at least one of first mobile phase stream contained in respective holding tank in first mobile phase zone of upstream holding tanks module is to promote adsorption new mass transfer equilibrium contact method between two phases is feed solution with dissolved components that is feeding zone; whereas at least one of corresponding holding tank disposed in downstream holding tanks module to receive and hold first mobile phase drained liquid is transmitted for said last mobile phase zone that is washing zone; and
b. at least one of second mobile phase stream contained in respective holding tank in second mobile phase zone of upstream holding tanks module is to elute at least one adsorbed component with at least one of second mobile solution that is at least one impurity stripping zone; whereas at least one of corresponding holding tank disposed in downstream holding tanks module to receive and hold respective second mobile phase drained liquid with eluted at least one component is to enhance respective concentration level of eluted component as recycled stream back to assigned holding tank in said at least one of impurity stripping zone to save solution consumption or as at least one by-product for other usage; and
c. at least one of third mobile phase stream contained in respective holding tank in third mobile phase zone of upstream holding tanks module is to elute at least one adsorbed component with at least one of third mobile solution that is at least one product recovery zone; whereas at least one of corresponding holding tank disposed in downstream holding tanks module to receive and hold respective third mobile phase drained liquid with eluted at least one recovered product is to enhance respective concentration level of eluted product as recycled stream back to assigned holding tank in said at least one of product recovery zone to save solution consumption or at least one product for other usage; and
d. at least one of fourth, fifth, and so forth mobile phase stream contained in respective holding tank in fourth, fifth, and so forth mobile phase zone of upstream holding tanks module is to further elute at least one adsorbed component in sequence with at least of fourth, fifth, and so forth mobile phase solution that is at least one regeneration zone and additional zone; whereas at least one of corresponding holding tank disposed in downstream holding tanks module to receive and hold fourth, fifth, and so forth corresponding mobile phase drained liquid with eluted at least one component is to enhance concentration level of each recovered component as recycled stream back to assigned holding tank in corresponding with said at least one regeneration zone and additional zone to save solution consumption or at least one by-product for other usage; and
e. at least one of first mobile phase stream contained in respective holding tank in said washing zone of upstream holding tanks module is to transmit to wash off retained resin/adsorbent solid packing material; whereas at least one of corresponding holding tank disposed in downstream holding tanks module to receive and hold first mobile phase drained liquid is to adjust and blend with components in feed solution as recycled stream back to assigned holding tank in said feeding zone to save solution consumption.

58. The process of claim 55 wherein said introducing various kind of liquid solution in sequential operation is utilized beginning with producing an acceptable target separation system's elution profile via optimizing between same predetermined mobile phase parameter and resin/adsorbent packing material as predetermined combination to carry out in a typical chromatography separation, wherein such various kind of characteristic parameters are selected mobile phase condition as homogeneous liquid solution including wide spectrum of variation named in pH value, ionic strength, solubility, polarity in connection with selected resin/adsorbent as combination, wherein resin/adsorbent packing materials are classified in various categories and/or commercially available resin/adsorbent packing material being named and used in chromatography including named ion exchange, affinity, reverse phase, normal phase, and ligand exchange that can chemically and selectively interact with the dissolved components in mobile phase feed solution to promote successive separation, and wherein selected parametric mobile phase condition in combination with selected resin/adsorbent packing material being employed for producing such target separation system's elution profile is the combined selection for batch mode that is said introducing various kind of liquid solution in sequential operation.

59. A generalized separation process is operated to eliminate displacement zone in chromatographic sequential operation via simultaneous respective mobile phase introducing into each of multiple cells containing particular resin/adsorbent packing material, said plurality of cells disposed in sequential order in respective zone for separating specific solute mixture containing at least one desired component from at least one other component as homogeneous liquid solution mixture in finite composition containing said solute mixture as feed solution mobile phase; via beginning to obtain an acceptable characteristic separation profile by carrying out a new mass transfer equilibrium contact method transmitting said liquid feed solution mobile phase contacting with a solid phase resin/adsorbent packing material, so that at least one of component contained in said liquid feed solution mixture can be adsorbed onto resin/adsorbent packing material; subsequently via said new mass transfer equilibrium contact method to transmit at least one of recycle liquid stream with particular solute composition dissolved in predetermined modified characteristic parameter eluent solution mixture capable of eluting specific adsorbed solute component, wherein all liquid recycled streams arranged in sequential order to contact with resin/adsorbent to separate at least one desired component migrating through various recycled streams to produce new mass transfer equilibrium contact method amid each pass of particular modified characteristic parameter eluent solution mixture to further gradually apart said at least one component from at least one of other component to obtain such acceptable characteristic separation profile; so that, such profile employed for said generalized separation process thereof, wherein said generalized separation process comprise following hybrid embodiments as general procedures of new mass transfer equilibrium contact method between resin/adsorbent solid phase and liquid mobile phase employed by operation of an apparatus operating via differential set-up and through single stage recycle protocol; thus to achieve expected simultaneous separation and concentration enhancement of at least one component isolated from at least one other component for mass production process; wherein
A. beginning with determining optimal full-strength bonding capacity of resin/adsorbent with a prefixed feed solution mobile phase throughput and such solid phase amount is equivalent to mass transfer zone in chromatography to carry out same above said new mass transfer equilibrium contact method mechanism; wherein retaining predetermined solid phase resin/adsorbent amount distributed equally in a bundled group of predetermined quantity of columns, each column having an inlet on top side and an outlet on another side with bottom meshed filter to contain equal amount of said resin/adsorbent from being drained; such bundled group of columns performing like partially fluidized beds as a whole unit being named as cell hereinafter; wherein each column retaining equal amount of resin/adsorbent solid material as plurality of columns installed in said cell and sum amount of each disposed resin/adsorbent being corresponding to resin/adsorbent installed as mass transfer zone in chromatography to fully saturated with prefixed feed solution throughput; the liquid inlet of cell is from top and liquid outlet of cell is from bottom; said new mass transfer equilibrium contact method comprising following general procedures, wherein
1. intermittently delivering predetermined amounts of mobile phase liquid material through predetermined type of liquid dispenser in portion as predetermined input format dose dropping amid predetermined first time period, wherein various kind of liquid solutions including feed solution mobile phase, at least one of recycle liquid stream organized in sequential order each with particular solute composition dissolved in particular modified characteristic parameter eluent solution mixture capable of eluting specific adsorbed solute mixture component, and eluent liquid followed with pressurized inert gas in sequential contact with said resin/adsorbent to promote expected new mass transfer equilibrium contact method either promoting adsorption of dissolved components onto said resin/adsorbent or eluting adsorbed components from said resin/adsorbent;
2. intermittently supplying broad range pressurized inert gas to said cell top side following each delivery of said mobile phase dose means amid predetermined second time period for maintaining sufficient pressure to force prompt draining such mobile phase liquid percolate through said resin/adsorbent solid phase packing material to complete expected new mass transfer equilibrium contact method;
3. meanwhile maintaining a vacuum environment on the other side of said solid phase material installed in said cell amid spent time during step (2) to maintain resin/adsorbent material in a semi-dry status; wherein said broad range pressurized inert gas being supplied from cell top and whereas vacuum being exerted from cell bottom;
4. collecting most of treated mobile phase liquid material meanwhile amid spent time during step (2) from the outlet of cell bottom;
5. defining in sum of spent time amid step (1) through step (4) as minimal time interval; wherein said generalized separation process further proceed
B. via aforesaid new mass transfer equilibrium contact method to obtain a characteristic separation profile for particular separation system, wherein feed solution mobile phase contacting with a solid phase resin/adsorbent packing material, so that at least one of component contained in said liquid feed solution mixture can be adsorbed onto resin/adsorbent packing material; subsequently via said new mass transfer equilibrium contact method to transmit at least one of recycle liquid stream containing particular solute composition dissolved in predetermined modified characteristic parameter eluent solution mixture capable of eluting specific adsorbed solute component, wherein all liquid recycled streams arranged in predetermined sequential order to contact with resin/adsorbent to separate at least one desired component migrating through various recycled streams to produce new mass transfer equilibrium contact method to further little by little apart said at least one component from at least one of other component amid each recycled stream contact to obtain such acceptable characteristic separation profile, further wherein various kind of mobile phase being delivered through predetermined type of liquid dispenser and combination of selected liquid input format, wherein input S-I mode is defined as that predetermined amounts of same mobile phase parametric condition is delivered within the said minimal time interval into said cell, and wherein mobile phase being delivered through predetermined type of liquid dispenser and selected liquid input format, wherein input I-I is defined as that predetermined amounts of “discrete increments” of mobile phase parametric conditions is delivered into said cell within said minimal time interval;
C. said new mass transfer equilibrium contact method is to deliver mobile phase in format by options of said input S-I proceeded along time domain, wherein
a. contacting said resin/adsorbent with at least one amount of feed solution mobile phase stream illustrated in step (1) through step (5) of step A and define total cumulated minimal time interval as feeding zone; subsequently
b. contacting said resin/adsorbent with at least one amount of first recycle mobile phase stream in sequence, each first recycled stream comprising particular solute composition dissolved in predetermined modified characteristic parameter eluent solution mixture to reach expected new mass transfer equilibrium contact method thus at least one of component is desorbed from the resin/adsorbent in sequence illustrated in step (1) through step (5) of step A and total cumulated minimal time interval is defined as zone 1; subsequently;
c. contacting said resin/adsorbent with at least one amount of second recycle mobile phase stream in sequence, each second recycled stream comprising particular solute composition dissolved in predetermined modified characteristic parameter eluent solution mixture to reach expected new mass transfer equilibrium contact method thus at least one of component is desorbed from the resin/adsorbent in sequence illustrated in step (1) through step (5) of step A and total cumulated minimal time interval is defined as zone 2;
d. repeating step (c) of step C by adding at least one amount of third mobile phase stream if remaining components still remained been adsorbed with said resin/adsorbent, such that components can be eluted by particular solute composition dissolved in predetermined modified characteristic parameter eluent solution mixture to reach expected new mass transfer equilibrium contact method thus remaining components are desorbed from the resin/adsorbent in sequence and total cumulated minimal time interval is defined as zone 3;
e. repeating step (d) until adsorbed component been desorbed in sequence with corresponding recycle mobile phase stream being acceptable thus total cumulated minimal time interval is defined respectively corresponding with matched particular recycle mobile phase as zone 4, 5, and so forth; otherwise,
f. contacting said resin/adsorbent with at least one amount of eluent liquid then followed with pressurized inert gas to the inlet of last cell in sequence illustrated in in step (1) through step (5) of step A to flush remaining liquid and total cumulated minimal time interval is defined as last zone; and
g. wherein lastly to integrate all defined zones in sequential prevail with respect to mobile phase parametric condition in time domain to conclude obtaining characteristic separation profile for particular separation system via input S-I;
D. said new mass transfer equilibrium contact method is to deliver mobile phase in format by options of said input I-I proceeded along time domain; wherein
1) contacting said resin/adsorbent with at least one amount of feed solution mobile phase stream illustrated in step (1) through step (5) of step A and define total cumulated minimal time interval as feeding discrete zone; subsequently repeating this step by increasing a discrete increment of mobile phase parametric conditions until all of said at least one of feed solution mobile phase stream being adjusted with preset incremental discrete delivered in sequence and total cumulated minimal time interval is defined as multiple feeding discrete zone named in sequential order corresponding to respective delivered mobile phase parametric condition; subsequently
2) contacting said resin/adsorbent with at least one amount of first recycle mobile phase stream in sequence, each first stream comprising particular solute composition dissolved in predetermined modified characteristic parameter eluent solution mixture in discrete increment of parametric condition to reach expected new mass transfer equilibrium contact method such that at least one of component is desorbed from the resin/adsorbent in sequence illustrated in step (1) through step (5) of step A and total cumulated minimal time interval is defined as discrete zone 1; repeating this step by increasing a discrete increment of mobile phase parametric conditions until all of said at least one amount of first mobile phase stream being adjusted with preset incremental discrete delivered in sequence and total cumulated minimal time interval is defined as multiple discrete zone 1 named in sequential order corresponding to respective delivered mobile phase parametric condition; subsequently
3) contacting said resin/adsorbent with at least one amount of second recycle mobile phase stream in sequence, each second stream comprising particular solute composition dissolved in predetermined modified characteristic parameter eluent solution mixture of mobile phase parametric composition to reach expected new mass transfer equilibrium contact method such that at least one of component is desorbed from the resin/adsorbent in sequence illustrated in step (1) through step (5) of step A and total cumulated minimal time interval is defined as discrete zone 2; repeating this step by increasing a discrete increment of mobile phase parametric conditions until all of said at least one amount of second mobile phase stream being adjusted with preset incremental discrete delivered in sequence and total cumulated minimal time interval is defined as multiple discrete zone 2 named in sequential order corresponding to respective delivered mobile phase parametric condition; subsequently
4) repeating step (3) of step D adding at least one amount of third mobile phase stream if remaining components still been adsorbed with said resin/adsorbent, such that components can be eluted by particular solute composition dissolved in predetermined modified characteristic parameter eluent solution mixture with discrete increment of mobile phase parametric condition to reach expected new mass transfer equilibrium contact method such that remaining components is desorbed from the resin/adsorbent in sequence illustrated in step (1) through step (5) of step A and total cumulated minimal time interval is defined as discrete zone 3; repeating this step by increasing a discrete increment of mobile phase parametric conditions until all of said at least one amount of third recycle mobile phase stream being adjusted with preset incremental discrete delivered in sequence and total cumulated minimal time interval is defined as multiple discrete zone 3 named in sequential order corresponding to respective delivered mobile phase parametric condition;
5) repeating step (4) until adsorbed component been desorbed in sequence with corresponding recycle mobile phase stream thus total cumulated minimal time interval is defined respectively corresponding with matched particular recycle mobile phase as zone 4, 5, and so forth; repeating this step by increasing a discrete increment of mobile phase parametric conditions until all of said at least one amount of corresponding recycle mobile phase stream being adjusted with preset incremental discrete delivered in sequence and total cumulated minimal time interval is defined as multiple discrete zone 4, 5, and so forth named in sequential order corresponding with respective delivered recycle mobile phase parametric condition;
6) contacting said resin/adsorbent with at least one amount of eluent liquid then followed with pressurized inert gas to the inlet of last cell in sequence illustrated in in step (1) through step (5) of step A to flush remaining liquid and total cumulated minimal time interval is defined as last zone; and
7) wherein lastly to integrate all defined zones in sequential prevail with respect to mobile phase parametric condition in time domain to conclude obtaining characteristic separation profile for particular separation system via input I-I; further wherein
E. an apparatus employed for integrating multiple modules contained in a closed loop connected in sequence yet functioning independently as a whole unit, such apparatus comprising following module, wherein
1) providing separation module, wherein
(a) single cell comprising predetermined quantity of columns orderly disposed inside said cell; each column having an top side inlet and a bottom side outlet with meshed filter to contain equal amount of resin/adsorbent material from being drained;
(b) a plurality of said single cell disposed inside an insulated heat media circulation jacket to maintain said plurality of cells in a selected temperature range;
(c) each of cell top having an inlet liquid conduct as temporary transit reservoir extended outside upward of said heat media circulation jacket to receive particular liquid delivered from corresponding holding tank in downstream holding tanks module through an opened flipper, named as flipper 3 hereinafter disposed around top inside of said liquid transit storage reservoir, through liquid pipe delivering respective liquid through predetermined type of liquid dispenser down below; such dispenser comprising of another preferred mechanical device flipper, named as flipper 4 hereinafter disposed inside in between bottom side of said temporary transit reservoir and top side of the liquid dispenser;
(d) each cell bottom being exposed to said vacuum environment containing a transit reservoir with its widely open top means to withdraw mist enriched inert gas via its gas exit pipe connect to a manifold to maintain said resin/adsorbent in a semi-dry status, meanwhile to affiliating liquid draining via disposed funneled shape liquid conduct through;
(e) another opened mechanical flipper, names as flipper 65 hereinafter disposed inside bottom of said funnel conduct, into underneath temporary liquid reservoir; having a gas pipe connected with same manifold next to said mist enriched inert gas exit pipe means for supplying broad range pressurized inert gas via this manifold to shut off said flipper 65 soon said vacuum environment being shut off, so that pushing entire drained liquid into following module via a preferred pressurize activated check valve disposed around top inside of said bottom liquid conduct, wherein said inert gas manifold being disposed underneath said vacuum environment and being extended outside downward of said insulated heat media circulation jacket;
2) providing downstream holding tanks module, wherein
(a) having a plurality of holding tank disposed in an organized order setting inside an insulated heat media circulation jacket to maintain whole plurality of holding tanks in a selected temperature range and each tank having an inlet liquid conduct extended outside upward of the insulated heat media circulation jacket;
(b) each of said whole plurality holding tanks comprising an outlet liquid conduct installed with said preferred pressure activated check valve extended outside downward of said jacket means for discharging stored liquid via each means of liquid distribution;
(c) having a liquid level sensor installed inside each of said whole plurality holding tanks to monitor predetermined liquid level of stored liquid within for following;
(i) means such level sensor is to control delivering sufficient volume amount of particular solution via liquid conduct disposed on top of such holding tank to maintaining a predetermined liquid level setting in respective holding tank and holding received respective liquid;
(ii) means for at least one isolated product into respective assigned storage tank;
(iii) means for discharging components in particular solution mixture as by product into respective assigned storage tank; and
(iv) means for transmitting in part of recycled stream of particular solute composition dissolved in predetermined modified characteristic parameter eluent solution mixture stored in assigned holding tank in predetermined volume recycling back into each assigned cell top in aforesaid separation module; further wherein;
3) providing inert gas supply module means for mobile phase liquid streams transmitting mechanism for close loop routing supplying broad range pressurized inert gas inasmuch as incorporating with liquid fluid transmitting between said separation module and downstream holding tanks module, wherein such module contain closed vacuum environment loop, upstream broad range inert gas supplying loop, and downstream broad range inert gas supplying loop;
(a) proceeding closed vacuum environment loop comprising following procedures,
(i) cell bottom been exposed to said vacuum environment to affiliate dropped dose liquid draining, meanwhile to extracting mobile phase liquid enriched mist inert gas to maintain said resin/adsorbent in semi-dry status through means extracting mist enriched inert gas to dry inert gas via driving force exerted from central vacuum pump through gas pipe via a selected mist separator to recover such mist from enriched inert gas;
(ii) meanwhile to create a heterogeneous contact as following dropped dose of liquid promptly sipping through stationary resin/adsorbent particles to meet criterion of said new mass transfer equilibrium contact method;
(iii) whole time, dry inert gas exiting mist separator being combined with pressurized dry air and deployed through an inert gas generator to obtain fresh dry inert gas and stored in a steel tank vessel maintaining preferred broad range of pressure level inert gas ready deploying back to following modules;
(b) proceeding upstream broad range inert gas supplying loop means for cell top region in separation module wherein comprising following procedures,
(i) via each volumetric pump simultaneously transmitting predetermined liquid volume amount from assigned holding tank of said downstream holding tanks module via supplying of broad range pressurized inert gas through gas pipe connected to close said flipper 4 disposed around each bottom of said temporary transit reservoir to hold transmitted liquid and thus to freely passing through opened said flipper 3 disposed around each cell top liquid conduct into each said cell top temporary transit reservoir located at top of said separation module; soon entire transmitted liquid amount being completed; subsequently
(ii) via means of alternatively and simultaneously supplying of broad range pressurized inert gas through gas pipe connected in between said flipper 3 and flipper 4 of said temporary transit reservoir and another gas pipe disposed next to said temporary transit reservoir to intermittently dose dropping in parts of received liquid out of temporary transit reservoir resulting as predetermined said liquid input format to promptly wet top portion and promptly sipping through resin/adsorbent bed to carry out expected new mass transfer equilibrium contact method;
(c) proceeding downstream broad range inert gas supplying loop means for all cells bottom region in separation module and downstream holding tanks module wherein comprising following procedures
(i) during duration of exerted vacuum environment to continuously drain dropped doses of liquid into underneath liquid reservoir and said preferred pressure activated check valve holding drained liquid within; soon as liquid draining of entire transmitted liquid been completed; subsequently;
(ii) shutting off vacuum environment, supplying low range pressurized inert gas routing via its pipe disposed next to said vacuum exit pipe in same manifold to close said flipper 65 to allow entire collected liquid freely pushing through opened said pressure activated check valve through liquid line connected to assigned holding tank in said downstream holding tanks module;
F. as illustrated wherein differential set-up protocols employed via illustrated in step (1) through step (5) of step A for general procedures of new mass transfer equilibrium contact method onto aforesaid predetermined cell construction of step A to carry out by predetermined combination of selected mobile phase between in-put S-I and in-put I-I format to obtain a characteristic separation profile for particular separation system related between selected resin/adsorbent and various kinds of mobile phase liquid material onto aforesaid apparatus to separate at least one desired component from feed solution mobile phase, following is said differential set-up protocol employed onto said apparatus, wherein
1. determining optimal full-strength bonding capacity of said resin/adsorbent with a prefixed feed throughput and filling such resin/adsorbent amount into a said cell contain multiple column disposed within;
2. sequentially breaking down characteristic elution profile partial time required to spend for respective predetermined mobile phase solution, this including feed solution mobile phase, at least one of recycle liquid stream organized in sequential order each with particular solute composition dissolved in particular modified characteristic parameter eluent solution mixture capable of eluting specific adsorbed solute mixture component, and eluent liquid followed with pressurized inert gas;
3. divide each said partial time by said minimal time interval to obtain the range cumulated minimal time interval and sum as major minimal time interval for multiple cells disposed in respective zone including feeding zone and other zones following same major time interval of most time-consuming zone; then
4. divide total input volume amount of such liquid by the number of cells to obtain the partial volume required for each cell in respective zone; then, further divides such said partial volume by a preselected number to further differentiate for multiple liquid doses to reflect general procedures of said new mass transfer equilibrium contact method sipping through resin/adsorbent in each cell; in addition
5. divides said resin/adsorbent amount in step 1, which derived from complete saturation with feed solution throughput, by a preselected number that corresponds to differential resin/adsorbent amount disposed in at least one column bundled in a single cell disposed in each zone to simultaneously receive the partial volume of such liquid for each cell in said group of cells;
6. sequentially allocate all cells with respective mobile phase solution as the range of respective zone and allocate all zones into an endless format; wherein integrating all zones orderly arranged in sequential format representing a complete elution separation cycle via transmitting all kind of mobile phase with finite parameter solution into underneath stationary separation module is to simulate all cells in horizon moving direction whereas mobile phase is simultaneously traveling in vertical direction via predetermined combination of selected mobile phase between in-put S-I between I-I format, wherein
(a) including setting up at least one zone between selection of at least one of feed solution mobile phase stream and multiple discrete feed solution mobile phase stream as feeding zone;
(b) including setting up at least one zone between selection of at least one of first recycle mobile phase stream and multiple first discrete recycle mobile phase stream as zone 1;
(c) including setting up at least one zone between selection of at least one of second recycle mobile phase stream and multiple second recycle discrete mobile phase stream as zone 2;
(d) including setting up at least one zone between selection of at least one of third mobile phase stream and multiple third recycle discrete mobile phase stream as zone 3;
(e) further expand including setting up in sequence at least one of additional zone between selection of fourth, fifth, and so forth mobile phase stream and multiple fourth, fifth, and so forth recycle discrete mobile phase streams as additional name as zone 4, 5, and so forth;
(f) including setting up at least one zone corresponding to at least one of eluent liquid followed with pressurized inert gas stream as last zone;
(g) and a predetermined plurality of alternative recycle mobile phase streams back to predetermined cell top temporary transit reservoir to further enhance concentration of eluted component dissolved in particular modified characteristic parameter eluent solution mixture capable of further eluting specific adsorbed solute mixture component and save consumption of respective eluent solution mixture;
(h) thus, integrating all combination of aforesaid zones in sequential order representing such obtained characteristic separation profile being for eliminating chromatography displacement zone and simultaneous separating at least one desired component from at least one other component amid each spent of minimal time interval;
G. further arranging such differential set-up protocols onto said apparatus via said new mass transfer equilibrium contact method along with single stage recycle protocol employed onto said apparatus to achieve separation operation containing following:
1) providing said downstream holding tanks module containing a plurality of holding tanks disposed in approximate order as corresponding each cell disposed in said separation module to hold drained corresponding liquid transmitted from and transmitted to assigned cell and other destination; such plurality holding tanks setting inside an insulated heat media circulation jacket to maintain whole plurality in a selected temperature range; wherein
a. at least one holding tank arranged in sequence assigned for receiving in corresponding with feed solution mobile phase containing at least one desired component from at least one other component as homogeneous liquid solution mixture in finite composition transmitted from its source into assigned top portion of cell top temporary transit reservoir in contact with resin/adsorbent solid phase packing material to attain new mass transfer equilibrium contact method as treated liquid to promote adsorption of at least one solute component collected from particular temporary holding tank disposed in cell bottom portion of said separation module as liquid holding tank disposed in feeding zone;
b. at least one holding tank arranged in sequence assigned for receiving in corresponding with particular recycled stream containing solute composition dissolved in particular modified characteristic parameter eluent solution mixture transmitted from said zone 1 into assigned top portion of cell top temporary transit reservoir in contact with resin/adsorbent solid phase packing material to attain new mass transfer equilibrium contact method as treated liquid to promote eluting specific adsorbed solute mixture component collected from particular temporary holding tank disposed in cell bottom portion of said separation module as liquid holding tank disposed in zone 1;
c. at least one holding tank arranged in sequence assigned for receiving in corresponding with particular recycled stream containing solute composition dissolved in particular modified characteristic parameter eluent solution mixture transmitted from said zone 2 into assigned top portion of cell top temporary transit reservoir in contact with resin/adsorbent solid phase packing material to attain mass transfer equilibrium as treated liquid to promote eluting specific adsorbed solute mixture component collected from particular temporary holding tank disposed in cell bottom portion of said separation module as liquid holding tank disposed in zone 2;
d. at least one holding tank arranged in sequence assigned for receiving in corresponding with particular recycled stream containing solute composition dissolved in particular modified characteristic parameter eluent solution mixture transmitted from said zone 3 into assigned top portion of cell top temporary transit reservoir in contact with resin/adsorbent solid phase packing material to attain new mass transfer equilibrium contact method as treated liquid to promote eluting specific adsorbed solute mixture component collected from particular temporary holding tank disposed in cell bottom portion of said separation module as liquid holding tank disposed in zone 3;
e. further expand at least one holding tank arranged in sequence assigned for receiving in corresponding with particular recycled stream containing solute composition dissolved in particular modified characteristic parameter eluent solution mixture transmitted from each said zone 4, 5, and so forth into assigned top portion of cell top temporary transit reservoir in contact with resin/adsorbent solid phase packing material to attain new mass transfer equilibrium contact method as respective treated liquid to promote eluting specific adsorbed solute mixture component collected from particular temporary holding tank disposed in cell bottom portion of said separation module as corresponding liquid holding tank disposed in sequence with corresponding zone 4, 5, and so forth;
f. at least one holding tank arranged in sequence assigned for receiving in corresponding with eluent liquid transmitted from its source into assigned top portion of cell top temporary transit reservoir in contact with resin/adsorbent solid phase packing material to attain mass transfer equilibrium as treated liquid to promote eluting all remaining adsorbed solute mixture component collected from particular temporary holding tank disposed in cell bottom portion of said separation module as liquid holding tank disposed in last zone;
g. adding one holding tank arranged in sequence after last zone assigned for receiving in corresponding with pressurized inert gas from its source into assigned top portion of cell top temporary transit reservoir to flush remaining liquid in resin/adsorbent solid phase packing material to maintain semi-dry status of new mass transfer equilibrium contact method collected from particular temporary holding tank disposed in cell bottom portion of said separation module as last holding tank disposed in sequence after last zone; further
h. assign according to step (a) through step (g) at least one product holding tank for respectively holding said one particular enriched component product and at least one by-product holding tank for respectively holding at least one other enriched component by-product; further preparing each recycle liquid stream according to obtained characteristic elution profile with finite solute composition dissolved in particular modified characteristic parameter eluent solution mixture capable of eluting specific adsorbed solute mixture component from respective holding tank organized in sequential order as said zone 1, 2, 3, 4, 5, and so forth, and “last zone” to hold eluent liquid transmitted from its source, followed with last holding tank to hold remaining liquid flushed by pressurized inert gas after last zone; thus integrating whole spectrum of holding tanks representing various kind of liquids of produced characteristic elution profile organized in sequential order disposed in each holding tanks of said downstream holding tanks module; and hence
2) proceeding said single stage recycle protocol incorporating said downstream holding tanks module with providing said separation module to achieve separation operation; wherein separation module comprising a plurality of each cell to retain predetermined solid phase resin/adsorbent amount as sum to fully saturated with prefixed feed solution throughput as mass transfer zone in chromatography and to distribute equal sub-portion amount in a plurality of each column having an inlet on top side and an outlet on bottom meshed filter to contain disposed resin/adsorbent from being drained; said such plurality of cells being arranged in approximate order as said downstream holding tanks module disposed in an insulated heat media circulation jacket to maintain in a selected temperature range; via general procedures of said new mass transfer equilibrium contact method, each assigned cell simultaneously receive predetermined volume amount of respective liquid stream via said mobile phase liquid streams transmitting mechanism of aforesaid various kind of mobile phase liquid stream from respective source in a format of predetermined volume in sequential dose drop into said separation module to produce expected new mass transfer equilibrium contact method, wherein including liquid from said feeding zone, zone 1, 2, 3, 4, 5, and so forth corresponding to feed solution mobile phase, each recycle liquid stream from respective holding tank organized in sequential order with particular solute composition dissolved in particular modified characteristic parameter eluent solution mixture capable of eluting specific adsorbed solute mixture component, and last zone of eluent liquid followed with pressurized inert gas; all liquid streams being simultaneously delivered into each assigned cell top temporary transit reservoir via said liquid streams transmitting mechanism in intermittent and simultaneous contact with resin/adsorbent, wherein after each drop dose of simultaneous liquid delivery following repeated procedures via repeated said new mass transfer equilibrium contact method proceeding through each assigned cell disposed in said separation module, wherein
(a) intermittent and simultaneous delivering amid first time period through means of alternated supplying between two separated broad range of pressurized inert gas routings from respective cell top portion to force draining of dose dropped liquid promptly sipping through said resin/adsorbent to complete said new mass transfer equilibrium contact method between two phases to promote adsorption of components onto said resin/adsorbent or eluting adsorbed component from said resin/adsorbent;
(b) meanwhile maintaining a vacuum environment of cell bottom portion to drain treated liquid solution into underneath temporary reservoir thus to maintain resin/adsorbent in a semi-dry status;
(c) intermittently amid second time period collecting treated liquid in temporary reservoir;
(d) repeating repeatedly step (a) through step (c) to complete all simultaneous liquid delivering from its source including feed solution, a plurality of recycle liquid stream in zone 1, 2, 3, 4, 5, and so forth along with last zone of each predetermined volume liquid amount into each assigned temporary transit reservoir of said top portion in separation module, so that, at least one desired component migrating through various recycled streams to produce new mass transfer equilibrium contact method amid each passage of liquid dose drop of particular modified characteristic parameter eluent solution mixture to further gradually apart said at least one component from at least one of other component to obtain such separation result of said characteristic separation profile amid each spent of said major time interval; further transmitting treated liquid via mobile phase liquid streams transmitting mechanism back to each assigned holding tanks in said downstream holding tanks module, including at least one product holding tank for respectively holding said one particular enriched component product, at least one by-product holding tank for respectively holding at least one other enriched component by-product, and a plurality of recycled mixtures orderly contained in each of corresponding holding tank, so that, each tank contains one particular recycled mixture that has a specific composition of said components dissolved in drained solution and eluent collected from bottom portion of said separation module for repeated recycling back to said respective assigned temporary transit reservoir in said top portion of separation module.

60. The process of claim 59 wherein feed solution mobile phase is introduced in between two consecutive zones and such consumed said major time interval being defined as feeding zone.

61. The process of claim 59 wherein introducing feed solution mobile phase containing at least one desired component to separate from at least one other component solute mixture as homogeneous liquid solution mixture in finite composition to interact with disposed resin/adsorbent disposed orderly contained in at least one cell of the apparatus is a particulate ion exchange resin/adsorbent.

62. The process of claim 59 wherein simultaneous introducing of feed solution mobile phase being introduced in between two consecutive zones comprises solute components of oligosaccharide, glucose and fructose sugar mixtures with finite component percentage composition and finite dry solid concentration dissolved in finite volume of de-ionized dirt free eluent water to promote at least one component adsorption onto said resin/adsorbent and a plurality of each recycled stream comprising said solute composition dissolved in predetermined finite solute percentage component eluent solution mixture and eluent liquid being same de-ionized dirt free water to apart said at least one component from at least one of other component amid simultaneous and intermittent passage of liquid dose drop including feed solution mobile phase, a plurality of recycled streams and eluent liquid followed with pressurized inert gas to reach expected new mass transfer equilibrium contact method to obtain enhancing dry solid concentration and little by little separating between glucose and fructose sugar component, wherein resin/adsorbent disposed orderly contained in at least one cell of the apparatus is a particulate one type of the alkaline-earth metals base strongly acidic Cation exchanger.

63. The process of claim 59 wherein said resin/adsorbent filled in each cell of the apparatus is calcium base strongly acidic cation exchanger to attain pure glucose as raffinate with finite dry solid concentration over 35%, and to attain 99.99% fructose purity as product with over 51% of finite dry solid concentration, and to attain a plurality of each recycling streams having finite characteristics in sugar composition and finite concentration.

64. The process of claim 59 wherein simultaneous introducing of feed solution mobile phase containing at least one desired component to separate from at least one other component solute mixture as homogeneous liquid solution mixture in finite composition in contact with disposed resin/adsorbent to promote adsorption and a plurality of each recycled stream comprising said solute composition dissolved in predetermined modified characteristic parameter eluent solution mixture in discrete increment of parametric condition to reach expected new mass transfer equilibrium contact method such that at least one of said component can be desorbed from the resin/adsorbent in sequence, wherein said resin/adsorbent disposed orderly contained in at least one cell of the apparatus is a particulate reverse phase resin/adsorbent.

65. The process of claim 59 wherein simultaneous introducing of feed solution mobile phase containing at least one desired component to separate from at least one other component solute mixture as homogeneous liquid solution mixture in finite composition in contact with disposed resin/adsorbent to promote adsorption and a plurality of each recycled stream comprising said solute composition dissolved in predetermined modified characteristic parameter eluent solution mixture in discrete increment of parametric condition to reach expected new mass transfer equilibrium contact method such that at least one of said component can be desorbed from the resin/adsorbent in sequence, wherein said resin/adsorbent disposed orderly contained in at least one cell of the apparatus is a particulate normal phase resin/adsorbent.

66. The process of claim 59 wherein general procedures proceeded in said new mass transfer equilibrium contact method wherein mobile phase liquid material being intermittently transmitted through predetermined type of liquid dispenser in portion is showerhead to conduct the predetermined volume of transmitted fluid amid short period time duration to sprinkle a wetted region of retained resin/adsorbent to sipping through and achieving expected new mass transfer equilibrium contact method between two phases.

67. The method of claim 59 wherein said a preselected number in step (4) and step (5) in step F is a finite whole number greater than one; including one.
